(19) United States
(12) Patent Application Publication
(10) Pub. No.: US 2026/0302995 A1
(43) Pub. Date: Oct. 1, 2026

(54) PRIORITY-BASED MATRIX CONVERTER CONTROL IN AN ELECTRIC MOTOR DRIVE UNIT

(71) Applicant: Vidar LLC, Syracuse, NY (US)

(72) Inventors: Dean P. Williams, Moravia, NY (US); Luca Rovere, Nottingham (GB)

(21) Appl. No.: 19/570,787

(22) Filed: Mar. 18, 2026

Related U.S. Application Data
(60) Provisional application No. 63/773,713, filed on Mar. 18, 2025.

(51) Int. Cl. H02P 27/08; H02P 21/14; H02P 25/10; H02P 29/50

(52) U.S. Cl. CPC H02P 27/08; H02P 21/14; H02P 25/10; H02P 29/50; H02P 2201/01

(57) ABSTRACT

A motor assembly includes a variable frequency drive implementing a matrix converter comprising a plurality of bidirectional switches. Each sensor of a plurality of sensors determines a metric value for a characteristic of the electric motor and measures a different characteristic of the electric motor. A controller accesses a prioritization scheme and selects a modulation technique from a plurality of modulation techniques based at least in part on the prioritization scheme and one or more metric values obtained from one or more corresponding sensors of the plurality of sensors. The controller is further configured to control a state of a bidirectional switch from the plurality of bidirectional switches based at least in part on the modulation technique.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

This application relates to variable frequency motor drives, such as those used in industrial pumps or other rotary devices. Variable frequency drive electronics can be sensitive to heat. It can be a challenge to effectively manage the temperature of the drive electronics as the number of heat generating devices in the drive electronics increases or the drive electronics are placed in proximity to relatively hot running electric motor.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

Aspects of the disclosure relate to variable frequency drives capable of driving increased horsepower while maintaining a relatively small form factor and/or maintaining a safe operating temperature, such as where the variable frequency drive is an embedded motor drive integrated with and configured for mounting to an electric motor. The electric motor and integrated motor drive can be for powering a rotary device such as an industrial pump or other type of machinery.

According to certain embodiments, the electronic variable frequency drive is configured for mounting inside the same size envelope as a standard National Electrical Manufacturers Association (NEMA) or International Electrotechnical Commission (IEC) rated motor of the same power rating, thereby allowing variable speed operation of the motor and any pump or rotary device it controls.

In some aspects, the techniques described herein relate to a motor assembly including: a motor housing; an electric motor at least partially disposed in the motor housing; a variable frequency drive implementing a matrix converter including a plurality of bidirectional switches; a temperature sensor configured to determine a temperature of the matrix converter; and a controller implemented by a hardware processor, the controller configured to control a state of each bidirectional switch of the plurality of bidirectional switches based at least in part on a modulation technique, wherein the controller is further configured to select the modulation technique from a plurality of modulation techniques based at least in part on the temperature of the matrix converter.

In some aspects, the techniques described herein relate to a motor assembly, wherein the plurality of modulation techniques includes minimum commutation loss (MCL) modulation, space vector modulation with one zero vector per switching sequence (SVM 1z), space vector modulation with two zero vectors per switching sequence (SVM 2z), space vector modulation with three zero vectors per switching sequence (SVM 3z) a carrier based per-phase modulation, or Alesina-Venturini modulation.

In some aspects, the techniques described herein relate to a motor assembly, wherein, in response to determining that the temperature exceeds a first temperature threshold, the controller is further configured to modify the modulation technique from SVM 2z to SVM 1z.

In some aspects, the techniques described herein relate to a motor assembly, wherein, in response to determining that the temperature exceeds a second temperature threshold, the controller is further configured to modify the modulation technique from SVM 1z to MCL.

In some aspects, the techniques described herein relate to a motor assembly, wherein the second temperature threshold exceeds the first temperature threshold.

In some aspects, the techniques described herein relate to a motor assembly, wherein the controller modifies a selection of the modulation technique from the plurality of modulation techniques to reduce a number of switching transitions of the plurality of bidirectional switches in response to the temperature exceeding a temperature threshold.

In some aspects, the techniques described herein relate to a motor assembly, wherein the controller is further configured to reduce a carrier frequency from a first frequency to a second frequency in response to the temperature exceeding a temperature threshold, wherein the carrier frequency corresponds to a switching frequency of the plurality of bidirectional switches.

In some aspects, the techniques described herein relate to a motor assembly, wherein the controller is further configured to select the modulation technique from the plurality of modulation techniques based at least in part on the temperature of the matrix converter and at least one additional parameter.

In some aspects, the techniques described herein relate to a motor assembly, wherein the at least one additional parameter comprises one or more of the following: total harmonic distortion; vibration; signal noise; audible noise; energy loss; stress associated with change in voltage over time at terminals of the electric motor; motor speed; maximum torque per ampere; or torque production.

In some aspects, the techniques described herein relate to a method of operating a motor assembly including a matrix converter, the method including: by a hardware processor configured to implement a matrix converter controller, operating the matrix converter using a first modulation technique at a first time, wherein the first modulation technique controls operation of a set of bidirectional switches of the matrix converter, and wherein the first modulation technique is one of a plurality of modulation techniques supported by the matrix converter controller; measuring a first temperature of the matrix converter; determining that the first temperature exceeds a first temperature threshold; selecting a second modulation technique from the plurality of modulation techniques; and operating the matrix converter using the second modulation technique at a second time that is later than the first time.

In some aspects, the techniques described herein relate to a method, further including causing a motor of the motor assembly to operate at a lower speed when operating the matrix converter using the second modulation technique than when operating the matrix converter using the first modulation technique.

In some aspects, the techniques described herein relate to a method, wherein the second modulation technique is configured to reduce a switching frequency of the set of bidirectional switches compared to the first modulation technique.

In some aspects, the techniques described herein relate to a method, further including: measuring a second temperature of the matrix converter when the matrix converter is operating using the second modulation technique; determining that the second temperature is below a second temperature threshold; and operating the matrix converter using the first modulation technique at a third time that is later than the second time.

In some aspects, the techniques described herein relate to a method, wherein the second temperature threshold is below the first temperature threshold by an amount that satisfies a hysteresis band.

In some aspects, the techniques described herein relate to a method, wherein the first modulation technique includes space vector modulation with two zero vectors per switching sequence of the set of bidirectional switches.

In some aspects, the techniques described herein relate to a method, wherein the second modulation technique includes a modulation technique selected from a secondary set of modulation techniques, and wherein the secondary set of modulation techniques includes at least one of the following: minimum commutation loss modulation and space vector modulation with one zero vector per switching sequence of the set of bidirectional switches.

In some aspects, the techniques described herein relate to a method, further including reducing a carrier frequency from a first frequency to a second frequency in response to the first temperature exceeding the first temperature threshold, wherein the carrier frequency corresponds to a switching frequency of the set of bidirectional switches.

In some aspects, the techniques described herein relate to a method, further including reducing a carrier frequency from a first frequency to a second frequency in response to a third temperature exceeding a third temperature threshold, wherein the carrier frequency corresponds to a switching frequency of the set of bidirectional switches.

In some aspects, the techniques described herein relate to a method, further including selecting the second modulation technique from the plurality of modulation techniques based at least in part on one or more parameters of the matrix converter or the motor assembly that includes the matrix converter.

In some aspects, the techniques described herein relate to a method, wherein the one or more parameters comprise one or more of the following: the first temperature; total harmonic distortion; vibration; signal noise; audible noise; energy loss; stress associated with change in voltage over time at terminals of the electric motor; motor speed; maximum torque per ampere; or torque production.

In some aspects, the techniques described herein relate to a non-transitory computer-readable medium configured to store computer-executable instructions that when executed by a hardware processor causes the hardware processor to at least: operate a matrix converter of a motor assembly using a first modulation technique at a first time, wherein the first modulation technique controls operation of a set of bidirectional switches of the matrix converter, and wherein the first modulation technique is one of a plurality of modulation techniques supported by the matrix converter; measure a first temperature of the matrix converter; determine that the first temperature exceeds a first temperature threshold; select a second modulation technique from the plurality of modulation techniques; and operate the matrix converter using the second modulation technique at a second time that is later than the first time.

In some aspects, the techniques described herein relate to a non-transitory computer-readable medium, wherein the second modulation technique is configured to at least: operate a motor of the motor assembly at a lower speed than the first modulation technique; or reduce a switching frequency of the set of bidirectional switches compared to the first modulation technique.

In some aspects, the techniques described herein relate to a non-transitory computer-readable medium, wherein the computer-executable instructions further cause the hardware processor to at least: measure a second temperature of the matrix converter when the matrix converter is operating using the second modulation technique; determine that the second temperature is below a second temperature threshold; and operate the matrix converter using the first modulation technique at a third time that is later than the second time.

In some aspects, the techniques described herein relate to a non-transitory computer-readable medium, wherein the computer-executable instructions further cause the hardware processor to at least reduce a carrier frequency from a first frequency to a second frequency in response to at least one of the following conditions: the first temperature exceeding the first temperature threshold, or a third temperature exceeding a third temperature threshold, wherein the carrier frequency corresponds to a switching frequency of the set of bidirectional switches.

In some aspects, the techniques described herein relate to a non-transitory computer-readable medium, wherein the computer-executable instructions further cause the hardware processor to at least select the second modulation technique from the plurality of modulation techniques based at least in part on one or more parameters of the matrix converter or the motor assembly that includes the matrix converter.

In some aspects, the techniques described herein relate to a non-transitory computer-readable medium, wherein the one or more parameters comprise one or more of the following: the first temperature; total harmonic distortion; vibration; signal noise; audible noise; energy loss; stress associated with change in voltage over time at terminals of the electric motor; motor speed; maximum torque per ampere; or torque production.

In some aspects, the techniques described herein relate to a motor assembly including: a motor housing; an electric motor at least partially disposed in the motor housing; a variable frequency drive implementing a matrix converter including a plurality of bidirectional switches; a power quality monitor configured to determine a total harmonic distortion of a carrier frequency of the matrix converter; and a controller implemented by a hardware processor, the controller configured to control a state of each bidirectional switch of the plurality of bidirectional switches based at least in part on a modulation technique, wherein the controller is further configured to select the modulation technique from a plurality of modulation techniques based at least in part on the total harmonic distortion.

In some aspects, the techniques described herein relate to a motor assembly, wherein the plurality of modulation techniques includes minimum commutation loss (MCL) modulation, space vector modulation with one zero vector per switching sequence (SVM 1z), space vector modulation with two zero vectors per switching sequence (SVM 2z), space vector modulation with three zero vectors per switching sequence (SVM 3z), a carrier based per-phase modulation, or Alesina-Venturini modulation.

In some aspects, the techniques described herein relate to a motor assembly, wherein, in response to determining that the total harmonic distortion exceeds a first distortion threshold, the controller is further configured to modify the modulation technique from MCL to SVM 1z.

In some aspects, the techniques described herein relate to a motor assembly, wherein, in response to determining that the total harmonic distortion exceeds a second distortion threshold, the controller is further configured to modify the modulation technique from SVM 1z to SVM 2z.

In some aspects, the techniques described herein relate to a motor assembly, wherein the second distortion threshold exceeds the first distortion threshold.

In some aspects, the techniques described herein relate to a motor assembly, wherein the controller modifies a selection of the modulation technique from the plurality of modulation techniques to increase the carrier frequency of the matrix converter in response to the total harmonic distortion exceeding a distortion threshold.

In some aspects, the techniques described herein relate to a motor assembly, wherein the controller is further configured to increase a motor speed of the electric motor in response to the total harmonic distortion exceeding a distortion threshold.

In some aspects, the techniques described herein relate to a motor assembly, wherein the controller is further configured to select the modulation technique from the plurality of modulation techniques based at least in part on the temperature of the matrix converter and at least one additional parameter.

In some aspects, the techniques described herein relate to a motor assembly, wherein the at least one additional parameter comprises one or more of the following: temperature; vibration; signal noise; audible noise; energy loss; stress associated with change in voltage over time at terminals of the electric motor; motor speed; maximum torque per ampere; or torque production.

In some aspects, the techniques described herein relate to a method of operating a motor assembly including a matrix converter, the method including: by a hardware processor configured to implement a matrix converter controller, operating the matrix converter using a first modulation technique at a first time, wherein the first modulation technique controls operation of a set of bidirectional switches of the matrix converter, and wherein the first modulation technique is one of a plurality of modulation techniques supported by the matrix converter controller; determining a total harmonic distortion of the matrix converter; determining that the total harmonic distortion does not satisfy a total harmonic distortion threshold; selecting a second modulation technique from the plurality of modulation techniques; and operating the matrix converter using the second modulation technique at a second time that is later than the first time.

In some aspects, the techniques described herein relate to a method, further including: determining a noise profile for the motor assembly, wherein selecting the second modulation technique is based at least in part on the noise profile.

In some aspects, the techniques described herein relate to a method, further including causing a motor of the motor assembly to operate at a higher speed when operating the matrix converter using the second modulation technique than when operating the matrix converter using the first modulation technique.

In some aspects, the techniques described herein relate to a method, wherein the second modulation technique is configured to increase a switching frequency of the set of bidirectional switches compared to the first modulation technique.

In some aspects, the techniques described herein relate to a method, further including: measuring, at a third time that is later than the second time, a temperature of the matrix converter when the matrix converter is operating using the second modulation technique; determining that the temperature does not satisfy a temperature threshold; and reverting operation of the matrix converter to the first modulation technique.

In some aspects, the techniques described herein relate to a method, wherein the first modulation technique includes minimum commutation loss modulation or space vector modulation with one zero vector per switching sequence of the set of bidirectional switches.

In some aspects, the techniques described herein relate to a method, wherein the second modulation technique includes space vector modulation with two zero vectors per switching sequence of the set of bidirectional switches.

In some aspects, the techniques described herein relate to a method, wherein determining the total harmonic distortion includes determining a frequency-weighted total harmonic distortion.

In some aspects, the techniques described herein relate to a method, wherein the total harmonic distortion is determined from a current signal obtained at an input to a terminal of a motor included in the motor assembly.

In some aspects, the techniques described herein relate to a method, further comprising selecting the second modulation technique from the plurality of modulation techniques based at least in part on one or more parameters of the matrix converter or the motor assembly that includes the matrix converter.

In some aspects, the techniques described herein relate to a method, wherein the one or more parameters comprise one or more of the following: a temperature; the total harmonic distortion; vibration; signal noise; audible noise; energy loss; stress associated with change in voltage over time at terminals of the electric motor; motor speed; maximum torque per ampere; or torque production.

In some aspects, the techniques described herein relate to a non-transitory computer-readable medium configured to store computer-executable instructions that when executed by a hardware processor causes the hardware processor to at least: operate a matrix converter of a motor assembly using a first modulation technique at a first time, wherein the first modulation technique controls operation of a set of bidirectional switches of the matrix converter, and wherein the first modulation technique is one of a plurality of modulation techniques supported by a matrix converter controller; determine a total harmonic distortion of the matrix converter; determine that the total harmonic distortion does not satisfy a total harmonic distortion threshold; select a second modulation technique from the plurality of modulation techniques; and operate the matrix converter using the second modulation technique at a second time that is later than the first time.

In some aspects, the techniques described herein relate to a non-transitory computer-readable medium, wherein the computer-executable instructions further cause the hardware processor to at least determine a noise profile for the motor assembly, wherein the second modulation technique is selected based at least in part on the noise profile.

In some aspects, the techniques described herein relate to a non-transitory computer-readable medium, wherein the second modulation technique is configured to operate a motor of the motor assembly at a higher speed than the first modulation technique.

In some aspects, the techniques described herein relate to a non-transitory computer-readable medium, wherein the computer-executable instructions further cause the hardware processor to at least: measure, at a third time that is later than the second time, a temperature of the matrix converter when the matrix converter is operating using the second modulation technique; determine that the temperature does not satisfy a temperature threshold; and revert operation of the matrix converter to the first modulation technique.

In some aspects, the techniques described herein relate to a non-transitory computer-readable medium, wherein the computer-executable instructions further cause the hardware processor to at least select the second modulation technique from the plurality of modulation techniques based at least in part on one or more parameters of the matrix converter or the motor assembly that includes the matrix converter.

In some aspects, the techniques described herein relate to a non-transitory computer-readable medium, wherein the one or more parameters comprise one or more of the following: a temperature; the total harmonic distortion; vibration; signal noise; audible noise; energy loss; stress associated with change in voltage over time at terminals of the electric motor; motor speed; maximum torque per ampere; or torque production.

In some aspects, the techniques described herein relate to a motor assembly including: a motor housing; an electric motor at least partially disposed in the motor housing; a variable frequency drive implementing a matrix converter including a plurality of bidirectional switches; a plurality of sensors, wherein each sensor of the plurality of sensors is configured to determine a metric value for a characteristic of the electric motor, and wherein each sensor of the plurality of sensors measures a different characteristic of the electric motor; a non-volatile memory configured to store a prioritization scheme specifying a prioritization of characteristics for the electric motor, wherein the characteristics are measured by the plurality of sensors; and a controller implemented by a hardware processor, the controller configured to access the prioritization scheme from the non-volatile memory and to select a modulation technique from a plurality of modulation techniques based at least in part on the prioritization scheme and one or more metric values obtained from one or more corresponding sensors of the plurality of sensors, wherein the controller is further configured to control a state of a bidirectional switch from the plurality of bidirectional switches based at least in part on the modulation technique.

In some aspects, the techniques described herein relate to a motor assembly, wherein the plurality of modulation techniques includes minimum commutation loss (MCL) modulation, space vector modulation with one zero vector per switching sequence (SVM 1z), space vector modulation with two zero vectors per switching sequence (SVM 2z), space vector modulation with three zero vectors per switching sequence (SVM 3z), a carrier based per-phase modulation, or Alesina-Venturini modulation.

In some aspects, the techniques described herein relate to a motor assembly, further including a user interface controller configured to present a user interface to a user, wherein the prioritization scheme is received in response to user interaction by the user with the user interface.

In some aspects, the techniques described herein relate to a motor assembly, wherein the prioritization scheme ranks the characteristics of the electric motor.

In some aspects, the techniques described herein relate to a motor assembly, wherein the controller selects the modulation technique based at least in part on a metric value obtained from a sensor of the plurality of sensors associated with the characteristic of the electric motor with a highest ranking.

In some aspects, the techniques described herein relate to a motor assembly, wherein the controller is further configured to determine a composite value based on metric values obtained from the plurality of sensors, and wherein the controller selects the modulation technique based at least in part on whether the composite value satisfies a threshold.

In some aspects, the techniques described herein relate to a motor assembly, wherein the controller is further configured to select a second modulation technique from the plurality of modulation techniques based at least in part on the composite value changing by at least a threshold amount.

In some aspects, the techniques described herein relate to a motor assembly, wherein the controller is further configured to weight each metric value of the one or more metric values based at least in part on the prioritization scheme.

In some aspects, the techniques described herein relate to a motor assembly, wherein the plurality of sensors includes a temperature sensor, a current-based power quality sensor, a voltage-based power quality sensor, a vibration sensor, or a noise sensor.

In some aspects, the techniques described herein relate to a method of operating a motor assembly including a matrix converter, the method including: by a hardware processor configured to implement a matrix converter controller, operating the matrix converter using a first modulation technique at a first time, wherein the first modulation technique controls operation of a set of bidirectional switches of the matrix converter, and wherein the first modulation technique is one of a plurality of modulation techniques supported by the matrix converter controller; determining a prioritization scheme for a set of control factors for the matrix converter; determining, at the first time, a metric value for each metric of a set of metrics associated with the motor assembly, wherein the set of metrics correspond to the set of control factors; ranking the set of metrics based on the prioritization scheme; determining, in order of the ranking of the set of metrics, whether the metric value for each metric satisfies a corresponding threshold; determining that a first metric value associated with a first metric of the set of metrics does not satisfy the corresponding threshold; selecting a second modulation technique from the plurality of modulation techniques based at least in part on the first metric; and operating the matrix converter using the second modulation technique at a second time that is later than the first time.

In some aspects, the techniques described herein relate to a method, wherein selection of the second modulation technique is further based at least in part on the first metric value associated with the first metric.

In some aspects, the techniques described herein relate to a method, wherein the first metric is a highest ranked metric in the set of metrics based on the prioritization scheme.

In some aspects, the techniques described herein relate to a method, wherein a second metric is ranked higher than the first metric in the set of metrics based on the prioritization scheme, and wherein a second metric value associated with the second metric satisfies the corresponding threshold.

In some aspects, the techniques described herein relate to a method, further including ceasing to determine, in the order of the ranking of the set of metrics, whether the metric value for each metric satisfies the corresponding threshold in response to determining that the first metric value does not satisfy the corresponding threshold.

In some aspects, the techniques described herein relate to a method, wherein the matrix converter operates at a carrier frequency, and wherein selecting the second modulation technique includes determining a modification to the carrier frequency based at least in part on the first metric value.

In some aspects, the techniques described herein relate to a method, further including: determining, at a third time that is later than the second time, that a second metric value associated with the first metric satisfies the corresponding threshold or a corresponding threshold adjusted by a hysteresis band; and restoring operation of the matrix converter to operation using the first modulation technique.

In some aspects, the techniques described herein relate to a non-transitory computer-readable medium configured to store computer-executable instructions that when executed by a hardware processor causes the hardware processor to at least: operate a matrix converter of a motor assembly using a first modulation technique at a first time, wherein the first modulation technique controls operation of a set of bidirectional switches of the matrix converter, and wherein the first modulation technique is one of a plurality of modulation techniques supported by the matrix converter controller; determine a prioritization scheme for a set of metrics for the motor assembly; determine, at the first time, a metric value for each metric of the set of metrics associated with the motor assembly; rank the set of metrics based on the prioritization scheme; determine, in order of the ranking of the set of metrics, whether the metric value for each metric satisfies a corresponding threshold; determine that a first metric value associated with a first metric of the set of metrics does not satisfy the corresponding threshold; selecting a second modulation technique from the plurality of modulation techniques based at least in part on the first metric; and operating the matrix converter using the second modulation technique at a second time that is later than the first time.

In some aspects, the techniques described herein relate to a non-transitory computer-readable medium, wherein the computer-executable instructions further cause the hardware processor to at least cease determining, in the order of the ranking of the set of metrics, whether the metric value for each metric satisfies the corresponding threshold in response to determining that the first metric value does not satisfy the corresponding threshold.

In some aspects, the techniques described herein relate to a non-transitory computer-readable medium, wherein the matrix converter operates at a carrier frequency, and wherein selecting the second modulation technique includes determining a modification to the carrier frequency based at least in part on the first metric value.

In some aspects, the techniques described herein relate to a non-transitory computer-readable medium, wherein the computer-executable instructions further cause the hardware processor to at least: determine, at a third time that is later than the second time, that a second metric value associated with the first metric satisfies the corresponding threshold or a corresponding threshold adjusted by a hysteresis band; and restore operation of the matrix converter to operation using the first modulation technique.

In some aspects, the techniques described herein relate to a motor assembly including: a motor housing; an electric motor at least partially disposed in the motor housing; a variable frequency drive implementing a matrix converter including a plurality of bidirectional switches; and a controller implemented by a hardware processor, the controller configured to: access a parameter value for a parameter associated with operation of the electric motor; select a modulation technique that satisfies the parameter value from among a plurality of modulation techniques supported by the matrix converter; determine a carrier frequency that satisfies the parameter value, wherein the carrier frequency corresponds to a rate at which the controller modifies switching states of the plurality of bidirectional switches when implementing the modulation technique; and cause the matrix converter to operate using the modulation technique at the carrier frequency.

In some aspects, the techniques described herein relate to a motor assembly, further including a user interface controller configured to present a user interface to a user, wherein the parameter value is received in response to user interaction by the user with the user interface.

In some aspects, the techniques described herein relate to a motor assembly, wherein the parameter is one of a plurality of parameters, and wherein the controller is further configured to: access a plurality of parameter values corresponding to the plurality of parameters; and select the modulation technique that satisfies the plurality of parameter values.

In some aspects, the techniques described herein relate to a motor assembly, wherein the controller is further configured to determine the carrier frequency that satisfies the plurality of parameter values.

In some aspects, the techniques described herein relate to a motor assembly, wherein the plurality of parameters are ranked and wherein the controller is further configured to select the modulation technique that satisfies at least the parameter value associated with a highest ranked parameter of the plurality of parameters.

In some aspects, the techniques described herein relate to a motor assembly, wherein the controller is further configured to: determine an operating state of the motor assembly; determine that the operating state does not satisfy the parameter value; select at least one of a second modulation technique from the plurality of modulation techniques or a modified carrier frequency; and cause the matrix converter to operating using the at least one of the second modulation technique or the modified carrier frequency.

In some aspects, the techniques described herein relate to a motor assembly, wherein the plurality of modulation techniques includes minimum commutation loss (MCL) modulation, space vector modulation with one zero vector per switching sequence (SVM 1z), space vector modulation with two zero vectors per switching sequence (SVM 2z), space vector modulation with three zero vectors per switching sequence (SVM 3z) a carrier based per-phase modulation, or Alesina-Venturini modulation.

In some aspects, the techniques described herein relate to a method of operating a motor assembly including a matrix converter having a plurality of bidirectional switches, the method including: by a hardware processor configured to implement a matrix converter controller, accessing a parameter value for a parameter associated with operation of the motor assembly; selecting a modulation technique that satisfies the parameter value from among a plurality of modulation techniques that the matrix converter controller is configured to implement; determining a carrier frequency that satisfies the parameter value; and operating the matrix converter using the modulation technique at the carrier frequency.

In some aspects, the techniques described herein relate to a method, wherein the carrier frequency corresponds to a rate at which the matrix converter controller modifies switching states of the plurality of bidirectional switches when implementing the modulation technique.

In some aspects, the techniques described herein relate to a method, further including receiving the parameter value in response to user interaction with a user interface.

In some aspects, the techniques described herein relate to a method, wherein the parameter value includes an indication of priority for the parameter.

In some aspects, the techniques described herein relate to a method, wherein the parameter value includes a target value for the parameter.

In some aspects, the techniques described herein relate to a method, wherein the parameter is one of a plurality of parameters, and wherein the method further includes: accessing a plurality of parameter values corresponding to the plurality of parameters; and basing selection of at least one of the modulation technique or the carrier frequency on whether the selection satisfies at least one of the plurality of parameter values.

In some aspects, the techniques described herein relate to a method, wherein the plurality of parameters are ranked and wherein the method further includes selecting the modulation technique that satisfies at least the parameter value associated with a highest ranked parameter of the plurality of parameters.

In some aspects, the techniques described herein relate to a method, further including: determining an operating state of the motor assembly; determining that the operating state does not satisfy the parameter value; selecting a second modulation technique from the plurality of modulation techniques; and operating the matrix converter using the second modulation technique.

In some aspects, the techniques described herein relate to a method, further including: determining an operating state of the motor assembly; determining that the operating state does not satisfy the parameter value; determining a second carrier frequency that satisfies the parameter value; and operating the matrix converter using the modulation technique at the second carrier frequency.

In some aspects, the techniques described herein relate to a non-transitory computer-readable medium configured to store computer-executable instructions that when executed by a hardware processor causes the hardware processor to at least: access a parameter value for a parameter associated with operation of a motor assembly; select a modulation technique, based at least in part on the parameter value, from among a plurality of modulation techniques, wherein the hardware processor controls a matrix converter of the motor assembly based at least in part on the modulation technique; determine a carrier frequency that satisfies the parameter value; and operate the matrix converter based at least in part on the modulation technique and the carrier frequency.

In some aspects, the techniques described herein relate to a non-transitory computer-readable medium, wherein the parameter is one of a plurality of parameters, and wherein the computer-executable instructions further cause the hardware processor to at least: access a plurality of parameter values corresponding to the plurality of parameters; generate a composite score based at least in part on the plurality of parameter values and a weighting of the plurality of parameters; and select the modulation technique based at least in part on the composite score.

In some aspects, the techniques described herein relate to a non-transitory computer-readable medium, wherein the computer-executable instructions further cause the hardware processor to at least: determine an operating state of the motor assembly at a first time; determine that the operating state does not satisfy the parameter value; select a second modulation technique from the plurality of modulation techniques; and operate the matrix converter using the second modulation technique.

In some aspects, the techniques described herein relate to a non-transitory computer-readable medium, wherein the computer-executable instructions further cause the hardware processor to at least: determine a second operating state of the motor assembly at a second time that is later than the first time; determine that the second operating state satisfies the parameter value; and restore operation of the matrix converter to use of the modulation technique.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure. In addition, various features of different disclosed embodiments can be combined to form additional embodiments, which are part of this disclosure. Further, one or more features or structures can be removed or omitted. The drawing includes the following Figures, which are not necessarily drawn to scale.

FIG. 1 is an exploded view of one embodiment of a motor assembly for driving a pump or rotary device in accordance with certain embodiments.

FIG. 2 is a cross-sectional view of part of the motor assembly of FIG. 1 in accordance with certain embodiments.

FIG. 3 is a front view (mid-plate side) of the end-plate of the motor assembly of FIG. 1 in accordance with certain embodiments.

FIG. 4 and FIG. 5A are a back view and a front perspective view, respectively, of the end-plate of the motor assembly of FIG. 1 in accordance with certain embodiments.

FIG. 5B is an exploded perspective view of the motor, terminal box, mid-plate, and end-plate in accordance with certain embodiments.

FIG. 6 is a perspective view of the end-plate 140 of the motor assembly of FIG. 1 with the conductive cover removed in accordance with certain embodiments.

FIG. 7 is a perspective view of the multi-board power plane and the corresponding electronics in accordance with certain embodiments.

FIG. 8 is an exploded view of the end-plate and its internal components (e.g., multi-board power plane) in accordance with certain embodiments.

FIG. 9 is a cross-section view of the end-plate and its internal components (e.g., multi-board power plane) in accordance with certain embodiments.

FIG. 10A and FIG. 10B are a front cross-section views (mid-plate side) of the end-plate and the motor assembly of FIG. 1 in accordance with certain embodiments.

FIG. 11 is a front view (e.g., mid-plate side) of the power layer of the multi-board power plane in accordance with certain embodiments.

FIG. 12 is a back view (e.g., fan side) of the power layer of the multi-board power plane in accordance with certain embodiments.

FIG. 13 and FIG. 14 are front and back views, respectively, of the control layer of the multi-board power plane in accordance with certain embodiments.

FIG. 15 and FIG. 16 are front and back views, respectively, of the second control layer of the multi-board power plane in accordance with certain embodiments.

FIG. 17A and FIG. 17B are front and back views of the control PCB board and housing of the third control layer of the multi-board power plane in accordance with certain embodiments.

FIG. 18 shows front and back views of the switched-mode power supply of the multi-board power plane in accordance with certain embodiments.

FIG. 19 and FIG. 20 are a front and front-perspective view, respectively of the mid-plate of the motor assembly of FIG. 1 in accordance with certain embodiments.

FIG. 21 and FIG. 22 are a back and back-perspective view, respectively of the mid-plate of the motor assembly of FIG. 1 in accordance with certain embodiments.

FIG. 23 is a perspective view of the motor assembly of FIG. 1 in accordance with certain embodiments.

FIG. 24A, FIG. 24B, and FIG. 24C are top views of the terminal box of the motor assembly of FIG. 1 in accordance with certain embodiments.

FIG. 25 is a schematic diagram of a matrix converter according to certain embodiments.

FIG. 26 is a schematic diagram of a clamp for a matrix converter in accordance with certain embodiments.

FIG. 27 is a schematic diagram of a portion of circuitry of a matrix converter in accordance with certain embodiments.

FIG. 28A is a schematic diagram of a bidirectional switch according to certain embodiments.

FIG. 28B is a schematic diagram of a bidirectional switch according to certain embodiments.

FIG. 28C is a schematic diagram of a bidirectional switch according to certain embodiments.

FIG. 29 is a schematic diagram of a matrix converter according to certain embodiments.

FIG. 30A shows a diagram of a bi-directional switch for implementing some part of the power functionality, e.g., of the power plane, according to some embodiments, and FIG. 30B shows an example of a bi-directional switch power module for implementing some part of the power functionality, according to some embodiments.

FIG. 31A and FIG. 31B illustrate a block diagram of certain elements of a motor system in accordance with certain embodiments.

FIG. 32 illustrates a circuit diagram of a portion of a matrix converter according to certain embodiments.

FIG. 33 presents a flowchart of an example modulation selection process based on temperature in accordance with certain embodiments.

FIG. 34 presents a flowchart of an example modulation selection process based on total harmonic distortion in accordance with certain embodiments.

FIG. 35 presents a flowchart of an example control factor prioritization based modulation selection process in accordance with certain embodiments.

FIG. 36 presents a flowchart of an example parameter-based modulation and carrier frequency modification process in accordance with certain embodiments.

FIG. 37A presents a set of graphs illustrating one non-limiting example of operation of a matrix converter in accordance with certain embodiments.

FIG. 37B is a continuation of the set of graphs illustrated in FIG. 37A in accordance with certain embodiments.

The drawings include examples of possible implementations; and the scope is not intended to be limited to the implementations shown therein. For example, the scope is intended to include, and embodiments are envisioned using, other implementations besides, or in addition to, that shown in the drawings, which may be configured within the spirit of the disclosure in the present application as a whole.

### DETAILED DESCRIPTION

A motor assembly may drive a pump or rotary device. The motor assembly may include a motor. The motor may be at least partially housed or supported by a motor frame and may include a stator arranged therein, a rotor coupled to the motor, one or more plates that can include a bearing housing, electronics, insulation, gaskets, and thermal adjustment mechanism (e.g., heatsinks, cooling fins, fans, etc.). The motor frame may also include a terminal box that can include at least some of the electronics of the motor assembly, such as a control system, which may include a variable frequency drive, configured for controlling the operation of the motor, which in turn is used for driving the pump or other rotary device. The motor frame may be or may include a motor housing that, at least in part, houses or supports the motor.

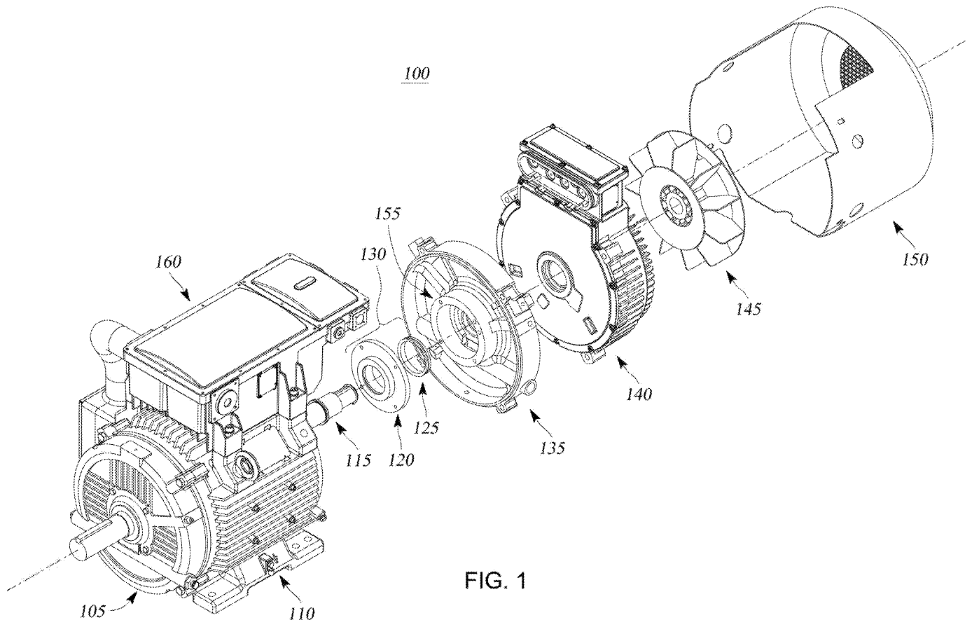

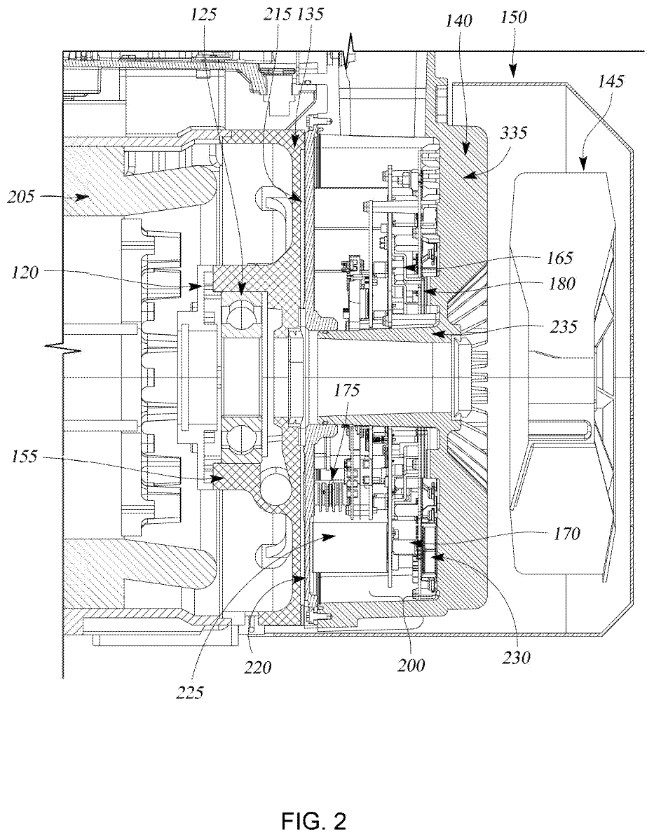

FIG. 1 is an exploded view of one embodiment of a motor assembly 100 for driving a pump or rotary device. The motor assembly 100 may be used for driving a pump, compressor, fan, and/or rotary device (not shown). The motor assembly 100 includes a motor 105. The motor 105 may include a motor frame 110 with a space envelope (e.g., cavity) that at least partially envelops a stator 205 (see FIG. 2) and a rotor 115.

A variable frequency electronics drive unit includes a mid-plate 135 and an end-plate 140. The rotor 115 of the illustrated embodiment extends through and couples to the mid-plate 135, the end-plate 140, and/or a fan 145. As shown, the variable frequency drive unit including the mid-plate 135 and the end-plate 140 can be axially mounted to the motor frame 110 in an in-line configuration, extending from the non-drive end side of the motor frame 110. In some cases, one or more of the mid-plate 135 or the end-plate 140 are be directly mounted to the motor 105. In other cases, the mid-plate 135 and/or the end-plate 140 are indirectly mounted in that there may be one or more elements between the mid-plate 135 and/or the end-plate 140 and the motor 105, such as an additional plate or a thermal layer. In some embodiments, the fan 145 is powered by the motor 105 (e.g., as in the illustrated embodiment via the rotor 115).

The mid-plate 135 may have a bearing housing flange portion 155. The motor 105 can includes a motor bearing assembly 130 that includes a bearing assembly 125, a front grease retainer 120, and/or a rear grease retainer (not shown). The end-plate 140 may include a multi-board power plane 200 (see FIG. 2). In other embodiments, the end-plate 140 may include a power plane or power layer 800 of any of the embodiments described herein.

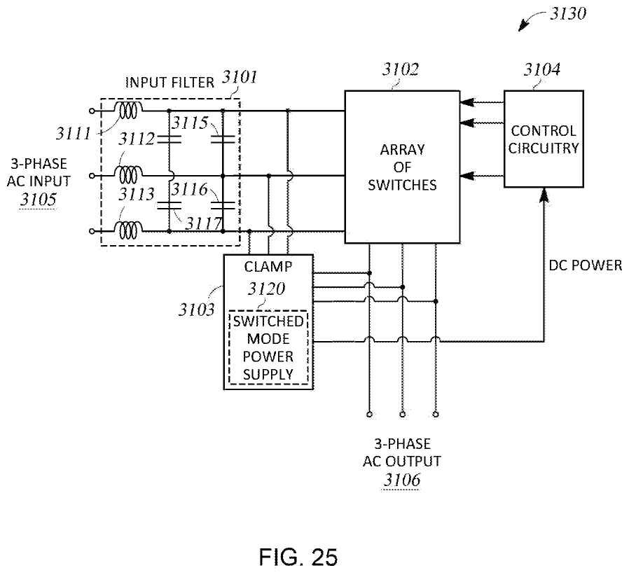

The motor assembly 100 may also, or alternatively, include a shroud 150 and a terminal box 160. In some embodiments, the terminal box 160 is attached to the top of the motor frame 110 and may include electronics, e.g., electronics of a variable frequency drive including capacitors, inductors, and/or power modules. The terminal box 160 will be described in more detail below. In some embodiments, the electronic components of the variable frequency drive (VFD) and/or matrix converter may be split between the terminal box 160 and the end-plate 140. As one example, the matrix converter can include some or all of the components of the matrix converter 3130 of FIG. 25, where the inductors 3111, 3112, 3113 are included in the terminal box 160, and some or all of the remaining components of the matrix converter 3130, such as the array of switches 3102 and or capacitors 3115, 3116, 3117, are included in the end-plate 140. As described herein, the electronic components of the variable frequency drive may include one or more circuit boards, power modules, and power control components.

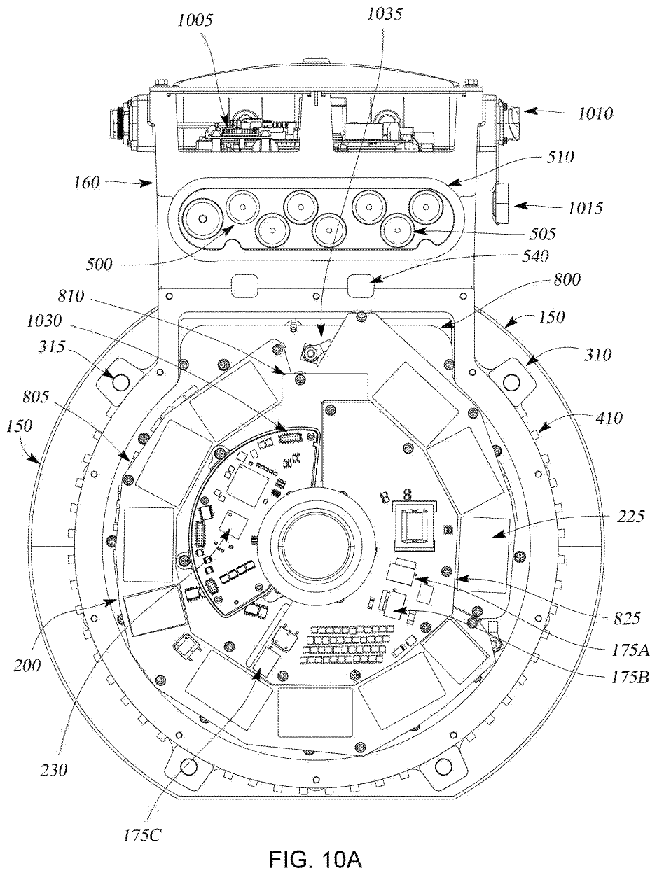

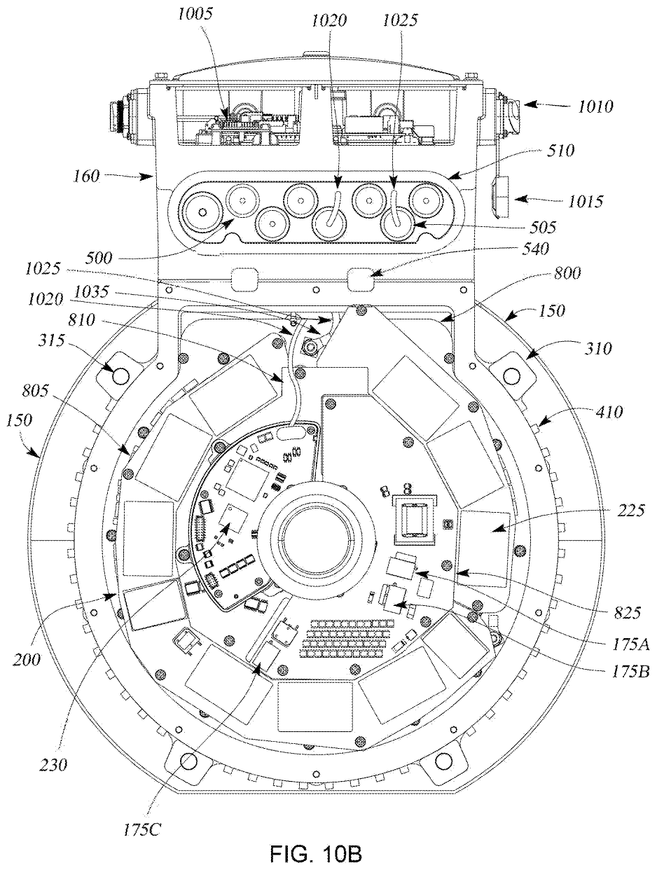

FIG. 2 is a cross-sectional view of part of the motor assembly 100 of FIG. 1. As described above, the end-plate 140 may have a multi-board power plane 200. For example, the multi-board power plane 200 may include two, three, four, five, six, or more than six separate printed circuit boards. In some embodiments, the multi-board power plane 200 may have one or more power layers or segments and one or more control layers or segments. Alternatively, or in addition, the multi-board power plane 200 may include the electronics of a variable frequency drive and/or a matrix converter (e.g., one or more power modules and power control components). For example, one or more of the PCB boards of the multi-board power plane 200 may include high temperature components 230 (e.g., power semi-conductors, power modules, etc.) while one or more other PCBs include low temperature (e.g., temperature sensitive) components 225 (e.g., control electronics, power quality filter capacitors, etc.). One or more of the low temperature components 225 may be coupled to a heat sink 175A, 175B, 175C (see FIG. 10A) to advantageously cool the low temperature components 225. The heat sinks 175A, 175B, 175C may have cooling fins to improve heat dissipation.

In some embodiments, the multi-board power plane 200 may include a communication board. The communication board may facilitate communication between the power layers and the control layers. However, in some embodiments, the power layers and control layers communicate to each other without using a separate communication board. For example, the power layers and control layers may be connected to each other through data connectors 170, which can be PCB-to-PCB connectors, for example, allowing components on the different layers to communicate with one another. Similarly, the power layers and control layers may be connected to a power distribution system via one or more busbars 165, 180. In some embodiments, the busbar 165 may be a double-L bar made of a conductive material (e.g., copper, gold). Additionally, or alternatively, the multi-board power plane 200 may include a busbar 180 that is toroidal-shaped or cylindrical-shaped that encircles the central column 235 of the end-plate 140. It should be noted that the multi-board power plane 200 may include one or more busbars of any other shape to connect the PCB boards and electrical components to one or more power distribution systems.

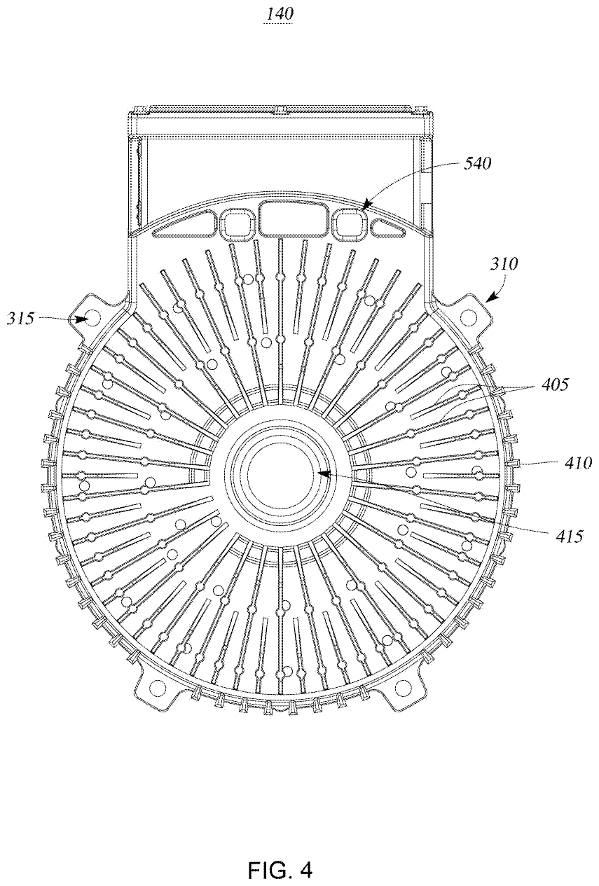

The first side of the end-plate 140 may be coupled to the second side of the mid-plate 135. The first side of the end-plate 140 may have a thermally conductive cover 220. In some embodiments, some or all of the low temperature components 225 (e.g., some of the electronic components of the variable frequency drive) are in physical contact with the conductive cover 220. Thus, the end-plate 140 may advantageously have a thermal pathway for dissipating the heat from, e.g., the low temperature components 225 to the conductive cover 220 (e.g., the conductive cover 220 acts as a heat sink). The conductive cover 220 may be made of any thermally conductive material (e.g., copper, gold), including any materials described herein. Furthermore, the high temperature components 230 may be in physical contact with the end-plate housing 335. Thus, the end-plate 140 may advantageously have a thermal pathway for dissipating the heat from the high temperature components 230 to the end-plate housing 335 and further to the radial cooling fins 405 and peripheral cooling fins 410 (FIG. 4). The end-plate housing 335 may be made of any thermally conductive material (e.g., metal, such as aluminum, steel, etc.), including any materials described herein. Thus, the end-plate 140 may efficiently dissipate the heat caused by the operation of the motor 105 and the multi-board power plane 200 away from the electronic components and to the external environment.

Furthermore, referring to FIG. 1 again, the motor assembly 100 may include a thermal insulation gap 215 between the end-plate 140 and the mid-plate 135. The thermal insulation gap 215 may be an insulative air gap. Advantageously, the insulative air gap 215 may be made narrow to the reduce the size of the motor assembly 100, while wide enough to allow heat to escape and reduce heat transfer between the mid-plate 135 and the end-plate 140. For example, the insulative air gap may have a thickness of 1 mm, 2, mm, 3.5 mm, 5 mm, 10 mm, more than 10 mm, or any thickness in-between. Alternatively, in higher temperature applications, the insulative air gap 215 may be 1 cm, 2 cm, 5 cm, 10 cm, more than 10 cm, or any thickness in-between. The insulative air gap 215 may inhibit (e.g., prevent or limit) the heat emitted from the motor 105 from reaching the electrical components in the end-plate 140. In some embodiments, the insulative air gap 215 may be connected to the external environment (e.g., through a vent or gap at mid-plate/end-plate coupling point) and allow at least some portion of the heat generated by the motor 105 and low temperature components 225 to be transferred to the external environment. Thus, the insulative air gap 215 may advantageously protect the electronic components in the end-plate 140 from the heat of the motor 105 while simultaneously enabling the motor 105 and the conductive cover 220 to dissipate heat. Alternatively, or in addition, the thermal insulation gap 215 may be a layer of any non-conductive material.

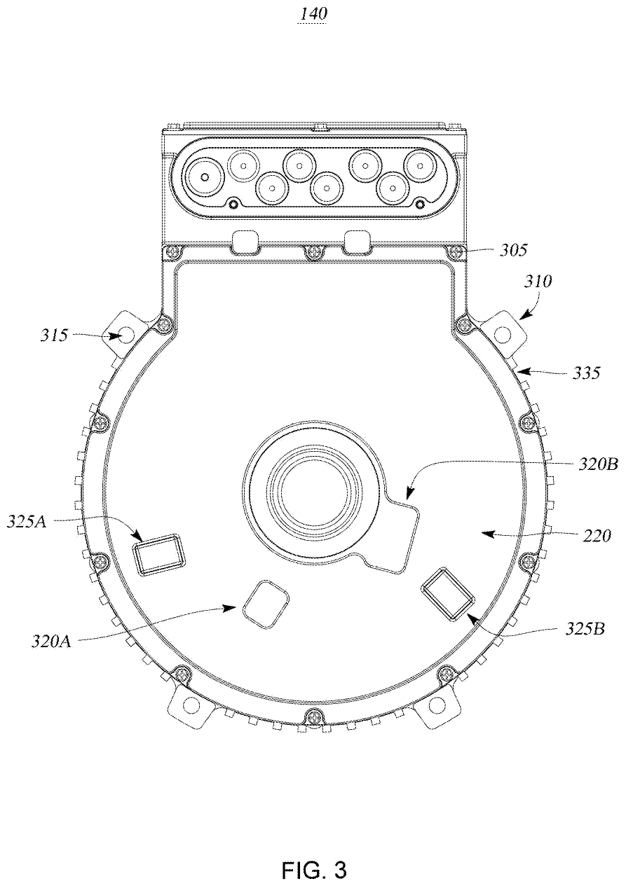

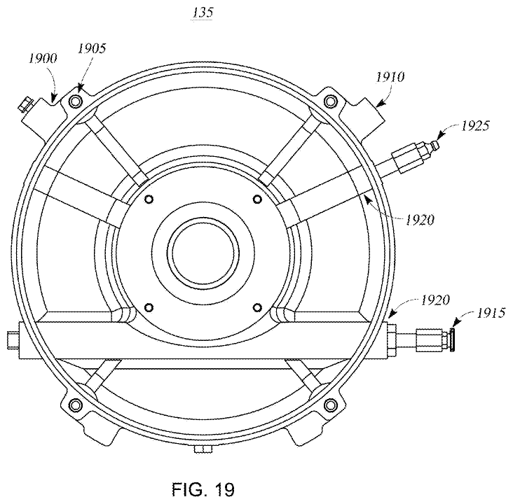

FIG. 3 is a front view (mid-plate 135 side) of the end-plate 140 of the motor assembly 100 of FIG. 19. The conductive cover 220 may be coupled to the end-plate housing 335 via one or more fasteners 305 (e.g., screws, snap-fit connectors, etc.). Alternatively, or in addition, the end-plate 140 may have one or more retaining members 310 (e.g., four) that include an aperture 315 for receiving a fastener (e.g., a dowel, screw or threaded bolt, snap-fit connector, etc.) to fasten the end-plate 140 to the mid-plate 135. The retaining members 310 may be mounting guides that advantageously help a user assemble the motor assembly 100. For example, a user may slide one or more dowels or bolts into the apertures 315 and easily push the end-plate 140 into place (e.g., in-between the mid-plate 135 and fan 145). In some embodiments, the dowels may be tapered to make it easier to insert the dowels into the aperture 315. Furthermore, the retaining members 310 may axially protrude beyond the conductive cover 220 to leave space for or set the thickness of the thermal insulation gap 215 between the end-plate 140 and mid-plate 135. However, in some embodiments, the retaining members 310 may be co-planar with the conductive cover 220.

In some alternative embodiments, the apertures 315 of the retaining member 310 receive dowels or bolts that are attached to the motor frame 110 (e.g., instead of the mid-plate 135). Similarly, the mid-plate 135 may have apertures 1905 (see FIG. 19) that receive dowels or bolts that are attached to the motor frame 110, to secure the mid-plate 135 to the motor frame 110. For example, the mid-plate 135 and end-plate 140 may either (1) receive the same bolts from the motor frame 110 (e.g., same bolt extends from motor frame 110 through aligned apertures in the mid-plate 135 and end-plate 140) or (2) have different dowels or bolts (e.g., one set for the mid-plate 135 and a second set for the end-plate 140). Thus, the retaining members 310 may advantageously help a user align and easily couple the end-plate 140 to motor frame 110 with the mid-plate 135 in-between.

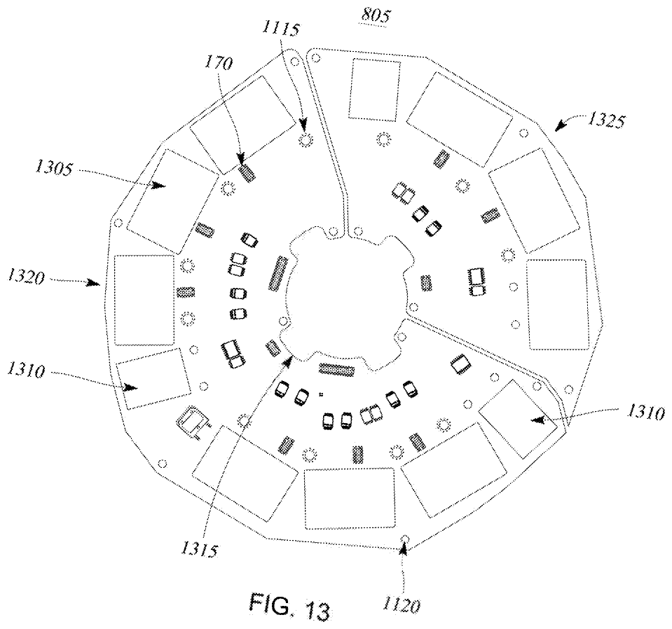

The conductive cover 220 may have one or more protruded sections 320A, 320B, and/or receded sections 325A, 325B. Each of the protruded sections 320A, 320B and receded sections 325A, 325B may advantageously correspond to one or more electronic components. For instance, if an electronic component mounted within the end-plate 140 is shorter than the space provided between the PCB board to which the electronic component is mounted and the main surface of the conductive cover 220, the conductive cover 220 may have a receded section 325A, 325B extending towards the electronic component (e.g., a power quality filter component), bringing the electronic component into physical contact with the conductive cover 220. For example, in the illustrated embodiment, the two clamp capacitors 1310 capacitors 1310 (see FIG. 13) are shorter than other electronic components mounted to the PCB board of the control layer 805 (see FIG. 13) and the main surface of the conductive cover 220 (e.g., shorter than the power quality capacitors 1305). To compensate for the disparity in length, the one or more clamp capacitors 1310 are each mounted to the PCB board of the control layer 805 on a first end of the respective clamp capacitor 1310 and contact a corresponding receded section 325A or 325B of the conductive cover 220 on a second end of the respective clamp capacitor 1310. Thus, the one or more clamp capacitors 1310 may effectively dissipate heat via the conductive cover 220 while being mounted next to longer electronic components.

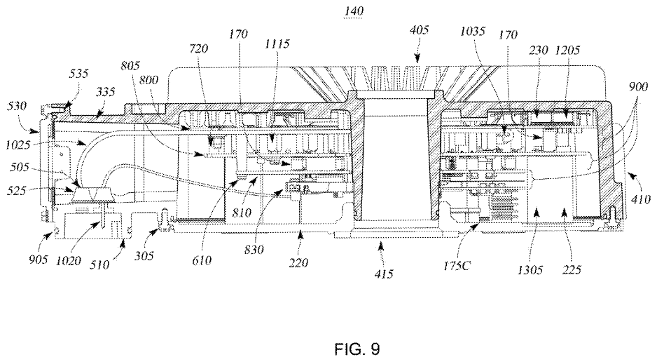

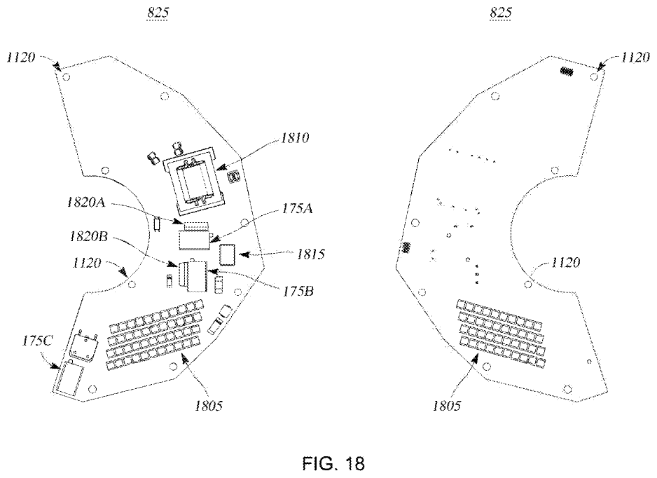

In some embodiments, if the electronic component is taller than the space provided between the PCB board to which the electronic component is mounted and the main surface of the conductive cover 220, the conductive cover 220 may have protruded sections 320A, 320B to accommodate the taller electronic component. For example, in the illustrated embodiment, one or more heat sinks 175A, 175B, 175C may be longer than other electronic components mounted to the PCB board 825 (see FIG. 9 and FIG. 18) and the main surface of the conductive cover 220. To compensate for the disparity in length, the heat sinks 175A, 175B, 175C are mounted to the PCB board 825 on a first end of each respective heat sink 175A, 175B, 175C and contact a corresponding protruded section 320A (heat sinks 175A, 175B) or 320B (heat sinks 175A, 175B) of the conductive cover 220 on a second end of the respective heat sink 175A, 175B, 175C. Thus, the heat sinks 175A, 175B, 175C may effectively dissipate heat via the conductive cover 220 while being mounted next to shorter electronic components.

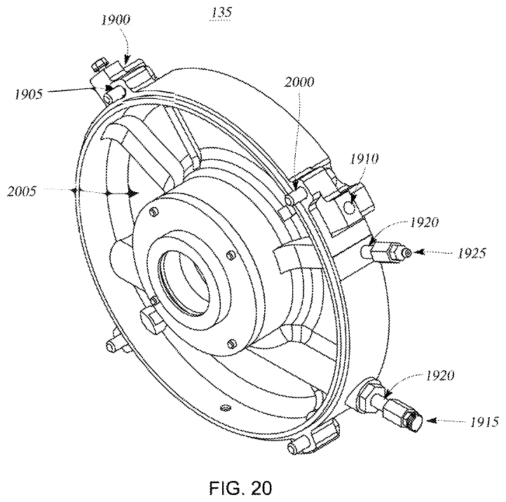

Thus, electronic components of different dimensions may be used without disrupting the thermal pathways for dissipating heat (e.g., from the low temperature components 225 to the conductive cover 220 to the thermal insulation gap 215/external environment). Similarly, the heat sinks 175A, 175B, 175C (see, e.g., FIG. 20) may be in physical contact (e.g., be thermally coupled) to the conductive cover 220. Additionally, the physical contact between the electronic components and the conductive cover 220 may provide additional mechanical support for the electronic components to secure them in place. For example, the physical contact may prevent the electronic components from disconnecting or flexing due to the vibrations cause by the motor 105.

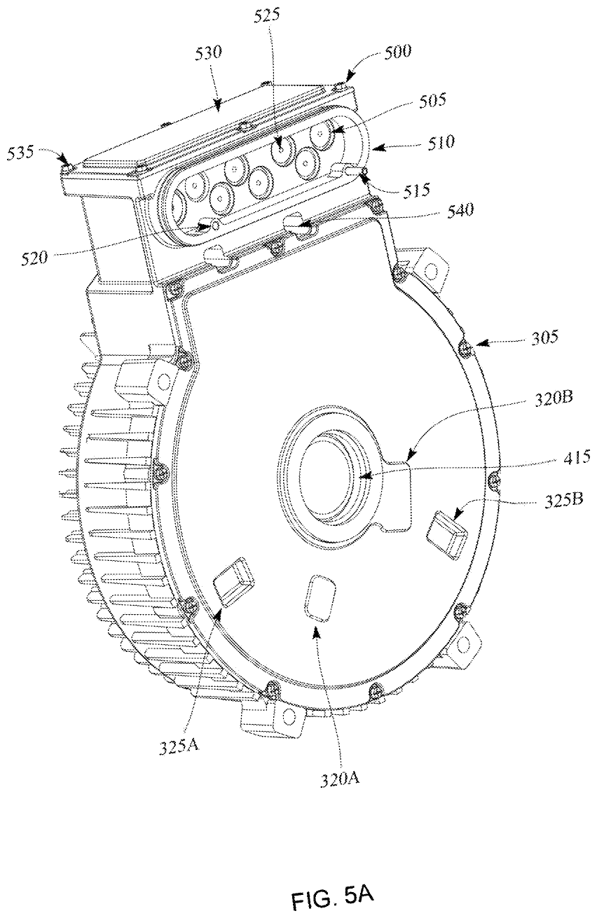

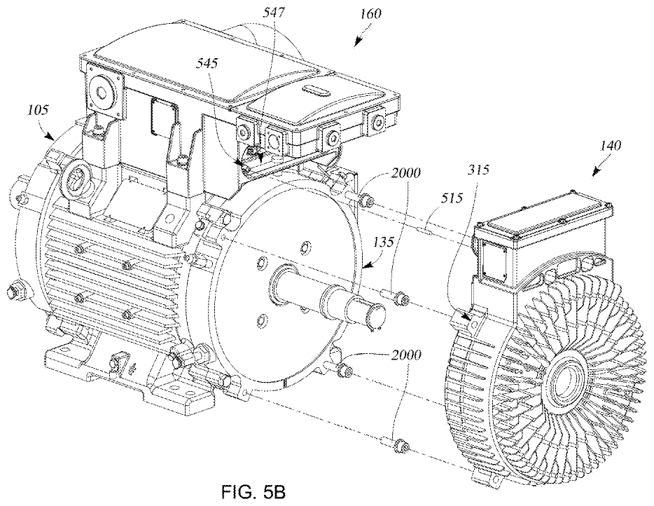

FIG. 4 and FIG. 5A are a back view and a front perspective view, respectively, of the end-plate 140 of the motor assembly 100 of FIG. 1. As described above, the end-plate 140 may have an opening 415, radial cooling fins 405 on the back side or surface of the end-plate 140, and peripheral cooling fins 410 on the side of the end-plate 140. In some embodiments, the end-plate 140 may have a wiring terminal 500 that may couple to the terminal box 160. The wiring terminal 500 may have one or more terminal points 505. For example, the wiring terminal 500 may have one, two, four, eight, ten, twenty, or more than twenty terminal points 505, or any number in-between. In some embodiments, the openings of terminal points 505 may include self-sealing grommets 525. The self-sealing grommets 525 may advantageously prevent moisture, dust, grease, and/or excess heat from entering the wiring terminal 500.

In some embodiments, the wiring terminal 500 has a top cover 530. The top cover 530 may include a gasket and may be attached to the wiring terminal 500 by one or more fasteners 535 (e.g., screws, magnets, snap-fit, etc.). Removing the top cover 530 allows a user to quickly install and repair any connections inside the wiring terminal 500. In some embodiments, the wiring terminal 500 is water-proof and dust-proof when the top cover 530 is attached. For example, the end-plate 140 and wiring terminal 500 may have a high ingress protection (IP) rating (e.g., IP 66) and not allow any dust and/or water to enter. Alternatively, the end-plate 140 and wiring terminal 500 may have a lower IP rating (e.g., IP 55) when the motor assembly 100 is being installed in less harsh environments.

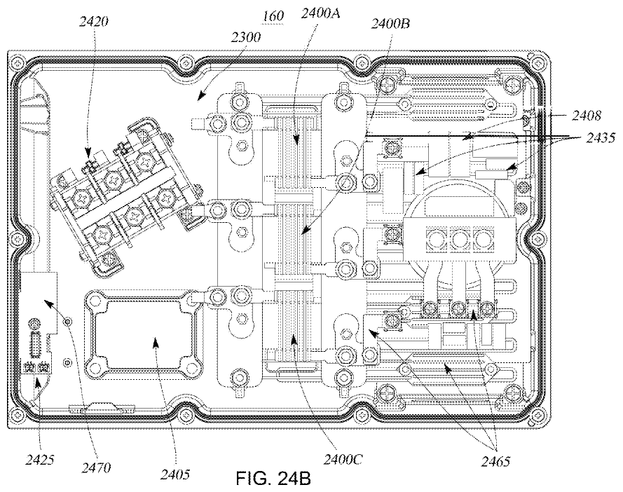

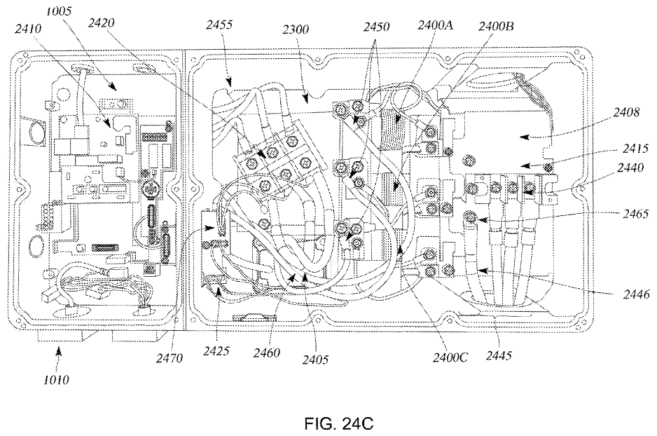

The wiring terminal 500 may have one or more retaining members 520 comprising an aperture. The retaining members 520 can receive dowels or other elongate guide members 515 which can couple to corresponding aperture of the terminal box 160. In the embodiment illustrated in FIG. 24A, the guide member 515 is a dowel 515 configured to couple to an aperture in the terminal box 160, and to guide alignment of the end-plate 140 with the mid-plate 135 and motor frame 110. While FIG. 5A only shows the rightmost retaining member 520 including a dowel 515, the other retaining member 520 can also include a dowel (as shown in FIG. 1).

FIG. 5B is an exploded perspective view of the motor 105, terminal box 160, mid-plate 135, and end-plate 140. As described in more detail below, the mid-plate 135 may be attached to the motor 105 via screws 2000, bolts, or other retaining hardware. During installation of the end-plate 140, the user can insert the dowels 515 into corresponding retaining members 545 on the terminal box 160, facilitating alignment of the end-plate 140. Then the user can insert threaded bolts through the apertures 315 for threaded mating with the corresponding apertures 2100 of the mid-plate 135 (which are aligned with the apertures 315 through the use of the dowels 515), thereby fastening the end-plate 140 to the mid-plate 135. In other embodiments, the gender of the guide features can be reversed, e.g., such that the dowels or other male elongate guide members 515 are held in the motor frame 110 and the end-plate 140 has apertures configured to receive the guide members 515 during installation.

For example, the end-plate 140 can include guides 315 that can mate with corresponding apertures on the terminal box 160 that are shaped to mate with the guides 315, thereby facilitating alignment of the end-plate 140 prior to fastening the end-plate 140 to the mid-plate 135 using the bolts of the end-plate mounting hardware EMH. The guides 315 are the fixed conduits 315 that form the wire channels, instead of dowels. In other embodiments, the gender of the guide features can be reversed, e.g., the terminal box 160 can include conduits that form the wire channels and the end-plate 140 can include corresponding apertures to receive the conduits that form the wire channels. Alternatively, or in addition, the wiring terminal 500 may use snap-fit connectors, magnets, screws, or any other type of fasteners to couple to the terminal box 160, mid-plate 135, fan 145, and/or any other component of the motor assembly 100.

Referring again to FIG. 5A, in some embodiments, the wiring terminal 500 includes a connection flange 510 and a gasket 905 (see FIG. 9) that facilitates coupling with the terminal box 160. For example, the terminal box 160 may have a corresponding receptacle to receive a connection flange 510. It should be understood that gaskets may be placed in-between any coupled components to prevent dust, water, grease, and/or excess heat from damaging the motor 105 and electronic components.

Referring to FIGS. 5A and 5B, the terminal box 160 can include an opening 547 that receives and mates with the flange 510 of the end-plate 140. The wiring terminal 500 generally facilitates electrical connection between electronics within the end-plate 140 and electronics within the terminal box 160. For instance, for each connection point 505 of the wiring terminal 500, a corresponding wire can extend within the end-plate 140 from a connection to electronics within the end-plate 140, through the grommet 525 of the connection point 505, into the opening 547 of the terminal box 160, and finally within the terminal box 160 to connect to electronics within the terminal box 160.

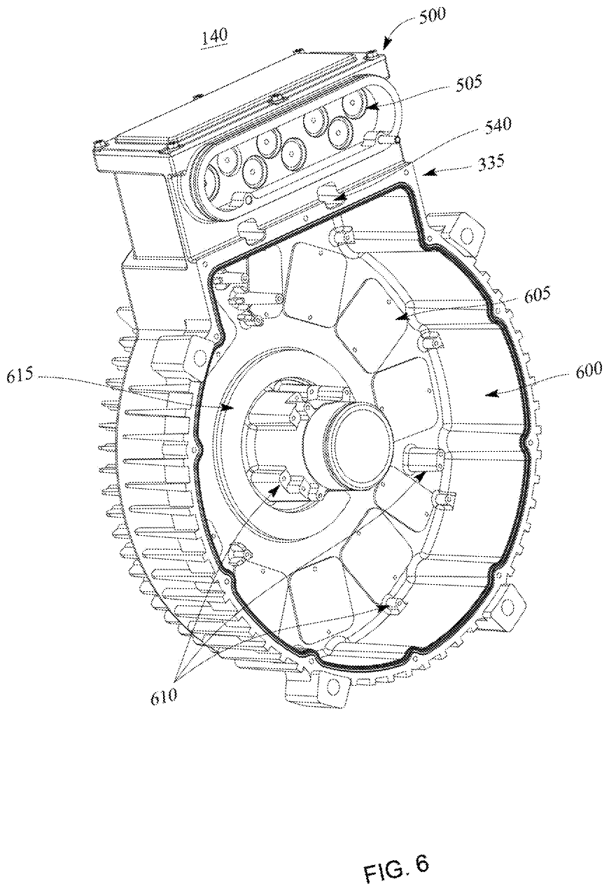

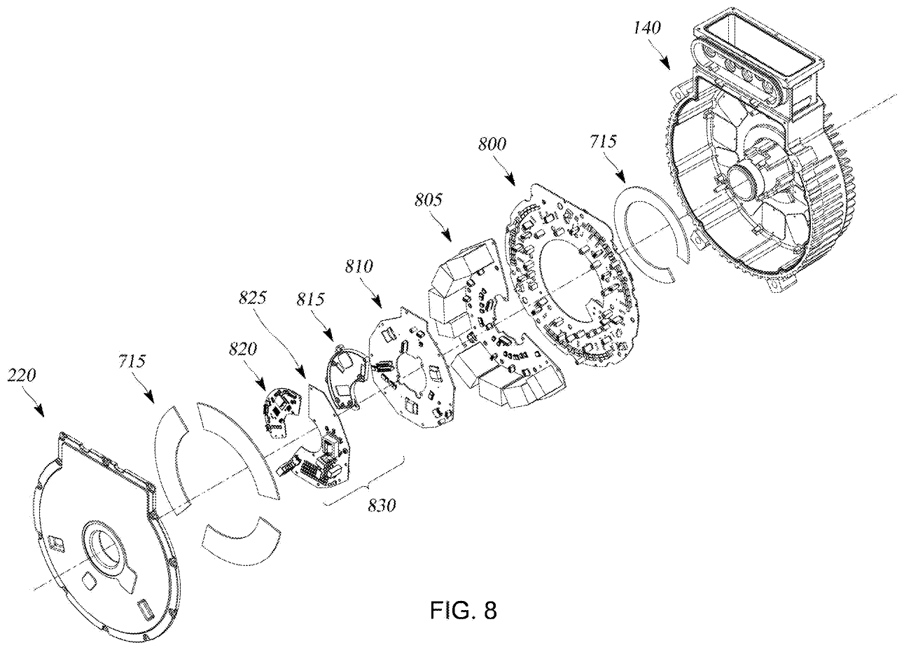

FIG. 6 is a perspective view of the end-plate 140 of the motor assembly 100 of FIG. 1 with the conductive cover 220 removed. In some embodiments, the end-plate 140 may have one or more ventilation channels 540 to allow air flow from the fan 145 to reach the terminal box 160. The air flow in the ventilation channels 540 may also, or alternatively, cool the end-plate 140. In some embodiments, the end-plate 140 may have a space envelope 600 (e.g., a hollow internal area with a periphery defined by a peripheral wall of the end-plate housing 335, a rear wall of the end-plate housing 335, and the cover 220). A gasket (not shown) may be interposed between the conductive cover 220 and the end-plate housing 335 to advantageously prevent moisture, dust, grease, and/or excess heat from entering the space envelope 600. The space envelope 600 may include contact surfaces 605 for the electronic components or other hardware. In some embodiments, the contact surfaces 605 can each comprise one or more layers of conductive epoxy pads. For example, the contact surfaces can be adapted to make contact with the top of the packages of corresponding components on the power layer 800, such as the power modules 1205 and the sensing modules 1206 (see, e.g., FIGS. 8, 9, and 12). Where the contact surfaces 605 are heat conductive, the contact of the top of the components with the corresponding contact surfaces 605 can help draw heat away from the components, onto the back wall of the end plate 140, and out of the end-plate 140, e.g., via the cooling fins 405, 410 of the end plate housing 335. The contact surfaces 605 may each have different dimensions and may protrude (e.g., 1 mm-10 mm) into the space envelope 600 to better accommodate different electronic components. The space envelope 600 may also, or alternatively, have attachment points 610 for the multi-board power plane 200. For example, the attachment points 610 may protrude different amounts for the different levels of the multi-board power plane 200. In some embodiments, the end-plate 140 may have a toroidal-shaped conductive epoxy pads 615 to provide additional heat diffusion (e.g., from the busbar 180 to the end-plate housing 335).

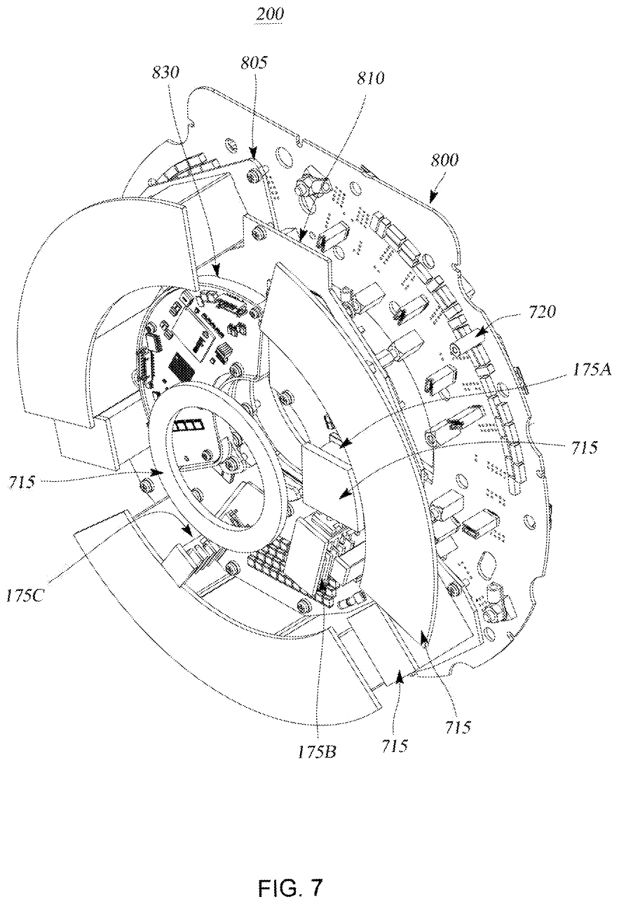

FIG. 7 is a perspective view of the multi-board power plane 200 and the corresponding electronics, dimensioned to fit within the space envelope 600 of the end-plate housing 335. As described above, the multi-board power plane 200 may include one or more control layers and one or more power layers. For example, the multi-board power plane 200 may have a control layer 805, a second control layer 810, a third control layer 830, and a power layer 800. The multi-board power plane 200 may have one or more spacers 720 in-between the layers. In some embodiments, the end-plate 140 includes one or more conductive epoxy pads 715. The conductive epoxy pads 715 may be made of any conductive material (e.g., silver-filled resin) and may be interposed between the conductive cover 220 and the low temperature components 225 and/or heat sinks 175A, 175B, 175C to increase heat diffusion and prevent the low temperature components 225 from overheating. In some embodiments, the conductive epoxy pads 715 are interposed between one or more components and the protruded sections 320A, 320B and/or receded section 325A, 325B (see FIG. 3) of the conductive cover 220. For example, the conductive epoxy pads may be interposed between the heat sinks 175A, 175B, 175C, input filter capacitors 1305, and/or clamp capacitors 1310 (see FIG. 13). It should be understood the conductive epoxy pads 615, 715 may be thermally conductive while being electrically insulative.

FIG. 8 is an exploded view of the end-plate 140 and its internal components including the multi-board power plane 200. In some embodiments, each layer of the multi-board power plane 200 consists of a PCB. Alternatively, or in addition, one or more of the layers may consist of two or more PCB boards. For example, the third control layer 830 may consist of a control PCB board 820 with a housing 815 and a switched-mode power supply 825. The housing 815 may provide additional support for the control PCB board 820, and/or thermal and electric insulation from other electronic components.

In some embodiments, the PCBs of the multi-board power plane 200 are double-sided PCBs with electronic components on both sides. The PCBs may also, or alternatively, be single-sided PCBs or multi-layered PCBs that advantageously allow complex circuits within a small area. Additionally, the PCBs may be made of either rigid or flexible materials. For example, the PCBs may be made of copper, fiberglass, epoxy resin, polyester resin, and/or any other material described herein. In some embodiments, the multi-board power plane 200 may be a toroidal-shaped assembly to advantageously fit in the space envelope 600 of the end-plate 140 while providing interconnections for the input/output power, current sensors, gate driver, clamp control circuit, power/clamp semi-conductor modules, clamp resistors, busbars, and power quality capacitors. In some embodiments, the electronic components (e.g., the power quality filters and/or power modules) are mounted about the center of the multi-board power plane 200 (e.g., in a circular pattern). Furthermore, the multi-board power plane 200 may have an opening to allow the shaft of the motor rotor 115 to pass through.

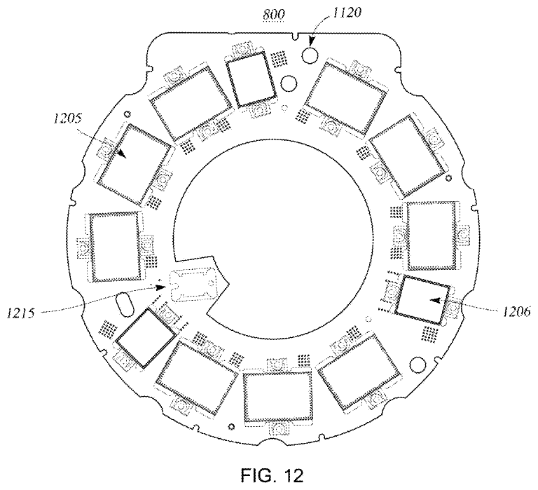

FIG. 9 is a cross-section view of the end-plate 140 and its internal components (e.g., multi-board power plane 200 and/or some or all of the variable frequency drive electronics unit). In some embodiments, the multi-board power plane 200 includes one or more thermal insulation air gaps 900. The thermal insulation air gaps 900 prevent the heat from the power layer 800 and the high temperature components 230 from damaging the low temperature components 225. The exemplary low temperature component 225 referred to in the cross-section of FIG. 9 is a power quality capacitor 1305 (see, e.g., FIG. 13). The exemplary high temperature component 230 referred to in the cross-section of FIG. 9 is one of the power modules 1205 (see, e.g., FIG. 12). The thermal insulation air gaps 900 may have a thickness of 5 mm, 10 mm, 20 mm, 30 mm, 50 mm, or more than 50 mm, or any thickness in-between. For example, the thermal insulation air gap 900 between the power layer 800 and the control layer 805 may be 20 mm, and the thermal insulation air gap 900 between the control layer 805 and the second control layer 810 may be 12 mm. In some embodiments, the thermal insulation air gaps 900 allow the multi-board power plane 200 to satisfy creepage and clearance standards. Thus, the thermal insulation air gaps 900 advantageously prevents high voltage components from electrically interfering with or damaging other electronic components. In some embodiments, the attachment points 610, spacers 720, power connectors 1115, and/or data connectors 170 may be used separate the layers from one another to create the thermal insulation air gaps 900.

FIG. 10A and FIG. 10B are front cross-section views (mid-plate 135 side) of the end-plate 140 and of the portion of the terminal box 160 that overhangs the mid-plate 135 and mates with the flange 510 and wiring terminal 500 of the end-plate 140. As shown in FIG. 10A and FIG. 10B, the multi-board power plane 200 may be generally toroidal-shaped and have a stack configuration so that the required electronic components and connectors can easily fit within the space envelope 600 of the end-plate 140. For example, all the PCB boards of the multi-board power plane 200 may be toroidal-shaped with an opening in the middle. The periphery of the end-plate 140 may be shaped to match and mate with the form factor of the motor 105 and terminal box 160. The terminal box 160 may connect to the wiring terminal 500. In some embodiments, the terminal box 160 may have a first electronic compartment 1005 that is positioned above the wiring terminal 500. The multi-board power plane 200 may communicate to electronic components in the terminal box 160 via the terminal points 505. In some embodiments, the terminal points 505 may allow for electrical connection between the terminal box 160 and the multi-board power plane 200. For example, in FIG. 9 and FIG. 10B a cable 1020 extending from the terminal box 160 is routed through one of the terminal points 245 to connect to an I/O port 1030 of the multi-board power plane 200. Alternatively, or in addition, one or more of the terminal points 505 may be used to route power cables from the terminal box 160 to the multi-board power plane 200. For example, a power cable 1025 may be routed through the terminal point 505 to connect to the ground terminal 1035. Alternatively, or in addition, the terminal box 160 may have one or more connectors 1010 with protective covers 1015. The terminal box 160 and connectors 1010 will be discussed in more detail below.

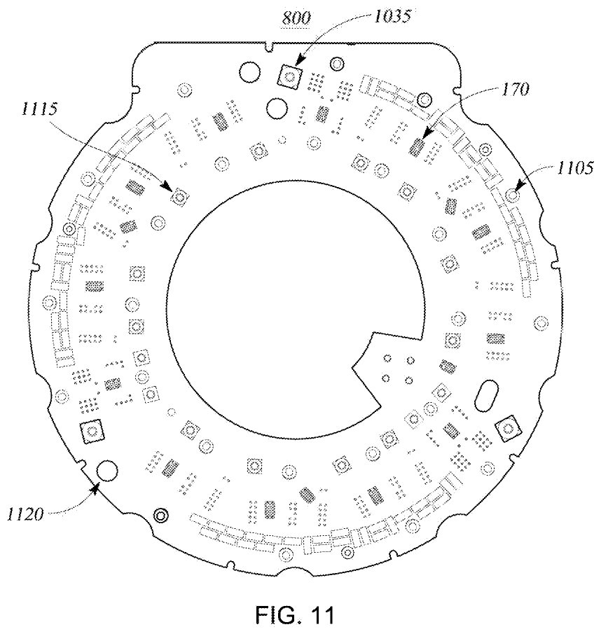

FIG. 11 is a front view (e.g., mid-plate 135 side) of the power layer 800 of the multi-board power plane 200. The power layer 800 may include one or more data connectors 170, component attachment points 1105, support apertures 1120, power connectors 1115, and/or ground terminal 1035. The component attachment points 1105 may allow electronic components to be mounted onto the board. Alternatively, or in addition, the electronic components may be surface mounted. In some embodiments, the support apertures 1120 may be mounting holes used to mount the power layer 800 onto the end-plate 140. The support apertures 1120 may also, or alternatively, allow one or more raised attachment points 610 (see FIG. 6) to pass through a support aperture 1120 and connect to a different PCB (e.g., the control layer 805) in the multi-board power plane 200. In some embodiments, the opening 1110 allows the power layer 800 to encircle the central column 235 of the end-plate 140.

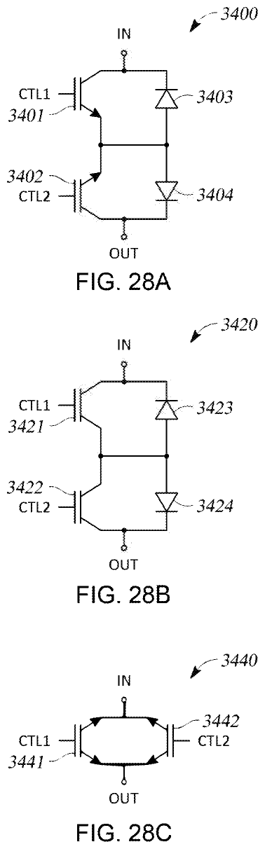

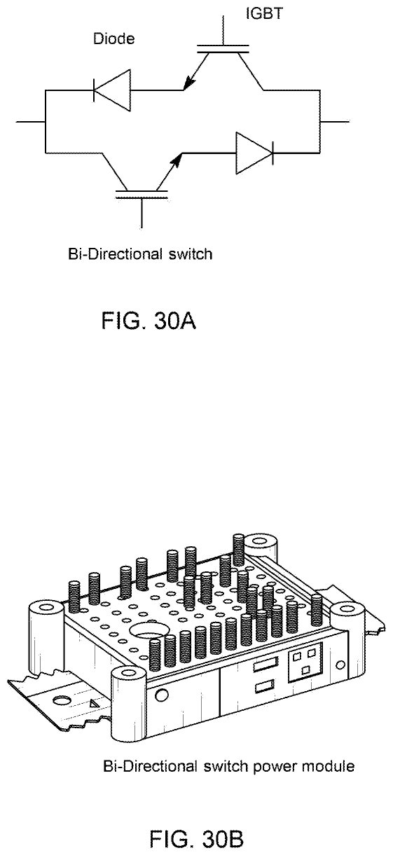

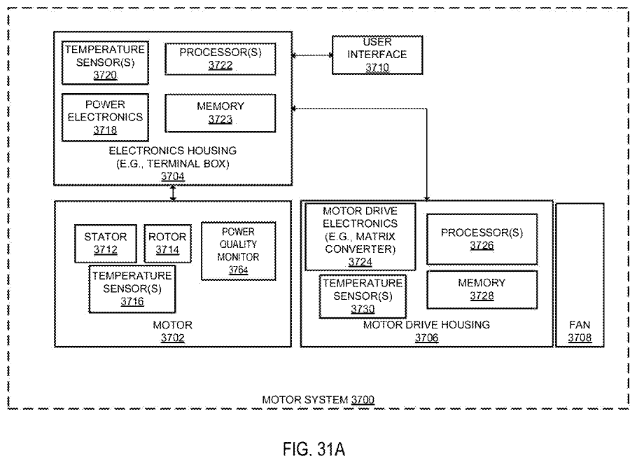

FIG. 12 is a back view (e.g., fan 145 side) of the power layer 800 of the multi-board power plane 200, which can include one or more components of the matrix converter (e.g., any of the matrix converters of FIG. 25, 27 or 29. In some embodiments, for example, the power layer 800 has one or more power modules 1205 and one or more current sensing modules 1206 current sensing modules 1206. For example, the power modules 1205 may include one or more power converters, power semi-conductors, and/or bi-directional switches (e.g., like the switches and/or power modules of FIG. 28A-28C or 30A-30B). In some embodiments, the power modules 1205 are one component of the matrix converter and communicate with other components (e.g., in the terminal box 160 and on other PCBs) to create the full matrix converter. As described above, the matrix converter can receive AC input signaling and provide converted AC signaling having a converted AC waveform with a converted voltage and frequency to drive the motor 105. For example, the matrix converter can be a direct AC-AC matrix converter without an intermediate DC stage.

The arrangement and distribution of the components of the matrix converter may allow the motor 105 to run efficiently while the end-plate 140 and/or the mid-plate 135 and end-plate 140 together maintain a small overall form factor (e.g., a length and diameter that complies with industry standards). As shown, the power modules 1205 may be positioned in a circular arrangement. The power modules 1205 may be in contact with the end-plate housing 335 to effectively transfer heat from the high temperature components 230 to the cooling fins 405, 410 of the end-plate housing 335. This is illustrated, for example, in FIG. 9, where the power module 230 is in contact with the end-plate housing 335. Furthermore, the power layer 800 may include one or more input filter capacitor connectors, a clamp IGBT connectors, shunt resistor connectors 1215, and/or an output clamp diode connector. The power modules 1205 (larger rectangles) may correspond to the bi-directional switches of the arrays of switches 3102, 3302, 3502 of FIGS. 25, 27, and 29, for example, and can be or can include any of the switches of FIGS. 28A-28C, 30A or the power module of FIG. 30B. The current sensing modules 1206 in some embodiments include resistive shunts, although other types of current sensors are possible.

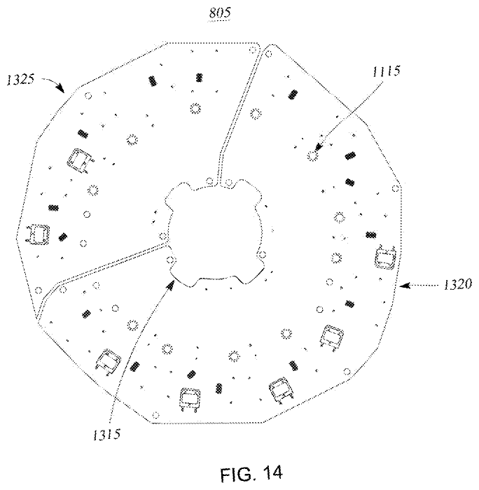

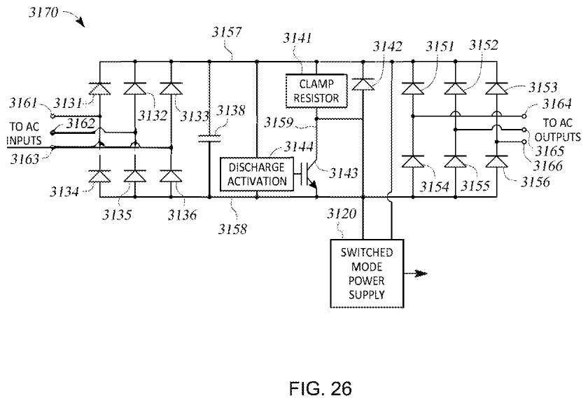

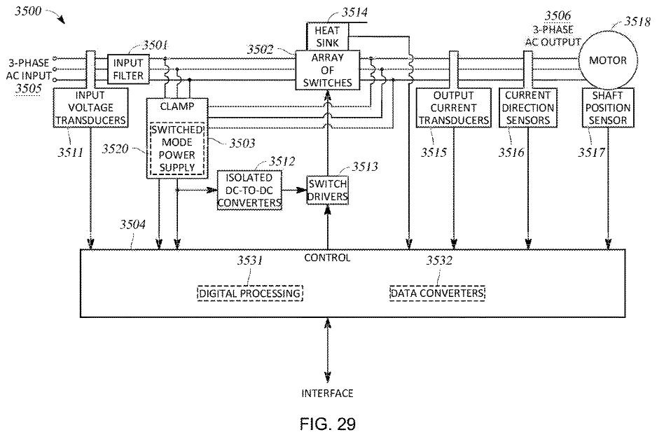

FIG. 13 and FIG. 14 are front and back views, respectively, of the control layer 805 of the multi-board power plane 200, which, like the power layer 800, can include one or more components of the matrix converter. The control layer 805 may include one or more input filter capacitors 1305, clamp capacitors 1310, data connectors 170, support apertures 1120, and/or power connectors 1115. In some embodiments, the electronic components of the control layer 805 may be used as power quality filter components (e.g., the input filter capacitors 1305). As described above, the control electronic modules may be positioned in a circular arrangement and may be in contact with the conductive cover 220 to effectively transfer heat from the low temperature components 225 (e.g., the capacitors 1305, 1310) into the external environment. It should be understood that the control layer 805 may also, or alternatively, have one or more power quality filters, power quality capacitors, peak supporters, input phase wires, shunt resistors, clamp modules, clamp resistor wires, gate driver power supply, controller cards, copper connectors, current sensors, gate drivers, power supply, and/or any other control electronics module/power qualify filter components. Furthermore, the control electronic modules and electronic components described herein may be distributed or positioned in any configuration among the various PCB boards, including on either side of the boards. Alternatively, or in addition, any of the electronic components may be distributed or positioned in the terminal box 160 (e.g., one or more power modules may be in the terminal box 160 in some other embodiments). The input filter capacitors 1305 may correspond to one or more of the capacitors 3115, 3116, 3117 of the input filter 3101 of FIG. 25 or to capacitors of the input filter 3501 of FIG. 29, for example. The clamp capacitors 1310 may correspond to the capacitor 3138 of FIG. 26, or to capacitors of the clamp circuits 3103, 3503 of FIGS. 25, 29.

In some embodiments, the control layer 805 is a two-part layer with a first PCB board 1320 and a second PCB board 1325. Separating the control layer 805 into two or more separate PCBs may offer several benefits, including improved accessibility for maintenance and repair, enhanced reliability by reducing the risk of a single point of failure, improved performance by using specialized materials/components for the different sides, and increased flexibility through a more modular design. In some embodiments, the control layer 805 may include a non-circular opening 1315 to allow the raised attachment points 610 of the end-plate housing 335 (See, e.g., FIG. 6) to reach the other layers of the multi-board power plane 200. The non-circular opening 1315 may also, or alternatively, allow one or more busbars or other components to reach the control layer 805 and/or the other layers.

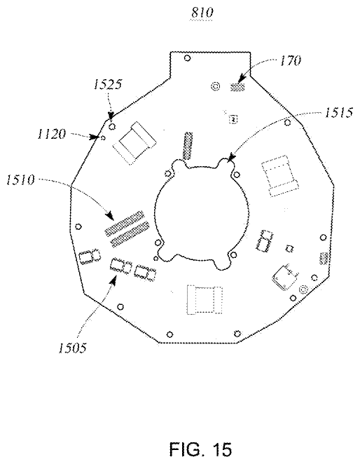

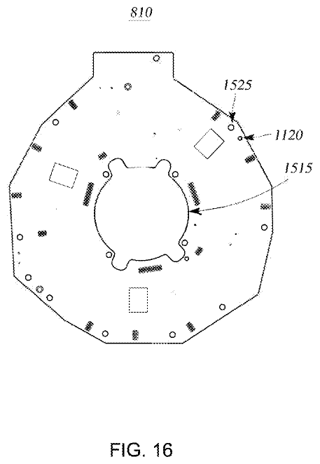

FIG. 15 and FIG. 16 are front and back views, respectively, of the second control layer 810 of the multi-board power plane 200. As described above, the second control layer 810 may include any of the electronic components (e.g., control electronic modules, data connectors 170, PCB mounting holes 1525, 1120) described herein. In some embodiments, the second control layer 810 is a clamp control PCB. Like the control layer 805 and the power layer 800, the second control layer 810 may include or one or more components of the matrix converter. Alternatively, or in addition, the second control layer 810 may include a microprocessor interface 1510 to connect to a microprocessor of the third control layer 830. In some embodiments, the second control layer 810 may be smaller than the other layers of the multi-board power plane 200. For example, the microprocessor interface 1510 can be a PCB-to-PCB connector allowing signals to pass from the second control layer 810 to the third control layer 830. The second control layer 810 may also, or alternatively, have a non-circular opening 1515 opening 1515 and non-circular support apertures 1525 support apertures 1525, 1120. In some embodiments, the opening 1515 of the second control layer 810 is circular and accommodates the central heat sink of the end-plate 140. However, the size of the layers may vary to accommodate different preferences and use cases. The second control layer 810 can further include one or more packaged integrated circuits 1505, which can perform control and drive functionality.

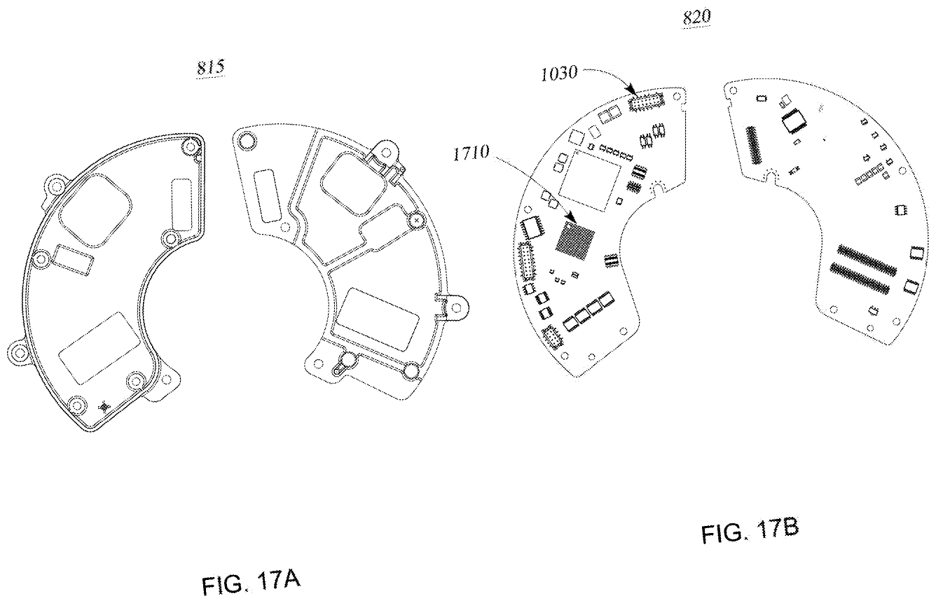

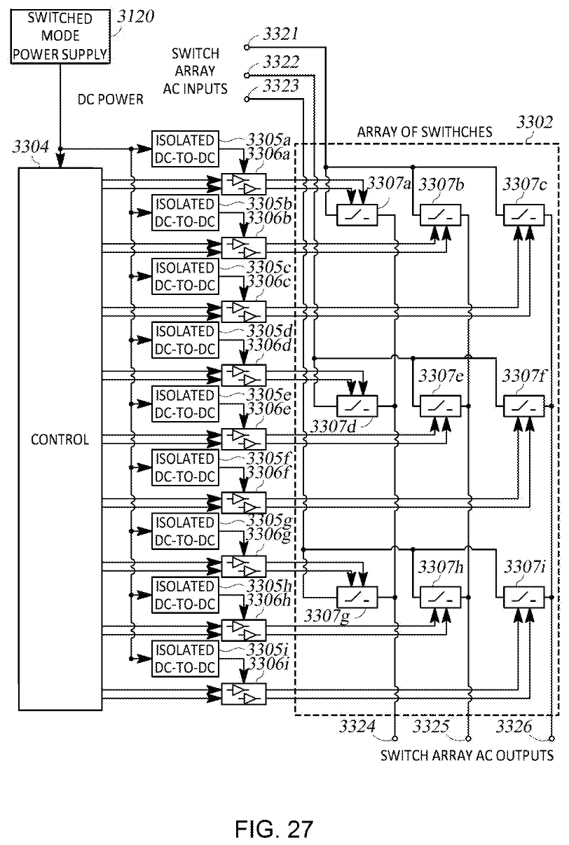

FIG. 17A illustrates a housing 815 of the third control layer 830 of the multi-board power plane 200. FIG. 17B illustrates a front and a back view of the control PCB board 820 housing 815 third control layer 830 multi-board power plane 200. For example, the PCB control board 820 can be a main control board for controlling the operation of the matrix converter and other components of the embedded motor drive electronics, including other components mounted within the end-plate 140. The housing 815 can be a plastic carrier for carrying the PCB control board 820. In some embodiments, the control PCB board 820 may include one or more integrated circuits 1710 integrated circuits 1710 mounted thereon. For example, one or more of the integrated circuits 1710 can comprise the main microprocessor of the multi-board power plane 200. The integrated circuits can include one or more field-programmable gate arrays, which can be programmable integrated circuits that can perform various digital logic functions and may consist of configurable logic blocks and programmable interconnects that allow field-programmable gate array 1710 to be customized for specific tasks, such as digital signal processing or control logic. In some embodiments, the PCB control board 820 may correspond to some or all of the control circuitry 3104 of FIG. 25, some or all of the control PCB of the control circuit 3304 of FIG. 27, and/or some or all of the control circuitry of the control block of FIG. 29.

In some embodiments, the control PCB board 820 may include any of the electronic components (e.g., control electronic modules, data connectors 170, support apertures 1120) described herein. Furthermore, the housing 815 may provide a physical barrier around the control PCB board 820, protecting it from external factors such as dust, moisture, and mechanical damage, which may extend the lifespan of the control PCB board 820 and improve the overall reliability of the multi-board power plane 200. The housing 815 may also, or alternatively, facilitate the dissipation of heat from the control PCB board 820 by acting as a heat sink. In some embodiments, the housing 815 may enhance the performance of the control PCB board 820 by improving signal integrity, power efficiency, and/or electromagnetic compatibility. It should be understood that any of the PCBs of the multi-board power plane 200 may have a housing.

FIG. 18 is a front and back view of the switched-mode power supply 825 of the multi-board power plane 200. In some embodiments, the switched-mode power supply 825 may be a power supply that efficiently converts an input voltage into a desired output voltage. It may be used to power the multi-board power plane 200 and the motor 105 by providing a stable, regulated voltage. The switched-mode power supply 825 may operate by switching one or more power transistors 1820B on and off at a high frequency, resulting in efficient power conversion with minimal losses. The power transistors 1820B may be metal-oxide-semiconductor field-effect transistors (MOSFETs). The switched-mode power supply 825 may include one or more diodes 1820A. The diodes 1820A and/or power transistors 1820B may be attached to corresponding heat sinks 175A, 175B. The heat sinks 175A, 175B, 175C may reduce the operating temperature of the power transistors 1820B and diodes 1820A to improve their efficiency and increase their lifespan.

In the illustrated embodiment, the switched-mode power supply 825 includes a switch mode transformer 1810, a plurality of power supply capacitors 1805, and a current sensor 1815. The switch mode transformer 1810, input filter capacitors 1305, clamp capacitors 1310 (see FIG. 13), and/or heat sinks 175A, 175B, 175C may be mounted to an epoxy pad 715 to improve heat diffusion and prevent the electronic components from overheating. As discussed above, one side of the epoxy pad 715 may be in contact with the conductive cover 220. The switched-mode power supply 825 may also include support apertures 1525, 1120, which can be PCB mounting holes. Overall, the control layers of the multi-board power plane 200 may be used to efficiently control the power provided to the motor 105.

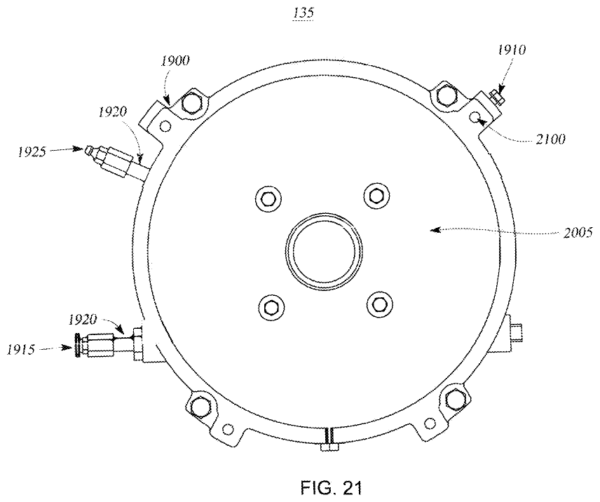

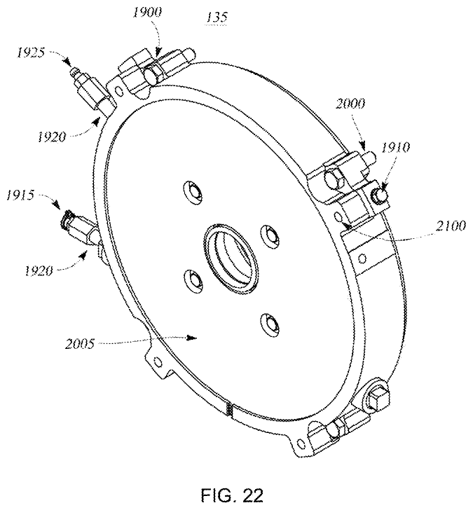

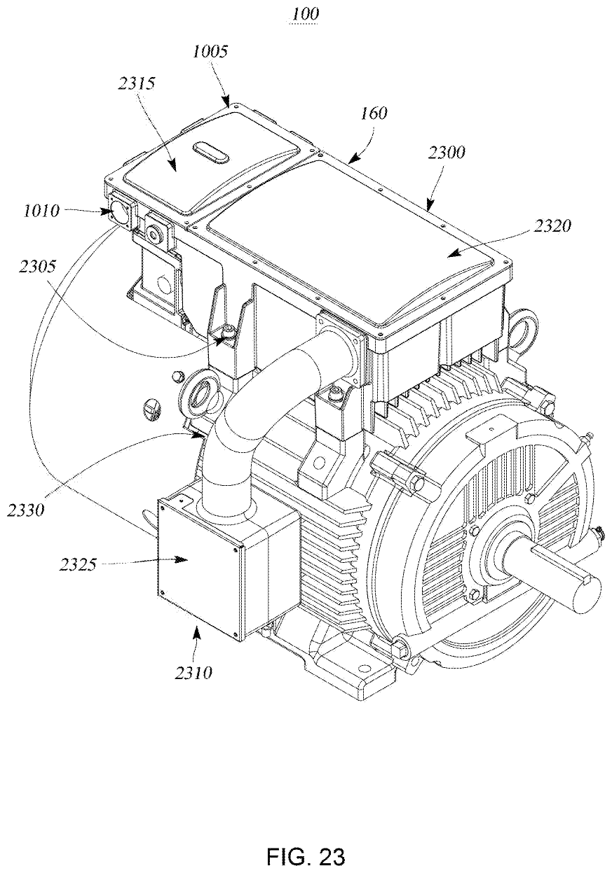

FIG. 19 and FIG. 20 are a front and front-perspective view, respectively of the mid-plate 135 of the motor assembly 100 of FIG. 1. FIG. 21 and FIG. 22 are a back and back-perspective view, respectively of the mid-plate 135 of the motor assembly 100 of FIG. 1. The mid-plate 135 may have a wall 2005. In some embodiments, the mid-plate 135 includes one or more bearing oil/grease tubes 1920. The grease tubes 1920 may include a service port 1925, 1915 for refilling or flushing the oil or grease. For example, service port 1925 may be a grease zerk fitting that allows input of fresh grease from a grease gun and service port 1915 may be a grease pressure release. That allows old grease to be expelled. The mid-plate 135 may also, or alternatively, have a wall and one or more retaining members 1900 (e.g., such as four retaining members 1900). The retaining members 1900 may be Z-shaped with three different apertures. The three different apertures may allow the mid-plate 135 to connect to the motor frame 110 (distal to the mid-plate wall 2005 wall 2005), the terminal box 160, and/or the end-plate 140 (proximate to the mid-plate wall 2005 wall 2005). For example, the first aperture 1905 (FIGS. 19 and 20) may receive a motor frame 110 fastener, the second aperture 1910 (FIGS. 19-22) may receive a terminal box 160 fastener, and the third aperture 2100 (FIGS. 21-22) may receive a dowel and/or an end-plate 140 fastener, as discussed previously, e.g., with respect to FIG. 3. In some embodiments, the retaining members 1900 may use screws 2000, bolts, rivets, snap-fit connectors, and/or magnets, to connect to other components. Additionally, or alternatively, the retaining members 1900 may receive a dowel in a friction fit. The other end of the dowel may be attached to the corresponding component. In some embodiments, a combination of any of the fastening methods described herein may be used.

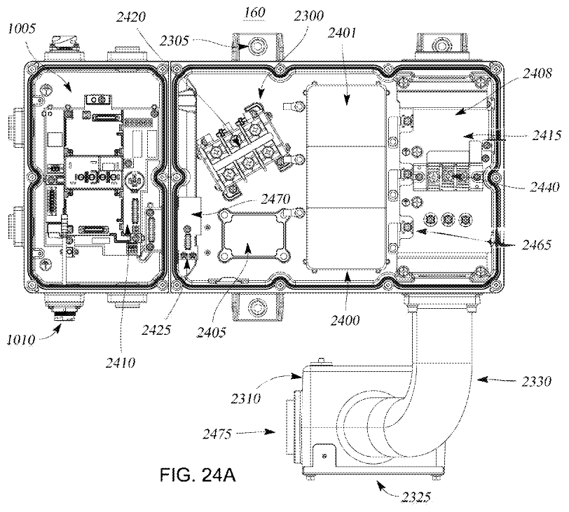

FIG. 23 is a perspective view of the motor assembly 100 of FIG. 1. In some embodiments, the terminal box 160 has a first electronic compartment 1005, a second electronic compartment 2300, and a third electronic compartment 2310. The three separate compartments may reduce electronic interference between the electronic components, as well as facilitate installation and repair of the motor assembly 100. In some embodiments, the third electronic compartment 2310 may be connected to the second electronic compartment via a protective conduit 2330. The three separate compartments may have removable lids 2315 lids 2315, 2320, and 2325 that may be used as heat sinks to cool the electronic components within the respective electronic compartment. The removable lids 2315, 2320, and 2325 may use any of the fastening methods described herein to couple to the respective terminal box 160 attachment points, as well as use gaskets to prevent dust, moisture, and/or grease from entering the motor assembly 100 and terminal box 160.

In some embodiments, the terminal box 160 has one or more attachment points 2305 to facilitate coupling with the rest of the motor assembly 100. The one or more attachment points 2305 may use any of the fastening methods described herein, as well as use gaskets to prevent dust, moisture, and/or grease from entering the motor assembly 100 and terminal box 160. As described above, the terminal box 160 may have one or more connectors 1010 (e.g., six connectors 1010). The connectors 1010 will be described in more detail below. In some embodiments, the motor assembly 100 may have multiple terminal boxes 160.

FIG. 24A is top view of the terminal box 160 of the motor assembly 100 of FIG. 1 with the lids 2315, 2320 removed. In some embodiments, the terminal box 160 has one or more electronic components that communicate with electronic components in the end-plate 140 to control the power provided to the motor 105. The terminal box 160 may have one or more inductors 2400 (e.g., three inductors 2400) that work with or that are part of the matrix converter, whereas the remaining components of the matrix converter are disposed within the end-plate 140. For instance, the inductors 2400 may be used to mitigate the transistor-switching noise generated by the matrix converter. In this capacity, the inductors 2400 may serve as low-pass filters, attenuating high-frequency noise while allowing the desired DC signals to pass through.

The inductors 2400 may be placed in series with the matrix converter's power modules 1205, or they may be connected in parallel with the load or other downstream components. By smoothing out the transistor switching noise, the inductors 2400 may improve the performance and reliability of the matrix converter. In some other embodiments, the inductors 2400 are disposed in the end-plate 140 such that the entire matrix converter is disposed within the end-plate 140. The inductors 2400 may correspond to the inductors 3111, 3112, 3113 of the input filter 3101 of FIG. 25 and/or the inductors of the input filter 3501 of FIG. 29, for example.

In some embodiments, the inductors 2400 are housed under a lid 2401. As shown, the terminal box 160 can further include an opening 2405 that allows for wire connections to pass between the motor 105 and the terminal box 160, an input power terminal block 2440 allowing for connection of the input grid power to the matrix converter, an output motor power terminal block 2420 allowing for connection of the output power delivered by the matrix converter to the motor 105, and one or more temperature sensors 2425 configured to detect the temperature of the motor and/or the terminal box 160. The terminal box 160 may also have one or more ground terminals 2465. As describe above, distributing the electronic components of a variable frequency drive and/or matrix converter between the terminal box 160 and the end-plate 140 allows the motor assembly size (e.g., the inline length) to remain compact and within applicable guidelines, while providing energy efficiency, adjustable operating speed and torque, and/or a lower starting current. It should be noted that the variable frequency drive may be configured to provide power to the electric motor.

With continued reference to FIG. 24A, the terminal box 160 may have a radio frequency interference (RFI) filter 2408 covered by a steel shield 2415, busbars, and/or an application control board 2410. The application control board 2410 may allow a user to control and monitor the motor 105 by connecting external hardware (e.g., computers, controllers, and/or sensors) to the application control board 2410. In some embodiments, the external hardware devices may communicate with the application control board 2410 through wireless signals such as Bluetooth or cellular radio. Alternatively, or in addition, the user may connect wires to the application control board 2410 to establish a physical link between the external hardware devices and the application control board 2410. For example, a user may connect one or more external hardware devices into the connectors 1010. The connector 1010 may be physically connected (e.g., via one or more wires) to the application control board 2410, the multi-board power plane 200, and/or any other component of the matrix converter. The application control board 2410 can also be connected to the matrix converter, including one or more processors or other components of the matrix converter within the end-plate 140, thereby allowing for control of or programming of the matrix converter by the application control board 2410.

In some embodiments, the application control board 2410 may be connected to a secondary control board 2470. The secondary control board 2470 may span from the first electronic compartment 1005 to the second electronic compartment 2300. Thus, the secondary control board 2470 may enable the transmission of both information and power between the two electronic compartments 1005, 2300.

FIG. 24B shows a top view of a portion of the terminal box 160 with the lid 2401 removed, thereby exposing the three input filter inductors 2400A, 2400B, 2400C. As described above, the three input filter inductors 2400A, 2400B, 2400C may correspond to the inductors 3111, 3112, 3113 of the input filter 3101 of FIG. 25 and/or the inductors of the input filter 3501 of FIG. 29. FIG. 24B also shows the terminal box 160 with the steel shield 2415 removed, thereby exposing components of the RFI filter 2408, which can include one or more surge protection varistors 2435 (e.g., metal-oxide varistors [MOVs]) configured to protect against grid voltage surges, one or capacitors, and one or more inductors (e.g., a toroid inductor).

FIG. 24C depicts another view of the terminal box 160 with certain wiring connections shown, which were not shown in FIG. 24A or FIG. 24B for the purposes of simplicity. For example, FIG. 24C shows a first set of wires 2445 connecting grid power to the input power terminal block 2440. In some embodiments, the first set of wires 2445 are routed through the protective conduit 2330 from the third electronic compartment 2310. The third electronic compartment 2310 may be connected to grid power via one or more connectors 2475. The first set of wires 2445 may include a ground wire 2446.

In some embodiments, the terminal box 160 includes a second set of wires 2450 extending from outputs of the input filter inductors 2400A, 2400B, 2400C through the opening 547 of the terminal box 160 to corresponding connection points 505 in the wiring terminal 500 of the end-plate 140 (FIG. 5B), and thereby to provide input power to the downstream components of the matrix converter residing in the end-plate 140. The terminal box 160 may also, or alternatively, include a third set of wires 2455 extending from an output of the matrix converter in the end-plate 140, via corresponding connection points 505 in the wiring terminal 500 of the end-plate 140, through the opening 547 in the terminal box 160, thereby providing AC-AC converted power signals from the matrix converter to an input of the output motor power terminal block 2420. In this fashion, the second set of wires 2450 and/or third set of wires 2455 may be routed from the second electronic compartment 2300 to the end-plate 140 via the wiring terminal 500. For example, one or more wires from the second set of wires 2450 and/or third set of wires 2455 may correspond to cable 1020 and/or power cable 1025, as shown in FIGS. 9 and 10B. In the illustrated embodiment, a fourth set of wires 2460 extends from an output of the output motor power terminal block 2420 through the opening 2405 in the bottom of the terminal box 160, to the motor 105, thereby delivering AC-AC converted power signals from the matrix converter to the motor 105.

### Additional Example End-Plates

In certain use cases, heat can be a significant problem that can shorten the life of a motor and associated control components. For example, many drilling and pumping operations are performed in locations with limited cooling. Moreover, even when operating in locations with significant cooling infrastructure, the demands on the motor can create significant heat. Accordingly, it is desirable to design the motor driver and supporting infrastructure in a manner that reduces heat buildup and that can cool heat generating components as efficiently and quickly as possible. To that end, the present disclosure describes certain example embodiments of an end-plate (e.g., end-plate 140) that reduces heat buildup. Moreover, embodiments are disclosed herein that facilitate cooling various heat generating components of a motor assembly (e.g., motor assembly 100) and/or generate relatively high horsepower.

Advantageously, in certain embodiments, the improved heat reduction and cooling techniques associated with the design disclosed herein enable support for scaling the motor to generate higher horsepower. For instance, embodiments are also disclosed that include embedded or integrated drive electronics units configured to accommodate a larger number of switching components or other drive electronics within a drive electronics housing. In certain embodiments, the motor assembly 100 can include an integrated drive electronics unit configured for mounting in-line with the motor while accommodating a relatively large number of switching components in a compact form factor, and supporting horsepower of between 25 HP and 200 HP. In some embodiments, greater horsepower may be supported, such as up to 500 HP, or more.

Relocating at least some of the heat generating electronic components of the motor drive, e.g., away from other components of the motor drive and/or motor can help to reduce the impact of heat. For example, moving the power modules 1205 in an intelligent manner can reduce the impact of heat from the power modules 1205 on additional components, such as the input filter capacitors 1305 and clamp capacitors 1310, among others.

According to certain aspects, mounting the switching components or other electronics components to a peripheral wall, or proximate to a peripheral wall, can provide more efficient heat loss and/or space utilization.

One drawback of conventional electric motors is that they are run at a fixed speed based on the input frequency of the AC power supply, and control of the rotational speed of a pump or other rotary device coupled to the electric motor is provided via mechanical structure (e.g., a brake, throttle valve), resulting in a waste of energy. Another drawback of existing electric motors is that the maximum speed of the electric motor is limited to the AC power supply's input frequency, thereby requiring a larger pump to be installed when increased pressure or flow of the pump is desired.

A matrix converter is a type of motor drive circuit that can adjust motor input frequency and voltage to control AC motor speed and torque as desired. For example, variable speed operation of an electric motor can improve reliability and throughput while reducing energy consumption. As discussed, the embodiments disclosed herein can include a matrix converter. For example, any of the embodiments discussed herein can include the matrix converters shown and described with respect to FIGS. 25-29, or any of the matrix converters described herein.

A matrix converter receives a multi-phase AC input voltage and opens and closes switches of a switch array over time to thereby synthesize a multi-phase AC output voltage with desired frequency and phase. Various circuits are used in a matrix converter for control functions. For instance, a processor and/or field programmable gate array (FPGA) can be used for computations related to a modulation algorithm that selects which particular switches of the array are opened or closed at a given moment, and switch drivers can be included to provide DC control signals to the control inputs of the switches.

The matrix converter can also include a clamp circuit that dissipates load energy (for instance, overvoltage conditions arising during shutdown) by clamping one or more inputs terminal of the matrix converter to one or more output terminals of the matrix converter. Including the clamp circuit enhances robustness, for instance, by providing a discharge path for excess load current and/or to handle overcurrent and shutdown conditions.

In certain embodiments herein, a matrix converter includes an array of switches having AC inputs that receives a multi-phase AC input voltage and AC outputs that provide a multi-phase AC output voltage to a load. The matrix converter further includes control circuitry that opens or closes individual switches of the array, and a clamp circuit connected between the AC inputs and AC outputs of the array and operable to dissipate energy of the load in response to an overvoltage condition. The clamp circuit includes a switched mode power supply operable to generate a DC supply voltage for the control circuitry.

Implementing the matrix converter in this manner provides a number of advantages, including an ability to maintain the control circuitry on for a longer duration of time when the AC input power is lost or of poor quality.

FIG. 25 is a schematic diagram of a matrix converter 3130 according to one embodiment. The matrix converter 3130 includes an input filter 3101, an array of switches 3102, a clamp circuit 3103, control circuitry 3104, 3-phase AC input terminals 3105, and 3-phase AC output terminals 3106.

In the illustrated embodiment, the input filter 3101 is implemented as an inductor-capacitor (LC) filter that serves to filter a 3-phase AC input voltage received on the 3-phase AC input terminals 3105 to generate a filtered 3-phase AC input voltage for the array of switches 3102. The input filter 3101 can also filter out switched noise caused by the array of switches 3102 and prevent such noise from contaminating the AC supply. The input filter 3101 can be a low pass filter. The 3-phase AC input voltage can correspond to, for example, three AC input voltage waveforms received from a power grid and each having a phase separation of about 120° and a desired voltage amplitude (for instance, 240 V or other desired voltage).

As shown in FIG. 25, the input filter 3101 includes a first inductor 3111 connected between a first AC input terminal and a first AC input to the array of switches 3102, a second inductor 3112 connected between a second AC input terminal and a second AC input to the array of switches 3102, and a third inductor 3113 connected between a third AC input terminal and a third AC input to the array of switches 3102. The input filter 3101 further includes a first capacitor 3115 electrically connected between the first AC input and the second AC input of the array of switches 3102, a second capacitor 3116 electrically connected between the second AC input and the third AC input of the array of switches 3102, and a third capacitor 3117 electrically connected between the first AC input and the third AC input of the array of switches 3102.

Including the input filter 3101 provides a number of advantages, such as providing protection against pre-charge and/or inrush current during power-up. Although one implementation of an input filter is depicted, matrix converters can be implemented with input filters of a wide variety of types. Accordingly, other implementations are possible.

The control circuitry 3104 opens or closes individual switches of the array of switches 3102 over time to thereby provide a 3-phase AC output voltage to the 3-phase AC output terminals 3106 with a desired frequency and phase relative to the 3-phase AC input voltage. The control circuitry 3104 can include various circuits for control functions. In a first example, the control circuitry 3104 can include a processor and/or FPGA for computations related to a modulation algorithm used to select which particular switches of the array of switches 3102 are opened or closed at a given moment. In a second example, the control circuitry 3104 can include switch drivers that provide DC control signals to the switches of the array of switches 3102 to thereby open or close the switches as desired.

The clamp circuit 3103 is electrically connected between the AC inputs and AC outputs of the array of switches 3102, and operates to dissipate energy during shutdown of the matrix converter 3130 or other overvoltage conditions. For example, the discharge activation circuit 3144 can sense a high voltage condition, and triggering the semiconductor switch 3143 to send cause overvoltage energy to pass through the clamp resistor 3141, thereby converting energy into thermal energy dissipated as heat. Including the clamp circuit 3103 enhances robustness, for instance, by providing a discharge path for excess load current and/or to handle overcurrent and shutdown conditions. For example, the clamp circuit 3103 can prevent freewheel paths for load current during shutdown and/or current paths for over-current.

In the illustrated embodiment, the clamp circuit 3103 includes a switched mode power supply 3120 that serves to generate DC power for the control circuitry 3104. In certain implementations, the supply voltage input to the switched mode power supply 3120 is directly connected to at least one internal node of the clamp circuit 3103. For example, a first internal node of the clamp circuit 3103 can serve to provide an input voltage to the switched mode power supply 3120 while a second internal node of the clamp circuit 3103 can serve as a ground voltage to the switched mode power supply 3120.

A switched mode power supply is an electronic power supply that incorporates a switching regulator to convert electrical power efficiently. For example, a switched mode power supply can convert power using switching devices that are turned on and off at high frequencies, and storage components such as inductors or capacitors to supply power when the switching device is in a non-conductive state.

Providing the input voltage to the switched mode power supply 3120 from a node of the clamp circuit 3103 provides a number of advantages, including an ability to maintain the control circuitry 3104 on for a longer duration of time when the AC input power is lost or of poor quality.

FIG. 26 is a schematic diagram of one embodiment of a clamp circuit 3170 for a matrix converter. The clamp circuit 3170 includes a switched mode power supply 3120, a first input clamping diode 3131, a second input clamping diode 3132, a third input clamping diode 3133, a fourth input clamping diode 3134, a fifth input clamping diode 3135, a sixth input clamping diode 3136, a clamp capacitor 3138, a clamp resistor 3141, a clamp diode 3142, an insulated gate bipolar transistor (IGBT) 3143, a discharge activation circuit 3144, a first output clamping diode 3151, a second output clamping diode 3152, a third output clamping diode 3153, a fourth output clamping diode 3154, a fifth output clamping diode 3155, and a sixth output clamping diode 3156.

Although one embodiment of a clamp circuit for a matrix converter is depicted, the teachings herein are applicable to clamp circuits implemented in a wide variety of ways. Accordingly, other implementations are possible.

The clamp circuit 3170 includes a first group of terminals 1061-1063 that connect to the AC inputs of an array of switches, and a second group of terminals 1064-1066 that connect to the AC outputs of the array of switches. The first group of terminals 1061-1063 includes a first terminal 3161, a second terminal 3162, and a third terminal 3163. Additionally, the second group of terminals 1064-1066 includes a fourth terminal 3164, a fifth terminal 3165, and a sixth terminal 3166.

As shown in FIG. 26, the input clamping diodes 1031-1036 serve as an input diode array connecting the first discharge node 3157 and the second discharge node 3158 to the AC inputs 1061-1063, while the output clamping diodes 1051-1056 serve as an output diode array connecting the first discharge node 3157 and the second discharge node 3158 to the AC outputs 1064-1066.

In the illustrated embodiment, the first input clamping diode 3131, the second input clamping diode 3132, and the third input clamping diode 3133 include anodes electrically connected to the first terminal 3161, the second terminal 3162, and the third terminal 3163, respectively. Additionally, each of the first input clamping diode 3131, the second input clamping diode 3132, and the third input clamping diode 3133 includes a cathode electrically connected to the first discharge node 3157. Furthermore, the fourth input clamping diode 3134, the fifth input clamping diode 3135, and the sixth input clamping diode 3136 include cathodes electrically connected to the first terminal 3161, the second terminal 3162, and the third terminal 3163, respectively. Additionally, each of the fourth input clamping diode 3134, the fifth input clamping diode 3135, and the sixth input clamping diode 3136 includes an anode electrically connected to the second discharge node 3158. Furthermore, the clamp capacitor 3138 is electrically connected between the first discharge node 3157 and the second discharge node 3158.

With continuing reference to FIG. 26, the clamp resistor 3141 is electrically connected in series with the IGBT 3143 in a discharge path between the first discharge node 3157 and the second discharge node 3158. Although the IGBT 3143 illustrates one example of a discharge device, other implementations of discharge devices can be used.

The clamp resistor 3141 can be implemented in a wide variety of ways. For example, implementing the clamp resistor 3141 with low inductance can inhibits large voltages from developing across the clamp resistor 3141 during clamping.

In the illustrated embodiment, the gate of the IGBT 3143 is controlled by the discharge activation circuit 3144. In certain implementations, the discharge activation circuit 3144 selectively turns on the IGBT 3143 based on monitoring a voltage difference between the first discharge node 3157 and the second discharge node 3158. For example, the discharge activation circuit 3144 can activate the IGBT 3143 when the voltage difference between the first discharge node 3157 and the second discharge node 3158 indicates an overvoltage condition. In certain implementations, the discharge activation circuit 3144 provides the control circuitry with an overvoltage sensing signal indicating whether or not overvoltage has been detected.

As shown in FIG. 26, the clamp diode 3142 is connected in parallel with the clamp resistor 3141, with an anode of the clamp diode 3142 electrically connected to an intermediate node 3159 along the discharge path. Additionally, the cathode of the clamp diode 3142 is electrically connected to first discharge node 3157. The clamp diode 3142 serves as a freewheeling path for any inductive voltage spike generated by the rapid switching of the IGBT 3143 (or other semiconductor discharge device) into a parasitic inductance of the clamp resistor 3141.

In the illustrated embodiment, the switched mode power supply 3120 receives an input supply voltage corresponding to a voltage difference between the first discharge node 3157 and the second discharge node 3158, and generates a regulated DC output voltage that powers control circuitry of a matrix converter. For example, the second discharge node 3158 can serve as a ground voltage to the switched mode power supply 3120, while the first discharge node 3157 can serve as the input supply voltage to switched mode power supply 3120. In certain implementations, the switched mode power supply 3120 is operable over a voltage range of at least 250 V DC to 1000 V DC, thereby enhancing performance in the presence of fluctuations in voltage of the first discharge node 3157 and/or the second discharge node 3158.

As shown in FIG. 26, the first output clamping diode 3151, the second output clamping diode 3152, and the third output clamping diode 3153 include anodes electrically connected to the fourth terminal 3164, the fifth terminal 3165, and the sixth terminal 3166, respectively. Additionally, each of the first output clamping diode 3151, the second output clamping diode 3152, and the third output clamping diode 3153 includes a cathode electrically connected to the first discharge node 3157. Furthermore, the fourth output clamping diode 3154, the fifth output clamping diode 3155, and the sixth output clamping diode 3156 include cathodes electrically connected to the fourth terminal 3164, the fifth terminal 3165, and the sixth terminal 3166, respectively. Additionally, each of the fourth output clamping diode 3154, the fifth output clamping diode 3155, and the sixth output clamping diode 3156 includes an anode electrically connected to the second discharge node 3158.

FIG. 27 is a schematic diagram of one embodiment of a portion of circuitry 3300 of a matrix converter. The circuitry 3300 includes an array of switches 3302, switch drivers 1106a-1106i that drive bidirectional switches 1107a-1107i of the array of switches 3302, a control circuit 3304 that generates input control signals to the switch drivers 1106a-1106i, isolated DC-to-DC converters 1105a-1105i that power the switch drivers 1106a-1106i, and a switched mode power supply 3120 that powers the control circuit 3304 and the isolated DC-to-DC converters 1105a-1105i.

As shown in FIG. 27, the array of switches 3302 includes a first bidirectional switch 3307a connected between a first AC input 3321 and a first AC output 3324, a second bidirectional switch 3307b connected between the first AC input 3321 and a second AC output 3325, a third bidirectional switch 3307c connected between the first AC input 3321 and a third AC output 3326, a fourth bidirectional switch 3307d connected between the second AC input 3322 and the first AC output 3324, a fifth bidirectional switch 3307e connected between the second AC input 3322 and the second AC output 3325, a sixth bidirectional switch 3307f connected between the second AC input 3322 and the third AC output 3326, a seventh bidirectional switch 3307g connected between the third AC input 3323 and the first AC output 3324, an eighth bidirectional switch 3307h connected between the third AC input 3323 and the second AC output 3325, and a ninth bidirectional switch 3307i connected between the third AC input 3323 and the third AC output 3326.

The bidirectional switches 1107a-1107i serve to conduct both positive and negative currents, and are implemented to be able to block both positive and negative voltages.

As shown in FIG. 27, each of the bidirectional switches 1107a-1107i receive a pair of switch control signals. In particular, the bidirectional switches 1107a-1107i receive first to ninth pairs of switch control signals from switch drivers 1106a-1106i, respectively. The switch drivers 1106a-1106i receive first to ninth pairs of input signals from the control circuit 3304. By controlling the state of the input signals over time, the control circuit 3304 achieves a desired modulation algorithm, such as Venturini modulation, Alesina modulation, scalar modulation, fictitious DC-link modulation, and/or space vector modulator. Furthermore, the control circuit 3304 generates the input signals to provide current commutation and/or other desired switching properties.

In the illustrated embodiment, the switched mode power supply 3120 receives an input voltage from internal node(s) of a clamp circuit (not shown in FIG. 27) and generates a DC voltage that powers the control circuit 3304. Additionally, the DC voltage serves as an input to the isolated DC-to-DC converters 1105a-1105i, respectively. The isolated DC-to-DC converters 1105a-1105i in turn provide first to ninth DC voltages to the switch drivers 1106a-1106i, respectively. The isolated DC-to-DC converters 1105a-1105i can be implemented in a wide variety of ways, including, but not limited to, as flyback converters.

While FIG. 27 shows circuitry of a matrix converter including nine bi-directional switches 3307a-3307i, in other embodiments, matrix converters can be provided including more bi-directional switches. For example, a multi-level matrix converter can include 18 or more bi-directional switches, as described previously (e.g., 18, 27, 36, or 72 or more bi-directional switches).

FIGS. 28A-28C illustrate various embodiments of bidirectional switches for an array of switches of a matrix converter. Although various examples of bidirectional switches are shown, the teachings herein are applicable to bidirectional switches implemented in a wide variety of ways.

FIG. 28A is a schematic diagram of a bidirectional switch 3400 according to one embodiment. The bidirectional switch 3400 includes a first IGBT 3401, a second IGB2 1602, a first diode 3403, and a second diode 3404. The bidirectional switch 3400 is arranged in a common emitter back-to-back IGBT configuration.

As shown in FIG. 28A, the gate of the first IGBT 3401 receives a first control signal CTL1, and the gate of the second IGBT 3402 receives a second control signal CTL2. Additionally, the collector of the first IGBT 3401 is electrically connected to an input terminal IN and to a cathode of the first diode 3403, and the emitter of the first IGBT 3401 is electrically connected to the emitter of the second IGBT 3402 and to the anodes of the first diode 3403 and the second diode 3404. Furthermore, the collector of the second IGBT 3402 is electrically connected to an output terminal OUT and to a cathode of the second diode 3404.

FIG. 28B is a schematic diagram of a bidirectional switch 3420 according to another embodiment. The bidirectional switch 3420 includes a first IGBT 3421, a second IGBT 3422, a first diode 3423, and a second diode 3424. The bidirectional switch 3420 is arranged in a common collector back-to-back IGBT configuration.

As shown in FIG. 28B, the gate of the first IGBT 3421 receives a first control signal CTL1, and the gate of the second IGBT 3422 receives a second control signal CTL2. Additionally, the emitter of the first IGBT 3421 is electrically connected to an input terminal IN and to an anode of the first diode 3423, and the collector of the first IGBT 3421 is electrically connected to the collector of the second IGBT 3422 and to the cathodes of the first diode 3423 and the second diode 3424. Furthermore, the emitter of the second IGBT 3422 is electrically connected to an output terminal OUT and to an anode of the second diode 3424.

FIG. 28C is a schematic diagram of a bidirectional switch 3440 according to another embodiment. The bidirectional switch 3440 includes a first bidirectional IGBT 3441 and a second bidirectional IGBT 3442. The bidirectional switch 3440 is arranged in a reverse blocking IGBT configuration.

As shown in FIG. 28C, the gate of the first bidirectional IGBT 3441 receives a first control signal CTL1, and the gate of the second bidirectional IGBT 3442 receives a second control signal CTL2. Additionally, a collector/emitter of the first bidirectional IGBT 3441 is electrically connected to the input terminal IN and to the emitter/collector of the second bidirectional IGBT 3442, and an emitter/collector of the first bidirectional IGBT 3441 is electrically connected to the output terminal OUT and to the collector/emitter of the second bidirectional IGBT 3442. Thus, the first bidirectional IGBT 3441 and the second bidirectional IGBT 3442 serves as a pair of switching devices arranged in anti-parallel.

With respect to FIGS. 28A-28C, the first control signal CTL1 and the second control signal CTL2 are provided by a switch driver. Additionally, the input terminal IN couples to an AC input of a switch array, while the output terminal OUT couples to an AC output of a switch array.

FIG. 29 is a schematic diagram of a matrix converter 3500 according to another embodiment. The matrix converter 3500 is providing power to a motor 3518, and includes an input filter 3501, an array of switches 3502, a clamp circuit 3503, a control circuit 3504, 3-phase AC input terminals 3505, 3-phase AC output terminals 3506, input voltage transducers 3511, isolated DC-to-DC converters 3512, switch drivers 3513, a heat sink 3514, output current transducers 3515, current direction sensors 3516, and a shaft position sensor 3517.

As shown in FIG. 29, the clamp circuit 3503 includes a switched mode power supply 3520 that generates a regulated DC voltage that powers the control circuit 3504 and that serves as an input voltage to the isolated DC-to-DC converters 3512. The isolated DC-to-DC converters 3512 (for instance, flyback converters) output DC voltages that power the switch drivers 3513.

With continuing reference to FIG. 29, the control circuit 3504 is electrically connected to an interface, such as a serial interface or bus. The interface can connect to a network to facilitate remote control over the matrix converter 3500 and motor 3518. Additionally, the control circuit 3504 includes digital processing circuitry 3531 (for instance, a processor and/or FPGA) that digitally processes data, and data converters 3532 that provide analog-to-digital conversion and digital-to-analog conversion operations. For example, the data converters 3532 can serve to provide conversion of signals received from the depicted sensors and transducers.

The control circuit 3504 receives a variety of signals that indicate operating conditions of the matrix converter 3500. For example, in the illustrated embodiment, the control circuit 3504 receives input voltage sensing signals from the input voltage transducers 3511, an overvoltage sensing signal from the clamp circuit 3503 (for example, from a discharge activation circuit of the clamp circuit 3503), a temperature sensing signal from the heat sink 1704, output current sensing signals from the output current transducers 3515, current direction sensing signals from the current direction sensors 3516, and a shaft position sensing signal from the shaft position sensor 3517.

Implementing the matrix converter 3500 with such sensors provides a number of functions, such as over-current trip protection, over-voltage trip protection, thermal trip protection, and/or enhanced control over rotation, torque, and/or speed of the motor 3518.

The matrix converter may be the main system configured on the power plane P, e.g., that is represented as shown in FIGS. 30A-30B. FIG. 30A illustrates a diagram of a bi-directional switch, e.g., using IGBT technology for implementing the desired power functionality. FIG. 30B illustrates an example of a bi-directional switch power module for implementing the desired power functionality. (As a person skilled in the art would appreciate, an insulated-gate bipolar transistor (IGBT) is a three-terminal power semiconductor device primarily used as an electronic switch which, as it was developed, came to combine high efficiency and fast switching. For example, Infineon Technologies AG distributed various products using such IGBT technology.) The purpose of having this circuit shown in FIG. 30A is to allow the matrix converter to convert an AC input of fixed voltage and frequency to a desired AC output waveform. Traditionally, in the prior art input AC power would have to be converted to a DC waveform before being synthesized into an AC output. According to some embodiments, the matrix converter may be configured to execute this process in fewer steps and with fewer components. Among the electronic modules, the power quality filter IFC may be configured as a prominent component. In such a case, its function is to reduce the level of electrical noise and harmonic distortions. In some embodiments, this power quality filter component may be attached directly onto the printed circuit board, such as first PCB board 1320 to be as close to the matrix converter as possible. This greatly improves its ability to reduce the amount of distortions emitted from the matrix converter electronics. The overall geometry and size of the power plane P allows for ease of manufacture and installation for power modules and control electronics.

In this power plane portion of the overall motor assembly shown in FIG. 1, heat will be emitted from at least two sources: the power semi-conductor modules and the shaft or rotor 115. Although the mid-plate may be configured with an insulation layer protecting the electronics, as described above, there will likely still be residual heat from the shaft or rotor 115. This is due to the temperature difference between the fan side and the mid-plate portion of the motor assembly. It is also understood that semi-conductors in the power plane will naturally generate heat during operation. The challenge is maintaining an operating temperature in order for the electronics to operate properly, e.g., below the failure point of the electronics.

Therefore, insulation and dissipation of heat are two functions that the power plane can perform. The former regarding insulation may be achieved through the multi-layered circuit board implementation disclosed herein. The multi-layered circuit board may be constructed of laminated material such as fiberglass, by way of example, which increases its thickness and strength. Fiberglass is known and understood to be a strong and light-weight material which has been used for insulation applications. This allows the power plane P to act as a thermal barrier between hotter power modules, the power quality capacitors and control electronics.

For the latter, heat may be dissipated through the heat sink fins, the fan, and/or the liquid cooling system described herein. The heat sink fins can be air cooled and act as cooling mechanisms. They operate through conduction and convection, two forms of heat transfer, where conduction is understood to be the transfer of heat between solids that are in contact with each other, while convection is understood to be the transfer of heat between a solid and a fluid. Heat transfer will first occur between the printed circuit board and the semi-conductors. It will then travel into the end-plate and heat sink fins. Convection occurs between the heat fins and the ambient air, e.g., surrounding the overall motor assembly 100 (FIG. 1) dispersing the heat. To function properly, the fins may be configured to be cooler to absorb heat and as the temperature of the fins rises, the heat may be diffused into the ambient environment. Since the power plane, or the distribution of power modules and/or elements 2504 also shares a similar geometry with the intermediate portion of the end-plate, the heat will be distributed uniformly along the surface.

The overall configuration of this multi-purpose power plane makes it an important contribution to the state of the art. The space envelope or cavity from the end-plate allocates room for the overall power plane and allows it to support both power modules and control electronics. In addition, the power plane has access to the heat sink fins from the end-plate, enabling it to cool the electronics at an operable temperature. The fiberglass circuit board construction of layer) acts as an excellent insulator separating hotter power semiconductors from the sensitive control electronics and power quality capacitors. These combined components allow the power plane to facilitate operating conditions and maintain the temperature of the control electronics well below maximum temperature levels.

### Automatic Matrix Converter Modulation Control

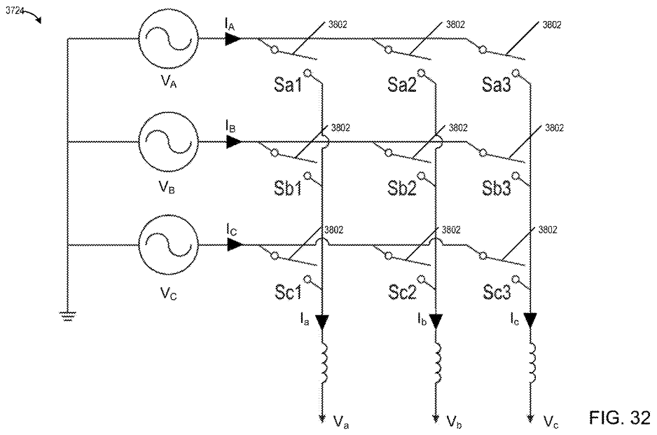

As previously described, the motor 105 may include a matrix converter (e.g., the matrix converter 3500). The matrix converter is used to transform one alternating current (AC) signal to another AC signal. The matrix converter is a type of direct AC-to-AC converter that eliminates the need for an intermediate DC link. In other words, the matrix converter can directly convert an input AC voltage to an output AC voltage. The matrix converter may generate a variable-frequency and/or variable-amplitude output. The matrix converter may use an array of bidirectional switches (e.g., switches 3502). These switches 3502 may be an array of 3×3 switches as explained further below with respect to FIG. 32. The switches 3502 may be controlled using a modulation technique, such as Space Vector Modulation (SVM), that controls the state of the switches so as to convert the input AC signal to one of several support output AC signals.

The matrix converter 3500 may support different variants of SVM as well as other modulation techniques as is described in more detail below. Each of the modulation techniques may provide different advantages and/or drawbacks. Thus, it is desirable to be able to change modulation techniques based on a desired performance of the matrix converter 3500 and/or the motor assembly 100.

System and processes disclosed here can modify the modulation technique or scheme applied to the matrix converter based on one or more desired operating characteristics and/or based on one or more measured metrics of the matrix converter and/or of the motor assembly 100. These characteristics or metrics may include any type of characteristic or metric that may impact or affect operation of the motor assembly 100 and/or that may indicate an operating state or condition of the motor assembly 100. For example, the characteristics or metrics may include motor speed, total harmonic distortion, temperature, audio noise, signal noise, vibration, and the like.

In some embodiments, the systems and processes herein can modify a carrier frequency of the matrix converter 3500. The carrier frequency may correspond to the frequency at which switching signals are modulated to control the power transfer between the input and output of the matrix converter 3500. The carrier frequency may refer to the rate at which the modulation signal (e.g., space vector modulation or sinusoidal PWM) updates switching states of the switches 3502. It should be understood that the carrier frequency may differ from the switching frequency, which may correspond to the actual frequency at which the power semiconductor switches (IGBTs or MOSFETs) turn on and off.

The matrix converter 3500 may be controlled by a processor (e.g., a general-purpose processor, a Digital Signal Processor (DSP), a special-purpose processor or controller, and the like). This processor may actively adjust one or more of the modulation technique and/or the carrier frequency of the matrix converter 3500 to obtain a desired operating state. The desired operating state may vary based on the specific use-case for the motor assembly 100 and/or the location (e.g., in a high-heat location, a low-heat location, in a well-ventilated building, in an underground outdoor location, etc.) of the motor assembly 100. However, often the desired operating state includes reducing energy losses, reducing operating temperature of the matrix converter, reducing audible noise, reducing total harmonic distortion (THD), improving torque production, reducing voltage change over time (dv/dt) at the motor terminals, and inducing smoother operation of the motor, among other characteristics. As will be described further below, in some embodiments, the matrix converter may be configured to operate using minimum commutation loss (MCL) modulation, which allows the matrix converter to commutate, or switch from one state to another state, between the input voltages that are closer in magnitude. Therefore, in some cases, the delta voltage seen at the motor winding may be minimized by employing the MCL modulation method. This can result in an average dv/dt stress reduction for the motor, thus reducing the common mode high frequency current circulation and associate aging.

In some cases, reducing losses and operating temperature of the matrix converter can be accomplished by reducing the number of switching transitions of the bidirectional switches (e.g., the IGBTs). By reducing the number of ON and OFF cycles, the bidirectional power transistors (e.g., the IGBTs) may have fewer switching transitions. Further, by reducing conduction time to allow for less switching and conduction losses, the matrix converter can operate at a lower temperature. Reducing the losses can be accomplished by both changing a modulation technique from a more frequent switching modulation technique (e.g., a space vector modulation with two zero vectors per switching sequence (SVM 2z)) to a less frequent switching modulation technique (e.g., a space vector modulation with one zero vector per switching sequence (SVM 1z) or minimum commutation loss (MCL) modulation). Alternatively, or in addition, reducing the losses can be accomplished by reducing the carrier frequency from a high value to a low value.

In some embodiments, the motor windings of the motor 105 and the frame structure of the motor assembly 100 can act as an audible speaker element and can vibrate at the carrier frequency presented to the stator coils. The higher frequencies are less audible to humans. However, the lower the carrier frequency, the closer the audio to the audible range of hearing can become and the louder the motor sounds.

Further, the matrix converter may be a low harmonic generating load attached to the power grid. The output frequency, or motor speed, can affect the harmonic content that the matrix converter presents to the grid. The slower the motor speed, the higher the harmonic content of the matrix converter.

In certain embodiments, using different modulation schemes and/or carrier frequencies enables the matrix converter to produce a more sinusoidal current from the grid and thus, produce less THD as measured in the output current signal (THDi). Different modulation techniques may produce different levels of THD. For example, SVM 2z may produce less THD than SVM 1z, which may in turn produce less THD than MCL. Further, the higher the carrier frequency, the less the THDi.

In certain embodiments, the systems and processes disclosed herein can provide automatic modulation control based on one or more characteristics or metrics that may be used as one or more control factors. The one or more control factors may be specified by a manufacturer or by an end-user. In some embodiments, the modulation control can be manual. For example, a user may specify a modulation technique to use. However, using an automatic modulation control enables systems presented herein to adjust modulation technique, or carrier frequency, based on determined conditions of the motor assembly 100.

For example, in one non-limiting example, if motor speed is under 33% of the supported motor speed and motor amperage (or load) is <50% of supported load, the matrix converter may be configured to operate with SVM 2z modulation, which may provide better THDi and motor performance without loss, or with reduced loss, compared to certain other modulation techniques. If instead the motor speed is >33% of the supported motor speed and/or the motor amps is >50%, the controller may switch the modulation technique for the matrix converter to SVM 1z, which may provide a compromise between the level of THDi, motor performance, and losses compared to certain other modulation techniques. Continuing the previous example, in some cases, regardless of motor speed or motor amps (e.g., load), if the temperature of the switches 3502 measured within the matrix converter 3500 module is above a threshold temperature (e.g., 70° C.), the controller may switch the modulation technique to MCL, which may provide less loss and can operate at a lower temperature with greater reliability compared to certain other modulation techniques. Further, in some cases, the controller may implement a hysteresis band (e.g., 10° C.). Thus, the controller may not switch the modulation technique back unless the temperature within the matrix converter 3500 module is reduced to 60° C.

As an additional non-limiting example, when it is determined that the output current of the matrix converter is over 150% of the rated continuous value of the matrix converter, the controller may automatically reduce the carrier frequency to the minimum supported frequency. For instance, while the normal supported carrier frequency may be 8 kHz, 10 kHz, or some other supported frequency, the minimum supported frequency may be 4 kHz or 6 kHz, or some other supported frequency below the normal supported carrier frequency. Continuing the example, when the output current of the matrix converter is over 100% of the rated continuous value of the matrix converter and the measured temperature for the switches (e.g., the IGBT module) is >90° C., the controller may reduce the carrier frequency by 100 Hz per 1° C. above 90° C. and/or above some other temperature threshold (e.g., 70° C.). In some cases, when the measured temperature for the switches >100° C., the controller may reduce the carrier frequency by 100 Hz per 1° C. above the temperature threshold regardless of the output current.

As can be seen from the prior examples, the system can use automated control to adjust the modulation technique or the carrier frequency. Further, in some cases, the system can adjust both the modulation technique and the carrier frequency.

It should be understood that the selected modulation techniques for different operating conditions may be dependent on supported modulation techniques by the matrix converter 3500 or the motor assembly 100 and that the examples provided herein assume a particular set of supported modulation techniques. However, embodiments described herein may be applied to matrix converter 3500 or motor assembly 100 that support other modulation techniques. Further, each of the embodiments described herein can be applied to each of the described matrix converter and/or motor embodiments. The identification of a particular system associated with a particular reference label is not intended to be exclusive or to exclude other embodiments described herein unless explicitly stated or unless mutually exclusive.

### Example Motor System Elements

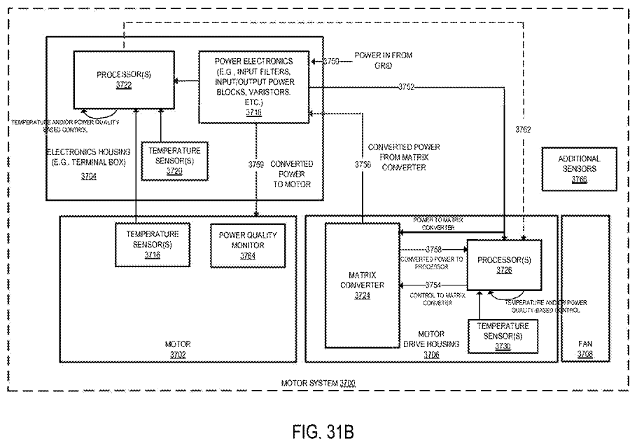

FIGS. 31A-31B illustrate block diagrams of certain elements of a motor system in accordance with certain embodiments. FIG. 31A is a block diagram of certain elements of a motor system 3700 in accordance with certain embodiments. The motor system 3700 of FIG. 31A can include any of the embodiments described herein with respect to a motor or motor system, including any of those shown and described with respect to FIG. 1 or any of the other figures described herein.

For example, the motor system includes a motor 3702, an electronics housing 3704 (e.g., such as the terminal box 160 of FIG. 1) which can be mounted to the motor 3702, and a motor drive housing 3706, which can be mounted to the motor 3702, such as in an in-line configuration aligned along an axis of the rotor, similar to the configuration shown in FIG. 1 that includes, for example, the end-plate 140 among other elements aligned with the axis of the rotor.

The motor 3702 can be an electric motor including a magnetic stator 3712 and rotor 3714 configured to rotate within the magnetic stator in response to a modulated input power signal generated by the motor drive electronics 3724. The motor 3702 can also include one or more temperature sensors 3716, which can be mounted with respect to the motor 3702 to output measurements of the temperature of the motor 3702. For instance, one or more temperature sensors 3716 can be positioned on the motor windings. The temperature sensors 3716 can include one or more of the embodiments described with respect to the one or more temperature sensors 2425. The motor 3702 can include one or more embodiments of the other motors described herein. For example, the motor 3702 can include one or more of the embodiments described with respect to the motor 105.

The electronics housing 3704 can include power electronics 3718, one or more temperature sensors 3720, one or more processors 3722, and memory 3723. The temperature sensors 3720 can include one or more of the embodiments described with respect to the temperature sensors 3716 and/or the one or more temperature sensors 2425.

The power electronics 3718 can include a variety of components configured to process input power signals received from a power source, and converted power signals generated by the motor drive electronics 3724. For example, as previously discussed above, the power electronics 3718 can include an input power terminal block allowing for connection of an input grid power, an input filter configured to perform high pass filtering on an input power signal received from a power source, surge protection varistors or other protection circuitry, and an output motor power terminal block.

The one or more processors 3722 can be mounted on one or multiple circuit boards, which can include an application control board. The processors 3722 can communicate with various components in the motor system 3700 including those within the motor drive housing 3706 (e.g., the motor drive electronics 3724, the processors 3726, or the temperature sensors 3730), within the motor 3702 (e.g., the temperature sensors 3716 or one or more processors within the motor 3702), or one or more components within the electronics housing 3704 (e.g., the temperature sensors 3720 or power electronics 3718), or within the user interface 3710.

The one or more temperatures sensors can be mounted within the electronics housing 3704 to detect a temperature of the electronics housing and/or the motor 3702. For example, the FIG. 24A shows one such temperature sensor 2425 mounted in the terminal box 1960 of FIG. 24A and configured to output measurements of the temperature of the motor and/or terminal box.

The motor drive housing 3706 can include motor drive electronics 3724, one or more processors 3726, memory 3728, and one or more temperature sensors 3730.

The motor drive housing 3706 can be shaped like the end-plate 140 of FIG. 1, for example, although other form factors (e.g., square, rectangular, etc.) are possible. In some cases, the motor drive housing 3706 can be the end-plate 140.

The motor drive electronics 3724 can be a variable frequency drive that includes variable frequency drive electronics. Further, the matrix converter 3724 can include any of the matrix converters described herein that are, for example, configured to convert an AC power signal received from the electronics housing 3704 to a converted power signal for driving the motor 3702. The matrix converter 3724 can include a matrix converter configured to convert the AC signal from one frequency to another frequency. In some cases, the matrix converter 3724 can be an AC-AC matric converter that converts the AC signal from one frequency to another frequency without first converting the signal to a DC signal. In some embodiments, the matrix converter 3724 can include other types of power converters.

The one or more processors 3726 can be configured with software, firmware, or other instructions to control the motor drive electronics. The processors 3726 can also be configured to receive measurements from the temperature sensors 3730 within the motor drive housing 3706. The processors 3726 can be mounted on one or multiple circuit boards and can communicate with various components in the motor system 3700 including those within the electronics housing 3704 (e.g., the processors 3722 or the temperature sensors 3720), within the motor 3702 (e.g., the temperatures sensors 3716 or one or more processors within the motor not shown), or within the user interface 3710. The memory 3728 can store software, firmware, or other instructions executed by the processors 3722 and or temperature or other data.

The one or more temperature sensors 3730 can be mounted within the motor drive housing 3706 to detect a temperature within the motor drive housing 3706. For example, some or all the temperature sensors 3730 can be positioned to detect temperature at one or more points of the motor drive electronics. In some embodiments, the motor drive electronics comprise a matrix converter having nine power modules including bi-directional switches, similar to the power modules 1205 of FIG. 12. A separate temperature sensor 3730 can be positioned within the packaging of each module, mounted to each module packaging, or positioned in sufficient proximity to each respective power module to detect a temperature of the respective power module. In other embodiments, there may be fewer or more temperature sensors 3730, and the temperature sensors 3730 can be positioned at different locations within the motor drive housing 3706. In some embodiments, the matrix converter may have more power modules. For example, the matrix converter may have 18 power modules. In some such cases, there may be additional temperature sensors 3730 positioned as described above to detect the temperature of each of the power modules. In some embodiments, each power module may be connected or disconnected via a bidirectional switch. Thus, if the matrix converter has 9 power modules, the matrix converter may include 9 bidirectional switches. Similarly, if the matrix converter has 18 power modules, the matrix converter may include 18 bidirectional switches. The temperature sensors 3730 may measure the temperature of the power modules and/or the bidirectional switches. The bidirectional switches may be any type of switch. For example, as described above, the bidirectional switches may be Insulated Gate Bipolar Transistor (IGBT) switches. In other cases, the bidirectional switches may be implemented using Silicon Carbide (SiC) metal-oxide-semiconductor field-effect transistors (MOSFETs).

The temperature sensors 3716, 3720, 3730 may include any type of appropriate temperature sensor for determining the temperature of power modules 1205 or other elements within the motor system 3700. The processors 3718, 3726 can include any appropriate type of microprocessor or microcontroller integrated circuits, and can include a digital signal processor (DSP), an FPGA, an ASIC, or any other type of processing unit. For example, the processors 3718 and/or the processors 3726 can be configured to control the matrix converter 3724 to modify a rotational speed, torque, or other characteristic of the motor 3702.

As will be discussed in further detail, the processors 3722 and/or processors 3726 can be configured to adjust motor operation 3702 by controlling the matrix converter based at least in part on temperature measurements from the temperature sensors 3716, 3720, and/or 3730 and/or power characteristics (e.g., input power quality or a quality of the converted power output by the matrix converter). Such power quality or other characteristics (e.g., total harmonic distortion (THD) of voltage and/or current) can be calculated by the processors 3722 and/or the processors 3726.

As an example, the processors 3722 and/or processors 3726 may modify a speed of the motor 1905 by controlling the matrix converter based at least in part on the determined characteristics of the power such that, if the processors 3722 and/or processors 3726 determine that power received from an input power source (e.g., mains power grid) is outside of power tolerances for normal operation (e.g., larger than a threshold THD), the processors 3722 and/or processors 3726 may adjust the matrix converter 3724 to reduce the speed of the motor 105.

The user interface 3710 can include one or more processors and a display screen, a touchscreen display, status lights, a wireless or wired interface that outputs the alert to a third-party device, or any other type of user interface. The user interface 3710 can be configured to output an alert or other indication to a user based on a determination of measured temperature and/or measured power characteristics. The alert can include any type of alert or information relating to the temperature and/or power characteristics. For example, the alert may include an indication of one or more of: measured temperature, power characteristics (e.g., THD of input power signals, THD of the converted power signals), an indication of motor operating speed or torque or a change in motor operating speed or torque, an indication of maximum or adjusted maximum operating speed under current operating conditions, an indication that a user setting is being overridden due to operating conditions (e.g., temperature or received power quality), or any other information associated with operation of the motor system 3700 relating to the temperature/power quality or otherwise.

In some embodiments, the motor 3702 can include a power quality monitor 3764. The power quality monitor 3764 can determine the THD by measuring one or more signals of the motor system 3700. The THD can be determined from a current signal, a voltage signal, or both a current and voltage signal. For example, the THD can be determined by measuring a voltage at an output terminal of the variable frequency device or the matrix converter. As another example, the THD can be determined by measured a current at an input to a motor terminal of the motor 3702. In yet other embodiments, the THD can be a frequency-weighted total harmonic distortion (WTHD), which can provide a measure of the harmonic performance for both the input current and the output voltage of the matrix converter 3724.

The power quality monitor 3764 can be any type of device that can measure a current and/or a voltage of the variable frequency device and/or the matrix converter 3724. For example, the power quality monitor 3764 can be a current sensor, a voltage sensor, a power quality analyzer, a power meter, or any other system that can continuously or intermittently determine the THD or WTHD of the motor system 3700.

In some embodiments, the motor system 3700 may include one or more additional sensors 3766. The one or more additional sensors 3766 may be included as part of the motor 3702, the electronics housing 3704, the motor drive housing 3706, and/or any other part of the motor system 3700. Further, the one or more additional sensors 3766 may be distributed throughout the motor system 3700. The one or more additional sensors 3766 can include any type of sensors that may be used to measure one or more characteristics or metrics of the motor system 3700. In some embodiments, these one or more characteristics may be used in addition to or in place of the temperature measurements and/or TID determination to determine a modulation technique for the matrix converter 3724 and/or a carrier frequency of the matrix converter 3724 using the various embodiments described herein.

For example, the one or more additional sensors 3766 may include audio sensors or microphones that can be used to measure or determine audible noise generated by the motor system 3700. As another example, the one or more additional sensors 3766 may include an accelerometer or other type of vibration sensor for determining vibrations associated with operation of the motor system 3700. In some cases, the one or more additional sensors 3766 may include one or more torque sensors, strain gauges, or piezoelectric transducers to determine a load on the motor. Further, the one or more additional sensors 3766 can include air gap flux sensors that can be used to determine rotor displacement associated with bearing aging. The rotor displacement may cause undesirable or unexpected flux deviations and/or motor inductance changes. The determination of flux deviation and/or motor inductance changes may be used to skew the modulation selection logic to a modulation which reduces the dv/dt stress at the motor terminals (e.g., MCL).

As previously described, the one or more additional sensors 3766 may include current sensors. In some embodiments, the current sensor can be used to measure the input side grid currents. The measurement of input side grid currents may enable the selection of a modulation method based on input power factor control. In cases where the input current measurement is not available, model-based estimation of the grid current can be carried out based on the input filter parameters data.

The memory 3723 and the memory 3728 can store software, firmware, or other computer-executable instructions executed by the processors 3722 and 3726 respectively, to control operation of the motor system 3700. Further, the memory 3723 and/or the memory 3726 may be used to store measured temperature or power quality measurements over time. In some cases, the memory 3723 and/or the memory 3726 may be used to store one or more temperature thresholds and/or power quality tolerances, which can be used by the processors 3726 and/or 3726 to determine when to modify or override operation of the motor 3702, such as by adjusting control of the matrix converter 3724.

Where the motor 3702 is connected to a variable torque load such as a centrifugal pump, fan, or the like, such loads generally follow affinity laws, where horsepower is proportional to speed³ (HP=S³) and flow rate is proportional to speed. As a result, if the matrix converter or other motor drive electronics 3724 slows down the motor 3702 driving the variable torque load, the power required to drive the variable torque load can drop by the cube of the speed, which will result in the motor being less torque-loaded. This can also result in cooler operation due to reduction in electrical losses and mechanical losses from lower RPMs.

As previously described, according to certain embodiments, the motor system 3700 can include embedded sensors, such as temperature sensors 3716, 3720, 3730 in some or all of the motor 3702, the terminal box 3704, and the motor drive housing 3706. The motor system 3700 may include additional sensors, such as vibration sensors, current sensors, voltage sensors, RPM sensors, torque sensors, pressure sensors, humidity sensors, proximity sensors, oil quality sensors, magnetic field sensors, fault detection sensors, and the like.

Motor temperature can increase if the fan 3708 fails, a screen protecting the cooling fan becomes partially blocked, or the load starts to experience a failure resulting in higher torque (e.g. failing bearings, debris buildup inside the pump or fan, malfunctioning valve or damper, etc.).

According to the embodiment illustrated in FIGS. 31A-31B, the motor system 3700 allows temperature sensing at multiple locations, which can include two or more of the motor drive electronics 3724, the motor 3702, and the terminal box 3704. The system 3700 can provide warnings to a user in response to higher detected temperatures in the case of a temperature increase due to excessive loading, impediment to cooling air flow, failed cooling fan, etc. Moreover, the motor system 3700 can also be configured to adjust operation, such as to operate a reduced speed, thereby actively reducing load and temperature according to the affinity laws while avoiding complete shutdown and maintaining some level of reduced-capacity operation.

According to certain embodiments, the motor system 3700 is configured for multiple operational modes, both of which override the normal speed setting if the motor system 3700 detects that temperature inside the matrix converter 3724 and/or the motor 3702 reaches a threshold level. Upon reaching the threshold level, the motor system 3700 can produce a warning signal and/or adjust the control of the matrix converter 3724 to reduce the speed of the motor, thereby reducing the temperature.

FIG. 31B is a block diagram showing certain elements of the motor system 3700 of FIG. 31A. Certain components have been omitted in FIG. 31B for simplicity to illustrate certain functionality based on sensed temperature and/or power quality.

The power electronics 3718 can receive a power signal (3750) from a power source (e.g., mains power grid). As one example, the electronics housing 3704 can be a terminal box, and referring to the terminal box of FIG. 24C, a first set of wires 2445 carrying the input power can connect to an input terminal block 2440. Moreover, a second set of wires 2450 can extend from outputs of input filter inductors 2400A, 2400B, 2400C to the downstream components of the matrix converter 3724 (referring again to FIG. 31B), as illustrated by the arrow 3752.

Both the matrix converter 3724 and the processors 3726 within the motor drive housing 3726 can receive the input power signals (3752) after conditioning by the power electronics 3718. The processors 3726 can control (3754) operation of the matrix converter, such as by controlling an array of switches according to a selected modulation scheme to generate converted power signals for controlling the motor. A set of available modulation schemes can be stored in the memory 3728.

The matrix converter 3724 outputs a converted power (3756) for controlling the motor. The power electronics 3718 can receive and condition the converted power. For example, referring again to FIG. 24C, a third set of wires 2455 can extend from an output of the matrix converter to an input of the output motor power terminal block 2420, and a fourth set of wires 2460 can extend from an output of the output motor power terminal block 2420 through the opening 2405 to the motor 3702. Referring again to FIG. 31B, these connections can generally be represented by the arrow 3756 extending from the matrix converter 3724 to the power electronics 3718 and the arrow 3759 extending from the power electronics 3718 to the motor 3702. In alternative configurations, the power connection can be direct between the matrix converter 3724 and the motor 3702 without passing through the electronics housing 3704.

The matrix converter 3724 can also output the converted power signals (3758) to the one or more processors 3726, which can in some embodiments control operation of the matrix converter 3724 based on the converter power. In such cases, the converted power can be converted to digital values using analog to digital converters and any other appropriate circuitry to allow for processing of the converted power by the processors 3726.

As shown, the processors 3726 within the motor drive housing 3706 can receive measurements from the temperature sensors 3730. Moreover, the processors 3722 within the electronics housing 3704 can receive measurements from the temperature sensors 3720 within the electronics housing 3704 and/or from the from the temperature sensors 3716 within the motor 3702. As indicated by the dashed line 3762, in some cases, the processors 3722 of the electronics housing 3704 can be connected to and communicate with the processors 3726 within the motor drive housing 3706, e.g., to forward measurements from the sensors 3716 and/or the sensors 3720, or to communicate other instructions or data.

As shown, the processors 3726 (and/or processors 3722) can control operation of the matrix converter or other drive electronics 3724 based on received temperature measurements and/or power quality measurements, such as to allow for reduced capacity or other modified operation based on such measurements. While not shown in FIG. 31B, additional processor(s) can be located in the motor 3702 and can communicate with the processors 3726 and/or the processors 3722.

### Example Matrix Converter

FIG. 32 illustrates a circuit diagram of a portion of a matrix converter 3724 according to certain embodiments. The matrix converter 3724 can be or may include one or more of the embodiments described herein for any of the embodiments of the matrix converters described herein, such as of the matrix converter 3500. The matrix converter 3724 may include an array of switches 3802. The switches 3802 may be bidirectional switches. In some cases, there may be 9 bidirectional switches that can be arranged in a 3×3 array as illustrated in FIG. 32. Alternatively, the switches 3802 may include 18 unidirectional switches with a pair of unidirectional switches arranges to achieve the operation of each bidirectional switch. However, it should be understood that other arrangements are possible. Further, the switches 3802 may include a different number of switches. For example, the switches 3802 may include 18 bidirectional switches arranged in a pair of tiers with each tier having a 3×3 array.

The switches 3802 may be implemented using any type of switch technology that may be used to implement a matrix converter 3724. For example, the switches 3802 may be Insulated-Gate Bipolar Transistors (IGBTs), Reverse Blocking IGBTs (RB-IGBTs), Metal-Oxide-Semiconductor Field-Effect Transistors (MOSFETs), Silicon Carbide (SiC) switches, Gallium Nitride (GaN) switches, or any other type of transistor or switch that may be used in the matrix converter 3724.

In the non-limiting example of FIG. 32, the switches 3802 may be arranged in a 3×3 matrix with the first row having switch Sa1, switch Sa2, and switch Sa3, a second row having switch Sb1, switch Sb2, and switch Sb3, and a third row having switch Sc1, switch Sc2, and switch Sc3. Each row of switches may be connected to a voltage source 3804 that generates a corresponding current. The first row of switches may be connected to a first voltage source V_{A}, the second row of switches may be connected to a second voltage source V_{B}, and the third row of switches may be connected to a third voltage source V_{C}. Each column of switches may be connected to an inductor that provides a current output and voltage output based on the voltage sources and the configuration of the switches 3802. The first column of switches may output a current Iₐ and voltage Vₐ, the second column of switches may output a current I_{b} and voltage V_{b}, and the third column of switches may output a current I_{c} and voltage V_{c}.

Although not illustrated, the output of each column of switches may be combined by, for example, a common node or additional circuitry. Further, although not illustrated, an output LC filter or a common-mode filter may be used to combine the output of each column of switches in the matrix converter 3724. It should also be understood that the output filter topology can vary. In some embodiments, the center point of the star connected capacitors or three-phase capacitors connected in a Y configuration, can be left floating or connected to the neutral point of the input side filter capacitors to contain the PWM switched noise in the matrix converter. Further, the matrix converter 3724 may include one or more capacitors or other circuit elements.

The switches 3802 may be controlled by a matrix converter controller, which may be implemented by the processors 3726 or may be a separate element of the motor system 3700. To simplify discussion, control of the matrix converter 3724 will be described as being by the processors 3726. However, it should be understood that a separate matrix converter controller can perform one or more of the operations described as being performed by the processors 3726. Further, the processors 3726 may refer to one or a plurality of processors.

The processors 3726 may control the matrix converter 3724 be modifying a state of one or more of the switches 3802 of the matrix converter 3724. Further, the processors 3726 may control the matrix converter 3724 using one or more modulation schemes that affect how long a switch is in a particular state (e.g., open or closed) and/or when the switch changes state. The one or more modulation schemes can include any type of modulation scheme or technique that can be used to control the state of the matrix converter 3724. For example, the one or more modulation schemes or techniques may include and/or may influence a minimum current line modulation, a minimum input filter current ripple, minimum input capacitors voltage ripple, minimum motor current ripple, a minimum commutation loss (MCL) modulation, space vector modulation (SVM), a space vector modulation with one zero vector per switching sequence (SVM 1z), a space vector modulation with two zero vectors per switching sequence (SVM 2z), a space vector modulation with three zero vectors per switching sequence (SVM 3z), or standard per phase carrier based modulations such as Alesina-Venturini modulation, among others.

Minimum current line modulation may attempt to reduce or minimize switching transitions. Further, minimum current line modulation may focus on minimizing the current flowing through the power semiconductor devices. The minimum current line modulation is a modulation that aims to minimize the input and load current ripple. The actual rms current in the power semiconductors cannot be affected by the modulation as it is set by the required load. But motor control can aim to reduce the rms current for the same operating torque or Maximum Torque Per Ampere (MTPA). Minimum current line attempts to reduce or minimize switching transitions. While SVM 2z (discussed below), increases switching transitions while reducing the current line ripple. So there is minimum current ripple as minimum current is achieved with a modulation with higher number of commutations.

Minimum Commutation Loss (MCL) modulation attempts to minimize switching losses during the commutation process, or the process of switching or transferring current flow between the components in the circuit. MCL may use discontinuous pulse with modulation (DPWM) to reduce the number of switching events.

Space vector modulation (SVM) may be based on the representation of three-phase voltages as a space vector in a two-dimensional (α-β) coordinate system. Rather than control each phase voltage separately, SVM may calculate an equivalent space vector representation and select the switching states of the matrix converter to synthesize the desired output voltage.

Space vector modulation with one zero vector (SVM 1z) is a variation of SVM that attempts to reduce switching losses by keeping at least one phase in the same switching state. Thus, during a transition or switching cycle, at least one phase does not switch. As a result, there may be fewer switching transitions per cycle compared to SVM. Reducing the switching transition can reduce switching losses while maintaining harmonic performance. SVM 1z applies a zero vector one time per carrier sample time.

Space vector modulation with two zero vectors (SVM 2z) is another variation of SVM. SVM 2z applies a zero vector two times per carrier sample time, which means all the three phases connected to the same input phase. SVM 2z results in 2 more commutations per carrier sample time compared to SVM 1z.

that that attempts to reduce switching losses by keeping two phases in the same switching state. Thus, during a transition or switching cycle two of the three phases remain in the same state. As a result, there may be fewer switching transitions per cycle compared to SVM. Reducing the switching transition can reduce switching losses. In some cases, harmonic distortion for SVM 2z may be lower than in SVM 1z, which in turn may have higher harmonic distortion than traditional SVM without maintaining a zero vector. Switching losses with SVM 2z may be lower than SVM 1z, which may be yet lower than SVM.

In some cases, SVM 2z may have lower THD than SVM 1z. However, the THDi and THDv output for SVM 1z, 2z can have a crossing point where one performs better than the other. The determination of whether SZM 1z or SVM 2z performs better may depend on: input-output frequency testing point, modulation depth of voltage transfer ratio and carrier frequency. At low loads, e.g., at low voltage transfer ratios, SVM 2z tends to perform better. While increasing the voltage transfer ratio SVM 1z can outperform SVM 2z with a lower THDi. In certain embodiments disclosed herein, at low loads, SVM 2z performs better than SVM 1z. As the SVM 2z increases, the losses in the converter, operating with SVM 2z at low loads, may be more suitable for certain applications.

Reducing commutations can results in lower temperature. SVM 2z may have 10 commutations per carrier cycle, while SVM 1z may have 8 commutations per carrier cycle. The reduced commutations may result in lower losses and lower temperature.

Both minimum current line and minimum commutation loss have relatively low switching losses. However, they may each have relatively more harmonic distortion and can also have higher control complexity compared to SVM and the SVM 1z and SVM 2z variants.

Space vector modulation with the zero vectors (SVM 3z) is a variant of SVM that may apply a zero vector three times per carrier sample time. SVM 3z may have the highest amount of commutations compared to SVM 1z and SVM 2z. SVM 3z may have 12 commutations per carrier sample time, which may result in the highest commutation losses. The SVM 3z connects 3 times per carrier cycle the output phases to the same input phase creating a zero vector 3 times. To place 3 zero vectors in one carrier period, more commutations are required as more vectors are used in one carrier period. SVM 3z may present the highest commutation loss, intermediate THDi levels, and the lowest motor output voltage distortion.

In some embodiments, controlling the matrix converter 3724 may include modifying a carrier frequency of the matrix converter 3724. The carrier frequency of the matrix converter 3724 may refer to the rate at which a modulation signal updates switching states of the switches 3802. In some embodiments, the switching frequency of the switches 3802 may be based on the carrier frequency and/or the selected modulation technique. The switching frequency may refer to the frequency at which the semiconductor switches (e.g., the IGBTs or MOSFETs) turn on or off In some embodiments, modifying the carrier frequency and/or the selected modulation technique can be used to modify one or more operating characteristics or metrics of the motor assembly 100, such as temperature, noise, harmonic distortion, and the like. Moreover, in some embodiments, one or more desired control factors, which may correspond to the operating characteristics, may be used to determine a modulation technique and/or carrier frequency for the matrix converter 3724.

In some embodiments, when the number of switching transitions per sequence decreases as the switches 3802 transition from SVM 2z to SVM 1z, or to MCL, the processor 3726 may increase the carrier frequency to maintain the same switching frequency.

### Example Temperature-Based Modulation Selection Process

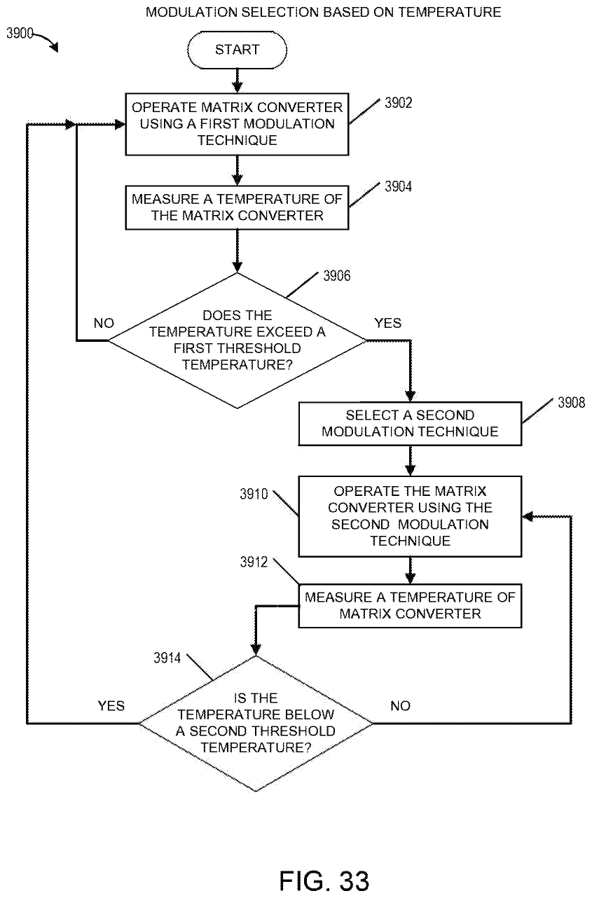

FIG. 33 presents a flowchart of an example modulation selection process 3900 based on temperature in accordance with certain embodiments. The modulation selection process 3900 can include any process that can determine or select a modulation technique for controlling a matrix converter 3724 based on a temperature of the matrix converter 3724 and/or a motor assembly 100 or motor 105 that includes the matrix converter 3724. The modulation selection process 3900 can be implemented by a temperature sensor 3716, a processor 3726, a matrix converter 3724, a processor 3722, a temperature sensor 3720, and the like. To simplify discussion, and not to limit the present disclosure, the operations of the modulation selection process 3900 are described with respect to certain example systems. However, it should be understood that other systems described herein, and other equivalent systems, may be used to implement certain operations of the modulation selection process 3900.

The modulation selection process 3900 may begin at block 3902 where, for example, the processor 3726 operates the matrix converter 3724 using a first modulation technique. Often, but not necessarily, the first modulation technique will be a modulation scheme of the available schemes that supports the most switching of the switches 3802 of the matrix converter 3724 and that supports the highest motor speed of the motor 105. In certain embodiments, the first modulation technique may be space vector modulation with two zero vectors per switching sequence (SVM 2z). SVM 2z may be the initial modulation technique as it often has the most amount of switching of the switches 3802 and often supports the highest motor speed of the motor 105. However, it is possible for the first modulation technique to be any other modulation technique supported by the matrix converter 3724 or the motor 105 of the motor assembly 100. For example, the first modulation technique may be minimum commutation loss (MCL) modulation, space vector modulation with one zero vector per switching sequence (SVM 1z), space vector modulation with three zero vectors per switching sequence (SVM 3z), or any other type of modulation technique for controlling the switches 3802 of the matrix converter 3724.

At block 3904, the processor 3726 measures a temperature of the matrix converter 3724 using, for example, one or more of the temperature sensors 3730. Measuring the temperature of the matrix converter 3724 may include measuring a temperature of any element (e.g., switches, power blocks, filters, etc.) of the matrix converter 3724. Measuring the temperature of the matrix converter 3724 may include measuring an ambient temperature within a housing that includes the matrix converter 3724, or elements thereof. In some embodiments, the block 3904 may include measuring a temperature of other elements of the motor assembly 100 in addition to or instead of the matrix converter 3724.

At decision block 3906, the processor 3726 determines whether the temperature measured at the block 3904 exceeds, or in some cases is equal to, a first temperature threshold. The first threshold temperature may be specified by a manufacturer or user (e.g., system operator). In some cases, the first threshold temperature may be based on a location of the motor assembly 100, a use of the motor assembly 100 (e.g., drilling, air circulation, pumping liquids, etc.), or any other factor that may affect the temperature of the matrix converter 3724 or the motor assembly 100. In some cases, the first threshold temperatures may be determined by the drive operating point (e.g., speed or torque) according to its use profile. In some embodiments, the first temperature threshold may be based on the modulation technique used to operate the matrix converter 3724.

If it is determined that the temperature does not exceed the first temperature threshold, the modulation selection process 3900 returns to the block 3902 where the matrix converter 3724 continues to operate using the first modulation technique. A new temperature reading or measurement may then be obtained at the block 3904 and the operations associated with the decision block 3906 may be repeated. The temperature may be measured and evaluated on a continuous basis, intermittently, or on a scheduled basis (e.g., every 5 seconds, once a minute, once every five minutes, once an hour, etc.). In some embodiments, the temperature is continuously monitored, and an alert is triggered if and upon the temperature exceeding the first temperature threshold.

If it is determined that the temperature does exceed the first temperature threshold, the processor 3726 selects a second modulation technique at block 3908. Further, in some cases, a user may be alerted upon determination of the temperature exceeding the first temperature threshold. In some cases, the user may be requested to confirm the selection of the second modulation technique. The second modulation technique may include any type of modulation technique that results in or is intended to result in a lower temperature of the matrix converter 3724. For example, assuming the first modulation technique is SVM 2z, the second modulation technique may be selected to be SVM 1z or MCL. The second modulation technique may be selected to reduce switching frequency of the switches 3802 and/or to reduce motor speed to facilitate reducing the temperature of the matrix converter 3724 and/or the motor assembly 100. In some cases, the motor speed may be determined by the application or use cases, and modulation may not modify or affect motor speed. However, in some embodiments, although modulation technique may not automatically change the fundamental frequency/motor speed, reducing motor speed on a variable torque application (e.g., for pumps and fans) may reduce load, which may in turn reduce temperature.

In some embodiments, the block 3908 may include determining a new carrier frequency. The carrier frequency may correspond to the switching frequency of the switches 3802. The new carrier frequency may be reduced from a first frequency to a second frequency that reduces the switching frequency, which may in turn reduce the temperature and energy losses of the matrix converter 3724.

At block 3910, the processor 3726 operates the matrix converter 3724 using the second modulation technique. Operating the matrix converter 3724 using the second modulation technique may include operating the matrix converter 3724 with reduced occurrence or rate of switching and/or with longer time between switching events. In some embodiments, operating the matrix converter 3724 at the block 3910 may be the same or similar to operating the matrix converter 3724 at the block 3902, but using a different modulation technique. Further, in some embodiments, the block 3910 may include operating the matrix converter 3724 at a reduced carrier frequency.

At block 3912, the processor 3726 measures a temperature of the matrix converter 3724 using, for example, one or more of the temperature sensors 3730. In some embodiments, the block 3912 may include one or more of the embodiments previously described with respect to the block 3904.

At decision block 3914, the processor 3726 determines whether the temperature measured at the block 3912 is below, or in some cases is equal to, a second threshold temperature. In some cases, the first threshold temperature and the second threshold temperature are the same. However, in other cases, the second threshold temperature may be lower by some temperature amount than the first threshold temperature. For example, the second threshold temperature may differ from the first threshold temperature by a hysteresis band amount to reduce or prevent frequent occurrences of shifting between being above and being below a threshold over a period of time. This hysteresis band amount can be any amount determined by a manufacturer or administrator of the motor assembly 100 and may vary depending on application or use case. For example, the hysteresis band amount may be 5° C., 10° C., 15° C., or any other amount. In some cases. the second threshold temperature may be based on one or more of factors used to determine the first threshold temperature.

If it is determined that the temperature measured at the block 3912 is not below the second threshold temperature, the modulation selection process 3900 may return to the block 3910 where the matrix converter 3724 continues to operate using the second modulation technique.

If it is determined that the temperature measured at the block 3912 is below the second threshold temperature, the modulation selection process 3900 may return to the block 3902 where the processor 3726 may revert to operating the matrix converter 3724 using the first modulation technique.

In some embodiments, if it is determined that the temperature is not below the second threshold temperature after a period of time, and/or if the temperature is not declining at a threshold rate, the processor 3726 may select a third modulation technique that causes an even greater reduction in switching and/or motor speed. For example, if the second modulation technique is SVM 1z, the processor 3726 may select MCL as a third modulation technique in an attempt to further reduce the temperature of the matrix converter 3724 and/or the motor assembly 100.

In some embodiments, one or more additional factors or metrics may be used to determine whether to change a modulation technique and/or to select the modulation, or to modify a carrier frequency with respect to the modulation selection process 3900. For example, the processor 3726 may measure load/current of the matrix converter 3724, a speed of the motor 105, audible noise of the 100, THD of the signal generated by the matrix converter 3724, or any other number of characteristics of the matrix converter 3724, the motor 105, or the motor assembly 100.

### Example THD-Based Modulation Selection Process

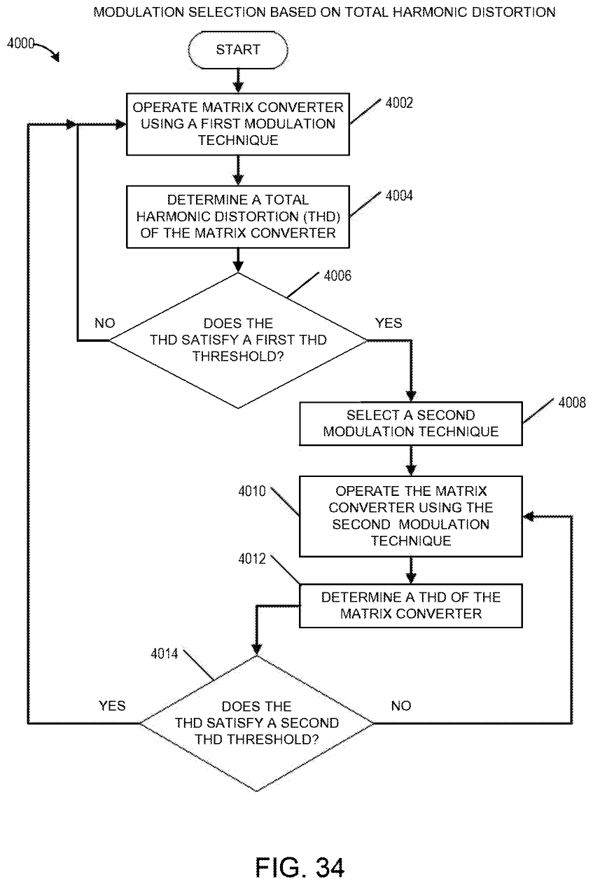

FIG. 34 presents a flowchart of an example modulation selection process 4000 based on total harmonic distortion in accordance with certain embodiments. The modulation selection process 4000 can include any process that can determine or select a modulation technique for controlling a matrix converter 3724 based on the total harmonic distortion of the matrix converter 3724. The modulation selection process 4000 can be implemented by a power quality monitor 3764, a processor 3726, a matrix converter 3724, a processor 3722, and the like. To simplify discussion, and not to limit the present disclosure, the operations of the modulation selection process 4000 are described with respect to certain example systems. However, it should be understood that other systems described herein, and other equivalent systems, may be used to implement certain operations of the modulation selection process 4000.

The modulation selection process 4000 may begin at block 4002 where, for example, the processor 3726 operates the matrix converter 3724 using a first modulation technique. In some embodiments, the block 4002 may include one or more of the embodiments previously described with respect to the block 3902.

At block 4004, the processor 3726 determines a total harmonic distortion (THD) of the matrix converter 3724 using, for example, the power quality monitor 3764. The power quality monitor 3764 may determine the THD by, for example, evaluating the output waveform of the matrix converter 3724. The THD may quantify the distortion introduced by harmonics compared to the fundamental frequency component of the output waveform. The THD may depend on a number of different factors including, for example, one or more of: the modulation technique, the switching frequency, the load (e.g., the motor 105), and/or the filters applied to the matrix converter 3724. The power quality monitor 3764 may measure the THD using a voltage and/or current measurement to determine the THDv or the THDi, respectively. In some embodiments, a voltage or current sensor may be used to capture an output voltage or output current. A Fast Fourier Transform (FFT) may be used to decompose the waveforms into its harmonic components and the THD may be calculated based on the root mean square (RMS) of the fundamental component and the higher-order harmonics. The operations described above with respect to the block 4004 describes an online THD measurement. In some embodiments, an offline THD measurement may be determined. In such cases, the THD may be mapped in advance for each modulation according to the speed and/or torque operating point. This information may be stored in a data structure, such as a lookup table (LUT). At block 4004 the processor 3726 may determine the THD under particular operating conditions by accessing the LUT. Based at least in part on the entries of the LUT, the processor 3726 may maintain a modulation technique and/or may select a different modulation technique.

At decision block 4006, the processor 3726 determines whether the THD determined at the block 4004 satisfies (e.g., is at or below) a first THD threshold. The first THD threshold may be selected based on a manufacturer or user setting. In some cases, the first THD threshold may be based on a power source, such as a connection to a power grid or a generator. In some embodiments, the first THD threshold may be based on the modulation technique used to operate the matrix converter 4002.

If it is determined that the THD does satisfy the first THD threshold, the modulation selection process 4000 returns to the block 4002 where the matrix converter 3724 continues to operate using the first modulation technique. A new THD determination may then be made at the block 4004 and the operations associated with the decision block 4006 may be repeated. The THD may be determined on a continuous basis, intermittently, or on a scheduled basis (e.g., every 5 seconds, once a minute, once every five minutes, once an hour, etc.). In some embodiments, the THD is continuously monitored, and an alert is triggered if and upon the THD not satisfying the first THD threshold.

If it is determined that the THD does not satisfy the first THD threshold, the processor 3726 selects a second modulation technique at block 4008. Further, in some cases, a user may be alerted upon determination that the THD does not satisfy the first THD threshold. In some cases, the user may be requested to confirm the selection of the second modulation technique. The second modulation technique may include any type of modulation technique that results in or is intended to result in a lower THD. For example, assuming the first modulation technique is MCL or SVM 1z, the second modulation technique may be selected to be SVM 2z. The second modulation technique may be selected to increase the motor speed of the motor 105. Operating at a lower motor speed may cause the matrix converter 3724 to generate greater harmonic content. In some embodiments, the motor speed is determined by a user or application. The motor device may operate at the selected speed and the modulation selection may be used to optimize the operation for the selected operating point.

In some embodiments, the block 4008 may include determining a new carrier frequency. The carrier frequency may correspond to the switching frequency of the switches 3802. The new carrier frequency may be increased from a first frequency to a second frequency that increases the switching frequency, which may in turn reduce the THD of the signal generated by the matrix converter 3724.

At block 4010, the processor 3726 operates the matrix converter 3724 using the second modulation technique. Operating the matrix converter 3724 using the second modulation technique may include operating the matrix converter 3724 with an increased occurrence or rate of switching and/or with shorter time between switching events. In some embodiments, operating the matrix converter 3724 at the block 4010 may be the same or similar to operating the matrix converter 3724 at the block 4002, but using a different modulation technique. Further, in some embodiments, the block 4010 may include operating the matrix converter 3724 at an increased carrier frequency.

At block 4012, the processor 3726 determines a THD of the matrix converter 3724. The block 4012 may include one or more of the embodiments of the block 4004. In some embodiments, the block 4012 may include one or more of the embodiments previously described with respect to the block 4004.

At decision block 4014, the processor 3726 determines whether the THD determined at the block 4012 satisfies the second THD threshold. In some cases, the first THD threshold and the second THD threshold are the same. However, in other cases, the second THD threshold may differ from the first THD threshold by a hysteresis band value to reduce or prevent frequent occurrences of shifting between being above and being below a threshold over a period of time. This hysteresis band amount can be any amount determined by a manufacturer or administrator of the motor assembly 100 and may vary depending on application or use case. For example, the hysteresis band amount may be 1%, 2%, 5%, or any other amount.

If it is determined that the THD measured at the block 4012 does not satisfy the second THD threshold, the modulation selection process 4000 may return to the block 4010 where the matrix converter 3724 continues to operate using the second modulation technique.

If it is determined that the temperature measured at the block 4012 does satisfy the second THD threshold, the modulation selection process 4000 may return to the block 4002 where the processor 3726 may revert to operating the matrix converter 3724 using the first modulation technique.

In some embodiments, one or more additional factors or metrics may be used to determine whether to change a modulation technique and/or to select the modulation, or to modify a carrier frequency with respect to the modulation selection process 4000. For example, the processor 3726 may measure load/current of the matrix converter 3724, a speed of the motor 105, audible noise of the 100, a temperature of the matrix converter 3724, or any other number of characteristics of the matrix converter 3724, the motor 105, or the motor assembly 100.

### Example Control Factor Prioritization Based Modulation Selection Process

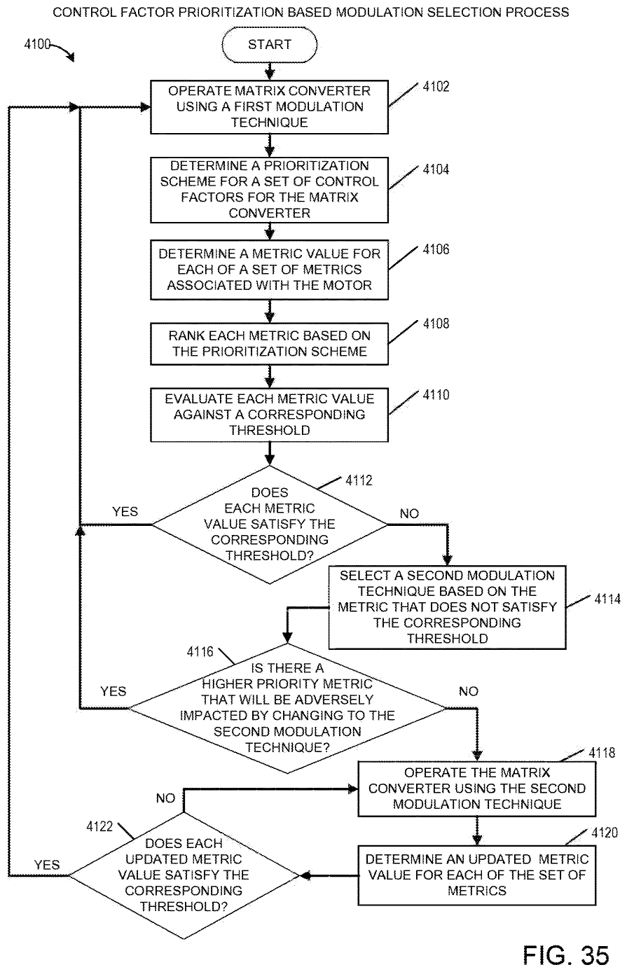

FIG. 35 presents a flowchart of an example of a modulation selection process 4100 based on a control factor prioritization in accordance with certain embodiments. The modulation selection process 4100 can include any process that can determine or select a modulation technique for controlling a matrix converter 3724 based on a prioritization of one or more control factors. The modulation selection process 4100 can be implemented by a power quality monitor 3764, a temperature sensor 3716, a temperature sensor 3730, a processor 3726, a matrix converter 3724, a processor 3722, a vibration sensor, a noise sensor, a torque sensor, and the like. To simplify discussion, and not to limit the present disclosure, the operations of the modulation selection process 4100 are described with respect to certain example systems. However, it should be understood that other systems described herein, and other equivalent systems, may be used to implement certain operations of the modulation selection process 4100.

The modulation selection process 4100 may begin at block 4102 where, for example, the processor 3726 operates the matrix converter 3724 using a first modulation technique. In some embodiments, the block 4102 may include one or more of the embodiments previously described with respect to the block 3902.

At block 4104, the processor 3726 determines a prioritization scheme for a set of control factors for the matrix converter 3724. The prioritization scheme may be determined based on input from a user. The input may be received in response to user interaction with a user interface generated by a user interface controller (not shown) and/or by a processor 3726. The input may identify one or more control factors for the matrix converter 3724 that affect operation of the matrix converter 3724 or selection of a modulation technique. In some embodiments, the prioritization scheme may be stored at a memory, such as a volatile memory or a non-volatile memory (e.g., the memory 3723 or the memory 3728). In some such cases, the block 4104 may include accessing the prioritization scheme from the memory. In some cases, the control factors may be based on a location of the motor assembly 100 or a use-case for the motor assembly 100 (e.g., mining, manufacturing, HVAC, and the like).

The control factors may include any factor that can affect operation of the matrix converter 3724 and/or selection of a modulation technique for the matrix converter 3724. For example, the control factor may be temperature, THD, vibration, noise, motor speed, torque, and the like.

At block 4106, the processor 3726 determines a metric value for each of a set of metrics associated with the motor. The set of metrics may correspond to the control factors. In some cases, the metrics and the control factors may be the same. In other cases, there may be a correspondence between the metrics and the control factors, but they may differ. For example, THD may be a control factor, but the metric that is measured may be current. The current metric may be used to determine the THD.

The processor 3726 may use one or more sensors to measure one or more metric values associated with one or more of the metrics and/or control factors. For example, the processor 3726 may use one or more of the temperature sensors 3730 to measure a temperature of the matrix converter 3724 or one or more elements of the matrix converter 3724. As another example, the processor 3726 may use a power quality monitor 3764 and/or one or more voltage or current sensors to measure the THD or current/voltage values that can be used to calculate the THD. The power quality monitor 3764 may be or may include a current-based power quality sensor and/or a voltage-based power quality sensor. In yet other examples, one or more vibration or audio sensors (not shown) may be used to measure vibration and/or audio generated by the motor assembly 100 during operation of the motor assembly 100. Further, the processor 3726 may use accelerometers or other sensors to determine motor speed and/or torque. In some embodiments, a metric value may be calculated based on a measurement from a sensor. For example, a current measurement may be used to calculate a THD value.

At block 4108, the processor 3726 ranks each metric based on the prioritization scheme. In some embodiments, the ranking may be based on a weighting of each control factor and/or metric. In some embodiments, the block 4108 may be optional or omitted. For example, in some embodiments, a composite value or composite score may be generated for the metric values. As various metrics may not be directly combinable (e.g., a temperature is generally not directly combinable with a current or a vibration value), generating the composite value or composite score may include determining a score for each metric where the score of the metrics may be combinable. For example, a score may be determined for a metric by determining where the metric value is within a scale that is specific to the metric. As another example, the score may be determined by comparing the metric value to a threshold. Regardless of how the score is determined, the score may be combined with other scores associated with other metrics for which values are determined at the block 4106. The score values may be directly summed or may be combined using a weighting determined from the prioritization scheme.

At block 4110, the processor 3726 evaluates each metric value against a corresponding threshold. In some cases, the block 4110 involves evaluating a subset of metrics. For example, if it is determined that the metric value associated with a highest ranked metric does not satisfy a corresponding threshold, the modulation selection process 4100 may proceed without evaluating additional metric values. Thus, in some cases, the processor 3726 may cease determining whether the metric value for each metric satisfies a corresponding threshold if it is determined that at least one of the metrics does not satisfy a corresponding threshold. Alternatively, or in addition, the block 4110 may include determining whether a composite value satisfies a threshold set for the composition of values associated with the set of metrics. The threshold may be based on the particular metric being evaluated and/or the particular prioritization scheme.

At decision block 4112, the processor 3726 determines whether each metric value satisfies the corresponding threshold. If it is determined at the decision block 4112 that each metric satisfies the corresponding threshold, the modulation selection process 4100 returns to the block 4102 where the matrix converter 3724 continues to operate using the first modulation technique.

If it is determined at the decision block 4112 that at least one metric, or a composite value, does not satisfy the corresponding threshold, the modulation selection process 4100 proceeds to block 4114 where the processor 3726 selects a second modulation technique based at least in part on the metric that does not satisfy the corresponding threshold. In some embodiments, the selection of the second modulation technique may be based on a plurality of metrics, whether they satisfy their corresponding thresholds or not. Further, in some cases, a user may be alerted upon determination that at least one metric or the composite values does not satisfy the corresponding threshold. In some cases, the user may be requested to confirm the selection of the second modulation technique. The second modulation technique may include any type of modulation technique that results in or is intended to cause the one or more metrics, or the composite value, to satisfy the corresponding threshold. For example, assuming the first modulation technique is SVM 2z, the second modulation technique may be selected to be SVM 1z or MCL. The second modulation technique may be selected to reduce or increase switching frequency of the switches 3802 and/or to reduce or increase motor speed to facilitate satisfying the desired control factors included in the prioritization scheme.

In some embodiments, the block 4114 may include determining a new carrier frequency. The carrier frequency may correspond to a rate at which the switches 3802 are modified between states. The new carrier frequency may be modified from a first frequency to a second frequency that adjusts the switching frequency of the switches 3802, which may in turn adjust one or more control factors or metrics of the matrix converter 3724, such as temperature, energy losses, THD, noise, vibration, and the like.

At decision block 4116, the processor 3726 determines whether there is a higher priority metric that will be adversely impacted by changing operation of the matrix converter 3724 from the first modulation technique to the second modulation technique. In certain embodiments, changing a modulation technique to improve a particular metric may be undesirable if a higher priority metric is negatively impacted by changing the modulation technique. In such cases, the modulation selection process 4100 may forego modifying the modulation technique or may select a different modulation technique that may improve the particular metric at a lower rate but maintain the higher priority metric.

As a non-limiting example, the prioritization scheme may indicate that the prioritization of control factors from highest to lower priority is: 1) energy losses and/or temperature; 2) THD; 3) smoothness of torque production; and 4) audible noise. It should be understood that the priority of control factors may differ and may be set by a manufacturer and/or an end-user. Continuing the example, it may be determined at the decision block 4112 that the audible noise does not satisfy a noise threshold. As such, the processor 3726 may select a new modulation scheme that reduces the audible noise generated by, for example, increasing motor speed. As an additional benefit, in some cases, the new modulation scheme that reduces audible noise may result in smoother torque production. However, continuing this example, the new modulation scheme may result in matrix converter 3724 operating at a higher temperature. If the increased temperature remains below a threshold, the increased temperature may be acceptable. However, if it is determined at the decision block 4116 that the new modulation technique will result in or is likely to result in the temperature exceeding a temperature threshold, the processor 3726 may determine not to change the modulation technique because, in this example, the temperature of the matrix converter 3724 is prioritized higher than the audible noise output of the motor assembly 100.

If it is determined at the decision block 4116 that there is a higher priority metric that will be adversely impacted by changing to the second modulation technique, the modulation selection process 4100 returns to the block 4102 where the processor 3726 continues to operate the matrix converter 3724 using the first modulation technique. Alternatively, in some embodiments, the processor 3726 may return to the block 4114 and attempt to identify another modulation technique that may not adversely impact higher priority metrics.

If it is determined at the decision block 4116 that there is not a higher priority metric that will be adversely impacted by changing to the second modulation technique, the modulation selection process 4100 proceeds to the block 4118. It may be determined at the decision block 4116 that there is not a higher priority metric that will be adversely impacted by changing to the second modulation technique because, for example, the metric that did not satisfy the corresponding threshold was the highest priority metric or because higher priority metrics are not adversely impacted by the change to the second modulation technique.

At block 4118, the processor 3726 operates the matrix converter 3724 using the second modulation technique. Operating the matrix converter 3724 using the second modulation technique may include operating the matrix converter 3724 with a different switching rate and/or with longer time between switching events compared to operation using the first modulation technique. In some embodiments, operating the matrix converter 3724 at the block 4118 may be the same or similar to operating the matrix converter 3724 at the block 4102, but using a different modulation technique. Further, in some embodiments, the block 4118 may include operating the matrix converter 3724 at an alternative carrier frequency.

At block 4120, the processor 3726 determines an updated metric value for each of a set of metrics associated with the motor and/or the matrix converter 3724. In some embodiments, the block 4120 may include one or more of the embodiments previously described with respect to the block 4106.

At decision block 4122, the processor 3726 determines whether each updated metric satisfies the corresponding threshold. In some embodiments, the decision block 4122 may include one or more of the embodiments previously described with respect to the block 4110 and/or the decision block 4112.

If it is determined at the decision block 4122 that at least one metric does not satisfy the corresponding threshold, the modulation selection process 4100 returns to the block 4118 where the processor 3726 continues to operate using the second modulation technique. In some embodiments, the corresponding threshold is the same threshold at the decision block 4122 and at the block 4110. In other embodiments, the corresponding threshold at the decision block 4122 may differ for at least one metric. In some embodiments, if a metric does not satisfy a corresponding threshold at the decision block 4122 or after a particular period of time, the processor 3726 may repeat the process of selecting a new modulation technique. For example, if it was determined at the decision block 4112 that the temperature of the matrix converter 3724 does not satisfy a temperature threshold, a second modulation technique may be selected at the block 4114 to reduce the temperature of the matrix converter 3724. Continuing the previous example, if it is determined at the decision block 4122 that the temperature of the matrix converter 3724 continues to not satisfy a temperature threshold, the processor 3726 may repeat the process associated with the block 4114 to select a third modulation technique. Alternatively, the processor 3726 may select a third modulation technique and operate the matrix converter 3724 using the third modulation technique. This process may be repeated until a corresponding threshold is satisfied by the determined metric values for the metrics identified by the prioritization scheme.

If it is determined at the decision block 4118 that each metric satisfies the corresponding threshold, the modulation selection process 4100 returns to the block 4102 where the processor 3726 restores operation or reverts to operating the matrix converter 3724 using the first modulation technique.

### Example Matrix Converter Control Process

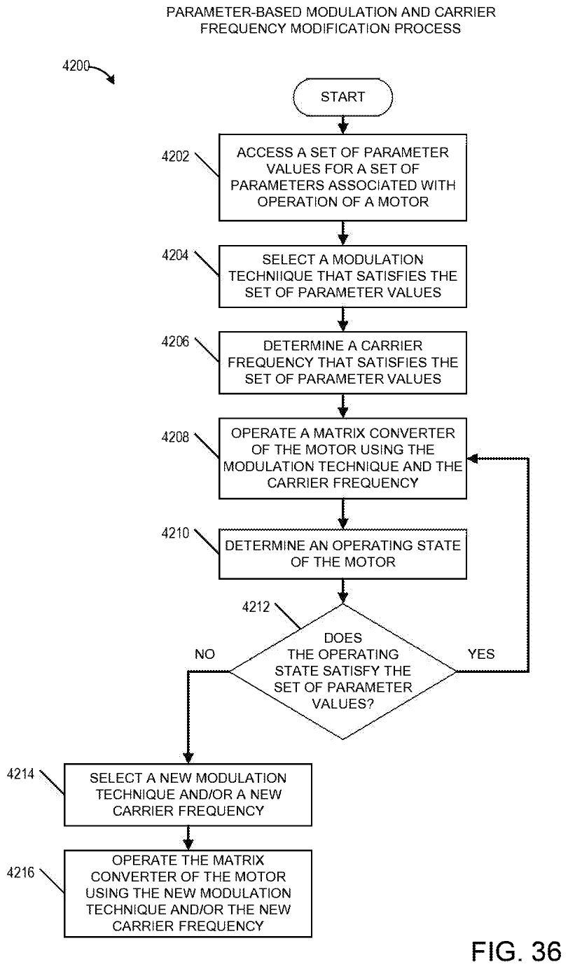

FIG. 36 presents a flowchart of an example matrix converter control process 4200 that modifies modulation and carrier frequency based on one or more parameters in accordance with certain embodiments. The matrix converter control process 4200 can include any process that can determine or select a modulation technique and/or modify a carrier frequency of a matrix converter 3724 based on one or more parameters. The matrix converter control process 4200 can be implemented by a power quality monitor 3764, a temperature sensor 3716, a temperature sensor 3730, a processor 3726, a matrix converter 3724, a processor 3722, a vibration sensor, a noise sensor, a torque sensor, and the like. To simplify discussion, and not to limit the present disclosure, the operations of the matrix converter control process 4200 are described with respect to certain example systems. However, it should be understood that other systems described herein, and other equivalent systems, may be used to implement certain operations of the matrix converter control process 4200.

The matrix converter control process 4200 may begin at block 4202 where, for example, the processor 3726 accesses a set of parameter values for a set of parameters associated with operation of a motor assembly 100 or a motor 105. The set of parameters may include one or a plurality of parameters. Further, the set of parameter values may include one or more parameter values for each parameter. The parameters may include target parameters associated with a desired operating state of the motor 105 and/or health-based parameters associated with maintaining operation of the motor 105 or keeping motor 105 operating in a safe state that is unlikely to cause damage to the motor 105. For example, the parameters may include a desired operating speed of the motor 105, a safe temperature for the motor 105, a safe vibration level for the motor 105, a desired THD, a desired noise level, and the like. In some cases, the desired operating state parameters and the health-based parameters may be related. For example, a noise level above the desired noise level may indicate a potential fault with the motor 105. As another example, operating above or below a target speed may cause an increased risk of damage to the motor 105.

At block 4204, the processor 3726 selects a modulation technique that satisfies the set of parameter values. In some cases, the modulation technique may be selected to satisfy a single parameter. In other cases, the modulation technique may be selected to satisfy a plurality of parameters. For example, if it is desirable to operate the matrix converter 3724 with the lowest or best THD and for the motor 105 to have the best performance without concern of conduction loss, the processor 3726 may select SVM 2z modulation and the motor may operate at under 33% of motor speed. If on the other hand, it is desirable to operate the motor 105 at a higher speed (e.g., more than 33%) and higher load, the matrix converter 3724 may operate using SVM modulation, which may offer a compromise between THD and conduction loss for the matrix converter 3724. At higher speed, but low load, the fan may provide increased cooling. However, at higher loads, conduction losses may increase. In yet another example, if it is desirable to reduce a temperature, the processor 3726 may select a MCL modulation technique. In some cases, the processor 3726 may initially operate the matrix converter 3724 using the modulation that provides optimal performance, such as SVM 2z or SWM 3z, and may adjust the selection of modulation technique to satisfy the set of parameters values if it is determined that the operation using the initial selection does not satisfy desired parameters. Thus, a user may specify a desired parameter and the processor 3726 may perform automatic modulation control to adjust to satisfy parameters as a state of the motor assembly 100 is determined or measured.

Selecting a modulation technique that satisfies the set of parameter values may include selecting a modulation technique that satisfies all of the parameter values. Alternatively, selecting the modulation technique that satisfies the set of parameter values may include selecting a modulation technique that satisfies one or more parameters that are identified as the highest priority, while parameters that are identified as lower priority may not be satisfied if they cannot be satisfied while still satisfying the parameters identified as higher priority.

At block 4206, the processor 3726 determines a carrier frequency that satisfies the set of parameter values. In some cases, not all parameters may be affected by the carrier frequency. In some such cases, determining the carrier frequency that satisfies the set of parameter values may include determining the carrier frequency that satisfy a subset of the parameter values (e.g., the parameters that are affected by carrier frequency). For example, initially, the carrier frequency may be 8 kHz, 10 kHz, or some other rate. If it is determined that the parameter values are not satisfied, the processor 3726 may modify the carrier frequency, such as by reducing it to 6 kHz or 4 kHz, or some other rate below the initial carrier frequency. In some cases, the carrier frequency may be increased rather than decreased.

The carrier frequency may refer to the rate at which the selected modulation updates the switching states for the switches 3802. The switching frequency of the switches 3802 may refer to the rate at which each of the switches 3802 turn ON and OFF. Thus, although the carrier frequency and the switching frequency may be related, in some case they may not be identical.

In some embodiments, determining the carrier frequency that satisfies the set of parameter values may be affected by the modulation technique. Similarly, in some embodiments, determining the modulation technique that satisfies the set of parameter values may be affected by the carrier frequency. Thus, in some embodiments, operations associated with the block 4204 and the block 4206 may be performed at least partially in parallel. Alternatively, the operations may be performed iteratively with, for example, an initial selected modulation technique being updated based on a selected carrier frequency or vice versa.

At block 4208, the processor 3726 operates a matrix converter 3724 of the motor 105 using the modulation technique and the carrier frequency. In some embodiments, the block 4208 may include one or more of the embodiments previously described with respect to the block 3902.

At block 4210, the processor 3726 determines an operating state of the motor 105. In some embodiments, the block 4210 may include one or more of the embodiments previously described with respect to the block 4106.

At decision block 4212, the processor 3726 determines whether the operating state satisfies the set of parameter values. For example, the processor 3726 may determine whether the THD or the motor speed satisfies a target value specified by the set of parameter values. Similarly, the processor 3726 may determine whether an operating temperature or a noise level satisfies a target value. In some cases, the motor assembly 100 may be associated with a particular target profile. In some such cases, the decision block 4212 may include comparing the state of the motor assembly 100 to the target profile. For example, the motor assembly 100 may be associate with a desired noise profile or a vibration profile. In such cases, the operating state of the motor assembly 100, or of the motor 105 may be compared to the noise profile or the vibration profile to determine whether the motor assembly 100, or the motor 105 is producing more noise or vibrations that the profile. This profile may be manufacturer specified, or user specified. In the previous example, the noise may refer to auditory noise. However, in some cases, the noise may be noise within a signal generated by the matrix converter 3724.

If it is determined at the decision block 4212 that the operating states does satisfy the set of parameter values, the matrix converter control process 4200 returns to the block 4208 and continues to operate the matrix converter 3724 using the modulation technique and the carrier frequency determines at the block 4204 and the block 4206, respectively.

If it is determined at the decision block 4212 that the operating states does not satisfy the set of parameter values, the matrix converter control process 4200 proceeds to block 4214 where the processor 3726 selects a new modulation technique and/or a new carrier frequency. In some cases, the matrix converter control process 4200 proceeds to the block 4214 if the operating state does not satisfy at least one of the set of parameter values. In some other cases, the matrix converter control process 4200 proceeds to the block 4214 if the operating state does not satisfy parameter values for one or more particular parameters that are designated as higher priority than one or more other parameters.

Selecting the new modulation technique and/or the new carrier frequency may include selecting a modulation technique and/or carrier frequency that satisfies the set of parameter values. In some cases, the parameters are ranked. In some such cases, selecting a modulation technique and/or carrier frequency that satisfies the set of parameter values may include selecting a modulation technique and/or carrier frequency that satisfies at least a highest ranked parameter of the set of parameters. In some other cases, selecting a modulation technique and/or carrier frequency may include selecting a modulation technique and/or carrier frequency that satisfies a majority or a plurality of the parameters.

At the block 4216, the processor 3726 operates the matrix converter 3724 of the motor 105 using the new modulation technique and/or the new carrier frequency determines at the block 4214. In some embodiments, the 4216 may include one or more embodiments of the block 4208.

A number of different example processes have been described herein. In certain embodiments, the motor assembly 100 may support one or more of the processes described herein. Further, embodiments of one or more operations described with respect to one process may be applied in another process. Moreover, the motor assembly 100 may implement some or all of the embodiments disclosed herein. Further, one or more of the embodiments described herein may be combinable or may be separate.

### Example Matrix Converter Control Use Cases

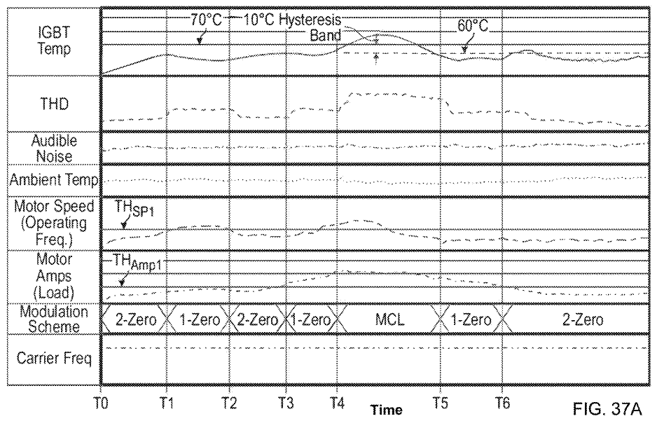

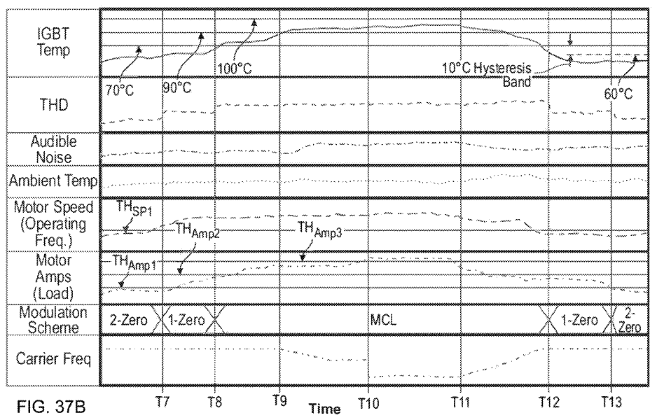

FIG. 37A and FIG. 37B present a set of graphs illustrating one non-limiting example use case of operating a matrix converter of a motor 105 in accordance with certain embodiments. The graphs of FIG. 37B are a continuation of the graphs of FIG. 37A illustrating additional time periods of operation. The graphs of FIG. 37A illustrate a set of time periods delineated T0-T6. The graphs of FIG. 37B illustrate a set of time periods delineated T7-T13.

Starting at time T0, the motor 105 may be initially off and is turned on. The temperature of the switches 3802 of the matrix converter 3724 is initially at some ambient temperature based on a location of the motor assembly 100. For example, the temperature may be 20° C. or any other temperature primarily based on the ambient temperature of the environment rather than based on operation of the motor 105.

At time T0, and up until time T1, the matrix converter 3724 may be operated using a modulation technique or scheme SVM 2z. The modulation technique of SVM 2z may be selected because the motor speed is below the threshold of TH_{SP1} and the current or load of the motor is below the threshold TH_{Amp1} at time T0. The TH_{Amp1} may be some current corresponding to a continuous current value produced by the matrix converter 3724. For example, the TH_{Amp1} may be 50%, 75%, 80%, etc. of the rated continuous value of the matrix converter 3724.

At time T1, the processor 3726 may determine that the motor speed, or operating frequency, has increased to exceed the threshold TH_{SP1} as indicated by the Motor Speed graph. The increase in motor speed may be due to user request. Alternatively, or in addition, the increase in motor speed may be an automated adjustment due to one or more control factors. For example, the processor 3726 may determine to modify the modulation scheme due to the increased temperature at T1. Consequently, the processor 3726 may also determine to modify the motor speed due to the change in modulation. Thus, in certain embodiments, there may be multiple adjustments to parameters of the motor assembly 100 due to a determined metric value. In other cases, the motor speed is set based on the desired application. In such cases, the change in modulation may not affect or change the motor speed. However, in some cases, due for example to temperature, the processor 3726 may be configured to override a user's motor speed selection or command and reduce the motor speed to reduce load and thereby reduce temperature and/or losses. In the illustrated example, the processor 3726 modifies the modulation scheme of the matrix converter 3724 to SVM 1z at time T1 as indicated by the Modulation Scheme graph.

At time T2, the processor 3726 may revert operation of the matrix converter 3724 to the modulation scheme SVM 2z. The change back to SVM 2z may occur because the motor speed, or operating frequency, has decreased below the threshold TH_{SP1}.

At time T3, the processor 3726 may determine that a load of the motor 105 exceeds a threshold TH_{Amp1}. This determination may be made by measuring a current at the load using a current sensor. As a result of the load exceeding the threshold TH_{Amp1}, the processor 3726 may change the modulation scheme of the matrix converter 3724 to SVM 1z.

At time T4, using, for example, a temperature sensor 3730, the processor 3726 may determine that a temperature of the switches 3802 exceeds a threshold (e.g., 70° C.) as indicated by the IGBT Temp graph. In response to determining that the temperature threshold has been exceeded, the processor 3726 may change the modulation scheme of the matrix converter 3724 to MCL at time T4.

At time T5, the processor 3726 using, for example, a temperature sensor 3730, may determine that the temperature of the matrix converter 3724 (or the switches 3802 thereof) has reduced below a temperature threshold. In some embodiments, and as illustrated in FIG. 37A, this threshold may not be the same threshold as used at T4, but may incorporate a hysteresis band to prevent or reduce excessive modulation changes due to a temperature oscillation around a threshold. Thus, as illustrated in FIG. 37A, the temperature threshold at time T4 may be 60° C. incorporating a 10° C. hysteresis band. Responsive to determining that the temperature is below the 60° C. threshold, the processor 3726 may revert the modulation scheme of the matrix converter 3724 back to SVM 1z. In some embodiments, the determination to modify the modulation scheme of the matrix converter 3724 may be based on a combination of the reduction in temperature of the switches 3802 and the load, as indicated by the Motor Amps graph, being above the TH_{Amp1} threshold.

At time T6, the processor 3726 using, for example, a current sensor may determine that the load has reduced to below the TH_{Amp1} threshold as indicated by the Motor Amps graph. As a result, the processor 3726 may determine to modify the modulation scheme of the matrix converter 3724 to be SVM 2z.

Turning to FIG. 37B, which continues the graphs from FIG. 37A, at time T7, the motor speed may increase above a threshold motor speed of TH_{SP1} as indicated by the Motor Speed graph. The processor 3726 may determine to change the modulation scheme of the matrix converter 3724 to SVM 1z. Advantageously, switching the modulation scheme from SVM 2z to SVM 1z may provide a compromise between THD and motor performance and losses for the motor 105.

At time T8, the processor 3726 may determine that the temperature of the switches 3802 has increased above the 70° C. threshold as indicated by the IGBT graph. Consequently, the processor 3726 may modify the switching modulation scheme to MCL, which may reduce switching frequency and help to reduce temperature of the switches 3802 of the matrix converter 3724.

From time T0 to time T8, a carrier frequency (illustrated in graph Carrier Freq) was set at an initial value. For example, the carrier frequency may be at 8 kHz between TO and T8. The carrier frequency may refer to the rate at which the modulation signal (e.g., the SVM signal) updates the switching state of the switches 3802. The individual switches of the switches 3802 may be associated with a switching frequency that corresponds to the frequency at which the power semiconductor switches (e.g., the IGBTs or MOSFETs) turn on or off.

Between time T8 and T9, the temperature of the switches (as indicated by the graph IGBT Temp) may rise. At time T9, the processor 3726 may determine, using for example the temperature sensors 3730, that the temperature of the switches 3802 has reached 90° C. As the rate at which the switching state of the switches 3802 are update may increase the temperature of the switches 3802, at time T9, the processor 3726 may begin to reduce the carrier frequency by, for example 100 Hz per 1° C. of temperature above 90° C. It should be understood that the carrier frequency can be modified at a different rate and/or in response to a different temperature. Further, in some embodiments, when the motor load (as indicated by the graph Motor Amps) exceeds a threshold TH_{Amp2}, the carrier frequency may be reduced by some rate, such as 100 Hz. In some embodiments, the processor 3726 may determine to reduce the carrier frequency based on a combination of the switch temperature exceeding 90° C. and the motor load exceeding TH_{Amp2}. The TH_{Amp2} may be a current of 100% of the rated continuous value of the matrix converter 3724. In some cases, the TH_{Amp2} may be a higher or lower current value.

At time T10, the processor 3726 may determine that the temperature of the switches 3802 continues to exceed 90° C. while the motor load now exceeds TH_{Amp3}. The TH_{Amp3} may be some selected current threshold that is above TH_{Amp2}, such as 150% of the rated continuous value of the matrix converter 3724. In some cases, the TH_{Amp3} may be a higher or lower current value that exceeds TH_{Amp2}. At time T10, as the temperature remains high (e.g., above 90° C.) and the motor load exceeds the higher threshold TH_{Amp3}, the processor 3726 may further decrease the carrier frequency. For example, the processor 3726 may decrease the carrier frequency to a minimum carrier frequency. The minimum carrier frequency may be any carrier frequency that can be implemented by the processor 3726 while maintaining one or more characteristics or settings of the motor 105. Thus, if the minimum carrier frequency is 6 kHz, the processor 3726 may decrease the carrier frequency to 6 kHz in an attempt to reduce the motor load and/or temperature of the switches 3802. It should be understood that other carrier frequencies may be supported as the minimum carrier frequency or in general by the matrix converter 3724.

At time T11, the processor 3726 may determine that the motor load has decreased below TH_{Amp3} and that in addition, the temperature of the switches 3802 has begun decreasing. In some cases, because the temperature remains high, the processor 3726 may take no action. However, in other cases, because the motor load has decreased and the temperature is beginning to decrease, the processor 3726 may begin to increase the carrier frequency as illustrated in FIG. 37B. The processor 3726 may increase the carrier frequency at the same rate it initially began decreasing the carrier frequency (e.g., 100 Hz), or may increase the carrier frequency at some other rate. The rate the carrier frequency is adjusted (either increase or decrease) may be based on particular metric values for various control factors, such as the motor load, temperature, audible noise, or other control factor.

As the motor load and temperature of the switches 3802 continues to decrease between T11 and T12, the processor 3726 may continue to increase the carrier frequency until it reaches a normal and/or maximum support carrier frequency (e.g., 8 kHz). At time T12, the processor 3726 may determine that the temperature has dropped a hysteresis band amount below the threshold temperature. For example, assuming the threshold temperature is 70° C. and the hysteresis band is 10° C., the processor 3726 determines that the temperature of the switches 3802 has dropped to 60° C., or in some cases, below 60° C. As such, at time T12, the processor 3726 may modify the modulation technique from MCL to SVM 1z.

At time T13, the processor 3726 may determine that the conditions of the matrix converter 3724, or of the motor 105, have returned to a state that permits operation using an optimal modulation scheme for the matrix converter 3724. For example, the processor 3726 may determine that the temperature is below a threshold temperature, that the motor load is below the TH_{Amp1} threshold, that the THD is below a threshold, and the like. As such, the processor 3726 may modify the modulation scheme for the matrix converter 3724 to be SVM 2z.

As previously explained, the example use-cases described and illustrated with respect to the FIG. 37A and FIG. 37B are non-limiting illustrative examples. Other thresholds may be used to determine when to modify the modulation scheme and what modulation scheme or technique to select. Further, other factors may be used to determine whether to modify the modulation technique. For example, at time T4, THD begins to increase and reaches a high point shortly after time T4. In response, the processor 3726 could increase the motor speed and/or change the modulation scheme from MCL to a modulation scheme with increased switching, such as SVM 2z. By increasing the motor speed, THD may be reduced.

### Terminology

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale.

Although described and illustrated with respect to exemplary embodiments thereof, the foregoing and various other additions and omissions may be made therein and thereto without departing from the spirit and scope.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A motor assembly comprising:
a motor housing;
an electric motor at least partially disposed in the motor housing;
a variable frequency drive implementing a matrix converter comprising a plurality of bidirectional switches;
a plurality of sensors, wherein each sensor of the plurality of sensors is configured to determine a metric value for a characteristic of the electric motor, and wherein each sensor of the plurality of sensors measures a different characteristic of the electric motor;
a non-volatile memory configured to store a prioritization scheme specifying a prioritization of characteristics for the electric motor, wherein the characteristics are measured by the plurality of sensors; and
a controller implemented by a hardware processor, the controller configured to access the prioritization scheme from the non-volatile memory and to select a modulation technique from a plurality of modulation techniques based at least in part on the prioritization scheme and one or more metric values obtained from one or more corresponding sensors of the plurality of sensors, wherein the controller is further configured to control a state of a bidirectional switch from the plurality of bidirectional switches based at least in part on the modulation technique.

2. The motor assembly of claim 1, wherein the plurality of modulation techniques comprises minimum commutation loss (MCL) modulation, space vector modulation with one zero vector per switching sequence (SVM 1z), space vector modulation with two zero vectors per switching sequence (SVM 2z), space vector modulation with three zero vectors per switching sequence (SVM 3z), a carrier based per-phase modulation, or Alesina-Venturini modulation.

3. The motor assembly of claim 1, further comprising a user interface controller configured to present a user interface to a user, wherein the prioritization scheme is received in response to user interaction by the user with the user interface.

4. The motor assembly of claim 1, wherein the prioritization scheme ranks the characteristics of the electric motor.

5. The motor assembly of claim 4, wherein the controller selects the modulation technique based at least in part on a metric value obtained from a sensor of the plurality of sensors associated with the characteristic of the electric motor with a highest ranking.

6. The motor assembly of claim 1, wherein the controller is further configured to determine a composite value based on metric values obtained from the plurality of sensors, and wherein the controller selects the modulation technique based at least in part on whether the composite value satisfies a threshold.

7. The motor assembly of claim 6, wherein the controller is further configured to select a second modulation technique from the plurality of modulation techniques based at least in part on the composite value changing by at least a threshold amount.

8. The motor assembly of claim 1, wherein the controller is further configured to weight each metric value of the one or more metric values based at least in part on the prioritization scheme.

9. The motor assembly of claim 1, wherein the plurality of sensors comprises a temperature sensor, a current-based power quality sensor, a voltage-based power quality sensor, a vibration sensor, or a noise sensor.

10. The motor assembly of claim 1, wherein the characteristics of the electric motor comprise: a temperature of the matrix converter, a temperature of the motor assembly; a total harmonic distortion of the matrix converter, an audible noise, a degree of vibration, a rate of energy loss, a motor speed, or a measure of torque production.

11. A method of operating a motor assembly comprising a matrix converter, the method comprising:
by a hardware processor configured to implement a matrix converter controller,
operating the matrix converter using a first modulation technique at a first time, wherein the first modulation technique controls operation of a set of bidirectional switches of the matrix converter, and wherein the first modulation technique is one of a plurality of modulation techniques supported by the matrix converter controller;
determining a prioritization scheme for a set of control factors for the matrix converter;
determining, at the first time, a metric value for each metric of a set of metrics associated with the motor assembly, wherein the set of metrics correspond to the set of control factors;
ranking the set of metrics based on the prioritization scheme;
determining, in order of the ranking of the set of metrics, whether the metric value for each metric satisfies a corresponding threshold;
determining that a first metric value associated with a first metric of the set of metrics does not satisfy the corresponding threshold;
selecting a second modulation technique from the plurality of modulation techniques based at least in part on the first metric; and
operating the matrix converter using the second modulation technique at a second time that is later than the first time.

12. The method of claim 11, wherein selection of the second modulation technique is further based at least in part on the first metric value associated with the first metric.

13. The method of claim 11, wherein the first metric is a highest ranked metric in the set of metrics based on the prioritization scheme.

14. The method of claim 11, wherein a second metric is ranked higher than the first metric in the set of metrics based on the prioritization scheme, and wherein a second metric value associated with the second metric satisfies the corresponding threshold.

15. The method of claim 11, further comprising ceasing to determine, in the order of the ranking of the set of metrics, whether the metric value for each metric satisfies the corresponding threshold in response to determining that the first metric value does not satisfy the corresponding threshold.

16. The method of claim 11, wherein the matrix converter operates at a carrier frequency, and wherein selecting the second modulation technique comprises determining a modification to the carrier frequency based at least in part on the first metric value.

17. The method of claim 11, further comprising:
determining, at a third time that is later than the second time, that a second metric value associated with the first metric satisfies the corresponding threshold or a corresponding threshold adjusted by a hysteresis band; and
restoring operation of the matrix converter to operation using the first modulation technique.

18. The method of claim 11, wherein the set of metrics associated with the motor assembly: a temperature of the matrix converter, a temperature of the motor assembly; a total harmonic distortion of the matrix converter, an audible noise, a degree of vibration, a rate of energy loss, a motor speed, or a measure of torque production.

19. A non-transitory computer-readable medium configured to store computer-executable instructions that when executed by a hardware processor causes the hardware processor to at least:
operate a matrix converter of a motor assembly using a first modulation technique at a first time, wherein the first modulation technique controls operation of a set of bidirectional switches of the matrix converter, and wherein the first modulation technique is one of a plurality of modulation techniques;
determine a prioritization scheme for a set of metrics for the motor assembly;
determine, at the first time, a metric value for each metric of the set of metrics associated with the motor assembly;
rank the set of metrics based on the prioritization scheme;
determine, in order of the ranking of the set of metrics, whether the metric value for each metric satisfies a corresponding threshold;
determine that a first metric value associated with a first metric of the set of metrics does not satisfy the corresponding threshold;
selecting a second modulation technique from the plurality of modulation techniques based at least in part on the first metric; and
operating the matrix converter using the second modulation technique at a second time that is later than the first time.

20. The non-transitory computer-readable medium of claim 19, wherein the computer-executable instructions further cause the hardware processor to at least cease determining, in the order of the ranking of the set of metrics, whether the metric value for each metric satisfies the corresponding threshold in response to determining that the first metric value does not satisfy the corresponding threshold.

21. The non-transitory computer-readable medium of claim 19, wherein the matrix converter operates at a carrier frequency, and wherein selecting the second modulation technique comprises determining a modification to the carrier frequency based at least in part on the first metric value.

22. The non-transitory computer-readable medium of claim 19, wherein the computer-executable instructions further cause the hardware processor to at least:
determine, at a third time that is later than the second time, that a second metric value associated with the first metric satisfies the corresponding threshold or a corresponding threshold adjusted by a hysteresis band; and
restore operation of the matrix converter to operation using the first modulation technique.

23. The non-transitory computer-readable medium of claim 19, wherein the set of metrics associated with the motor assembly: a temperature of the matrix converter, a temperature of the motor assembly; a total harmonic distortion of the matrix converter, an audible noise, a degree of vibration, a rate of energy loss, a motor speed, or a measure of torque production.
